(19) United States
(12) Patent Application Publication
(10) Pub. No.: US 2003/0225683 A1
(43) Pub. Date: Dec. 4, 2003

(54) Electronic bid/proposal system for the construction industry

(75) Inventors: Bernard Charles Hill, Glencoe, MN (US); Michael Richard Malz, Winsted, MN (US)

Correspondence Address: Mark A. Litman & Associates, P.A., York Business Center, Suite 205, 3209 West 76th St., Edina, MN, 55435, US

(73) Assignee: MT One, Inc.

(21) Appl. No.: 10/449,658

(22) Filed: May 30, 2003

Related U.S. Application Data
(60) Provisional application No. 60/385,219, filed on May 31, 2002.

(51) Int. Cl. G06F 17/60

(52) U.S. Cl. 705/37

(57) ABSTRACT

A computer-based system is used to communicate between a central location and distal locations to allow submission of bidding information on a project or elements of a project. A project manager (e.g., private or public organization, commercial or residential developers, general contractor, architect, etc.) establishes a website where potential bidders on a project or request for bid (RFB) can submit detailed bids. The bids and associated information are submitted in a defined format and enables the submission of exceptions in the bidding process. The system organizes individual bids according to elements of a project and can identify bidding errors and red flag extremes in bids. The system can categorize and organize bids for the project manager, but does not render decisions.

### RELATED APPLICATIONS

This Application claims priority from U.S. Provisional Application Serial No. 60/385,219, filed May 31, 2002.

### BACKGROUND OF THE INVENTION

1. Field of the Invention

The present invention relates to a system and process for making, cataloguing and inscription of bids/proposals for projects, provision of supplies and materials. For example, food or construction materials, or construction work. The system relates to such a system where bids can be screened according to various hierarchies and properties to assist a general contractor, bid receiver or offering party in making a selection.

2. Background of the Art

The process of offering open bidding or closed bidding on projects has become very complex, especially as the size of a project increases. Where there are many subcontractors, and each of the subcontractors may also delegate work, a major project may entail hundreds of bids on each of the various elements of the full-scale project. The work by a general contractor or organization attempting to select each of the subcontractors can be an overwhelming task. Government regulations requiring opening of bids on certain projects and non-discriminatory practices, as well as encouraging the use of minority subcontractors complicates the task further.

Service contractors, such as those involved in any form of the many property maintenance, repair and building trades, are faced with their own problems. They can greatly benefit from the advantages of having written contracts with their clients. However, the nature of these businesses creates logistical problems.

Computers are effective tools to help organize information and manage a business. Most service contracting businesses only realize a fraction of the potential benefit from computers because of limited availability of software programs written specifically for them and the lack of proper design in programs for the industry.

Some of the conventional methods that service contracting people use to conduct their business's are giving verbal quotes and invoices; submitting nothing other than a price written on a business card; preparing hand written contract proposals and invoices; and viewing a job or completing work in the field, returning to the office to use a computer system to generate a contract proposal, change order, or invoice, and then mailing, faxing or delivering the documents to the client.

Some of the drawbacks of these common practices are obvious. In today's world, especially where governmental agencies are involved and because financial and legal records become critical in assessing work and problems in projects, these traditional offer mechanisms are no longer satisfactory. Verbal contracts or prices written on business cards provide insufficient documentation and legal records. If there are any problems or misunderstandings, the ‘contract’ may be unenforceable. Hand written paper work is often poorly organized and difficult to read. Any changes to original copies are cumbersome at best and subject to rebuttal. When any of these methods are used, job estimates are often largely guess work, or based on rule of thumb generalizations that may or may not be based on sound management and accounting practices. To be successful, businesses using these methods often use only seasoned individuals with years of work experience for the bidding process.

Businesses will now tend to have a computer system in a central office. Some of the disadvantages with this arrangement are the time delays that occur due to the distance between work sites and the office, and the lack of access to important information while in the field or away from the office for any reason. For example, it typically takes several days to a week for a mailed contract proposal to reach a client after the initial visit to review the work to be done. Furthermore, most service businesses use a word processor or spreadsheet computer program to generate contract proposals and invoices. These are very inefficient systems in this context because critical information is either not captured at all, or stored in many separate files making it difficult to be extracted and utilize it in a meaningful way.

Although some computer based electronic commerce systems have been described for specific uses, as described below, there are few directed toward the bid/proposal functions inherent in the construction industry.

U.S. Pat. No. 5,570,291 describes a system for estimating and ordering the custom manufacture of an item wherein a remote computer with a general customer and delivery data is linked to a central computer with a database of product details for creating price estimates. This central computer is linked to a third computer at a manufacturing plant for accessing scheduling and delivery data as well as immediate order placement. This system is geared towards only the manufacture of a product.

U.S. Pat. No. 5,317,503 describes an apparatus designed for calculating the repair cost of a damaged car. It is specifically designed for insurance applications and estimates on bodywork for a car. Tree Management Systems, Inc. of Bloomington, Ind., provides a tree service industry system for both a hand held computing device and standard desktop computers. The desktop system allows the operator to organize client and job information, generate invoices and itemized proposals, schedule work, track employee and inventory data, and generate reports for receivables, jobs and sales. The portable hand held system is limited only to maintaining customer information and generating proposals.

Contractor's Management Systems of Langdon, N.H., provides a system for the plumbing, HVAC and electrical industries that includes general ledger, financial statements, check writing, point of sale processing, bar coding, inventory tracking, and service scheduling as well as estimating and establishing set prices for common tasks. The system apparently requires an operator to factor in an overhead margin and a profit margin on top of labor costs and materials costs to determine prices for specific tasks to be included in a price book or look-up table. Reference is also made to generating estimates by creating and combining several assemblies of parts. Thus, it appears that this system is geared towards setting standard prices that will repeatedly be charged for specific tasks such as changing a hot water heater or installing a bathtub. There is also reference to comparing actual hours and materials to defined hours and materials in order to examine a task for profitability. There is a reference to a portable system, but the capabilities are apparently limited to generating proposals and invoices.

U.S. Pat. No. 5,794,207 Method and Apparatus for a Cryptographically Assisted Commercial Network System Designed to Facilitate Buyer-driven Conditional Purchase Offers, issued Aug. 11, 1998, to Walker et al., assigned to Walker Asset Management Limited is essentially an online bidding process in which a buyer specifies the price it desires to pay for an object, such as an airplane reservation or a car. The bid is submitted over the Internet to a central site that analyzes a database of sellers of that type of item to find one or more selling the object at close to the bid price. These matches or near-matches are presented to the buyer, who can then select from them and place a conditional purchase offer. If the seller accepts, the sale is made. A buyer can initiate another round of bidding if there is no good result from the initial one.

The Roofer's Database of Garland, Tex., provides a software program for the roofing industry that organizes customer and job information, generates proposals and invoices, tracks employees, suppliers, sales leads and sales performance. Reference is made to job costing for job estimates where the operator inputs profit and overhead percentages in addition to labor and materials. It also refers to measuring productivity by tracking the history of squares (of direct material) bid versus squares (of direct materials) used.

Evergreen Technology of Seattle, Wash., provides a system specifically for the painting and wall covering industry that includes labor rate calculation, bidding, invoicing, work scheduling and employee motivation. In the labor rate calculation, overhead is based on monthly expenses. Depreciation for equipment or other capitalized expenses doesn't appear to be accounted for. Profit is a flat percentage markup on an operator's desired profit, and there are no guidelines for establishing what an appropriate profit percentage should be. Time and materials are used to generate itemized prices in an estimate worksheet, but actual proposals don't have itemized prices or a job discount, and an operator doesn't have the ability to use discretion to override a price that the system calculates. The system provides a mechanism for job cost reports that compare actual to estimated labor, materials, overhead and profit for a job.

U.S. Pat. No. 6,338,050 describes what is felt to be an international control system. A multivariate negotiations engine for international transaction processing which: enables a sponsor to create and administer a community between participants such as buyers and sellers having similar interests; allows a buyer/participant to search and evaluate seller information, propose and negotiate orders and counteroffers that include all desired terms, request sample quantities, and track activity; allows a seller/participant to use remote authoring templates to create a complete Website for immediate integration and activation in the community, to evaluate proposed buyer orders and counteroffers, and to negotiate multiple variables such as prices, terms, conditions etc., iteratively with a buyer. The system provides secure databases, search engines, and other tools for use by the sponsor, which enable the sponsor to define the terms of community participation, establish standards, help promote the visibility of participating companies, monitor activity, collect fees, and promote successes. All this is done through a multivariate negotiations engine system operated at the system provider's Internet site, thus requiring no additional software at the sponsors', or participant sellers', or buyer's sites. This also allows buyers and sellers to use and negotiate payment options and methods that are accepted internationally. The system maintains internal databases that contain the history of all transactions in each community, so that sponsors, buyers and sellers may retrieve appropriate records to document each stage of interaction and negotiation. Documents are created by the system during the negotiation process.

The necessities of a bid/proposal system are quite different from these electronic commerce systems that are directed more towards project management systems.

Published U.S. patent application 20010033768 (published Nov. 22, 2001 in the name of L. A. Wares) describes an electronic commerce based, construction industry system for bidding and project management. It is asserted that in a pre-construction setting, the electronic commerce bidding and management system provides a user with the means for participating and competing in and competing in on-line computerized bases. The project management system comprises technical infrastructure means for receiving, storing, and exchanging information; and function management means, coupled to said technical infrastructure means, for managing at least one of a plurality of project functions utilizing information stored in said technical infrastructure means in an e-commerce environment. The types of functions contemplated include, but are not limited to design, bidding, building or construction, and maintenance functions. There may be means for collaborating bids between owners, architects, engineers, general contractors, subcontractors, suppliers and building product manufacturers. The project management system's bidding function may comprise means for preparing bid documents by architects and owners; means for evaluating and re-packaging said bid documents into bid packages by general contractors; means for distributing said bid packages to subcontractors by said general contractors; means for performing quantity take-offs and soliciting request for quotes from suppliers, wholesalers and building product manufacturers by said subcontractors; means for preparing bids by said suppliers, wholesalers and building product manufacturers and for submitting said bids to said subcontractors; means for evaluating request for quotes and compiling bids by said subcontractors for submitting to said general contractors; means for evaluating bids received from said subcontractors and for compiling totals into a base bid by said general contractors; and means for submitting said base bid by said general contractors to said owners and architects.

What is desired, therefore, is a computer-based system specifically designed to help service contracting people in a variety of industries quickly and easily generate written contract proposals with itemized prices that are competitive yet profitable. Furthermore, the operator should be able to use discretion as needed to override any particular price that the system calculates or to offer a job discount as desired to reflect the efficiencies that a contractor can realize when executing larger jobs or multiple jobs in a single location, and to encourage clients to accept more services. Since the most significant cost driver in many service businesses is labor, the emphasis for pricing, profitability and any comparisons is summarized by consistently referring to labor rates that, after being adjusted for direct materials expenses, specifically incorporate all other business expenses and a justifiable profit.

The benchmark or minimum labor rate is calculated using generally accepted job cost accounting methods that properly incorporate depreciation expenses and profit. Profit, as forecasted in a proposal price, should conform to the common job cost accounting concepts of return on investment or return on equity compared to alternative potential investments. Thus, an estimated profit can justifiably be set by comparing an expected rate of return to returns of Treasury Bills and the stock market as is common in economic theory, instead of randomly choosing a “profit markup” on any particular job.

The system also organizes information so that it is easily accessible and can provide meaningful performance feedback including survey responses from clients so that managers can make informed decisions about how to improve the business. The system generates work orders, invoices and profit reports based on only the accepted portions of an itemized proposal.

In typical intranet client/server technology, one computer acts as a Web server computer to perform complex tasks, while other, smaller computers or terminals are clients that communicate with the web server. In typical client/server intranets the client requests data and performance of tasks from the web server computer. A web server program runs on the web server computer to provide web server processes and threads specific to these processes functions. The communications between these intranet clients and web servers is in Hypertext, or HyperText Markup Language (HTML)—the language of the Internet's World Wide Web, or XHTML (Extensible HyperText Markup Language).

Usually, for intranets, at the web server site, one or more people would create documents in hypertext format and make them available at the web server. In many companies, employees have personal computers or terminals at their desks connected to the internal network. In an intranet these employees would use a web browser on their terminals to see what hypertext documents are available at the internal corporate web server site.

While this has been an advance for internal communications over a private network, it does not usually provide any interactive, iterative, multivariate negotiations capabilities and it requires personnel familiar with HyperText Markup Language (HTML) to create hypertext links in documents to create and maintain the internal web pages. If a more interactive approach is desired, an Information Technology (IT) specialist in some form of scripting, such as CGI, or PHP is needed who can create forms documents and procedures to allow users to ask for information from the web server. Again, this is custom programming at the user's site, and still does not provide multivariate negotiations or commerce capabilities.

Corporations that share information internally can also use workgroup software such as IBM's LOTUS NOTES™ software on the internal network or intranet. However, this, too, requires special programming and scripting for the unique needs of the organization, and normally does not address multivariate negotiations, even on an internal basis.

Since extranets simply extend a company's intranet to include selected other companies, the extranet concept usually does not provide any negotiations capabilities, either, much less electronic commerce capabilities.

To date, most attempts at adapting Internet technology to negotiations and commerce, even in small measure, have been focused on solving the problem from inside a corporation's systems going out and with the emphasis on the seller, not the buyer. Consequently, Intranet/Extranet options usually do not provide electronic commerce, only more sophisticated information distribution and sharing.

For corporations that sell at retail, one technique for selling goods over the Internet is uses the concept of a hosting mall website that enables buyers to browse through stores (individual participating selling corporate websites or aggregated catalog systems) and use a shopping cart feature for selecting items to purchase. Participating sellers in a mall create their own websites that list items for sale and prices. The mall usually provides the shopping cart technique for the buyer to use to select items to buy. Such

Internet sales techniques also use security systems for transmitting payments by credit card and or CYBERCASH” payment methods. Most of these mall websites are significantly limited in the interaction, if any, they allow between buyers and sellers. A few allow limited price negotiations between buyers and sellers, but none allow iterative, multivariate negotiation and bargaining for both price and terms, such as availability, shipping, carrier, payment methods, risk of loss, etc.

Similarly, for non-retail business buyers and sellers, the mall concept above has limited value, since it usually does not connote much about the integrity or capability of the participating businesses, nor provide all of the various payment options a business might want to use. Most of the present Internet and World Wide Web systems for commerce are directed to consumer purchases of retail items in small quantities, not to business to business transactions or consumer transactions negotiating for goods and services in large quantities on national or international terms.

The companies that do provide more of a business to business focus over the Internet usually do so by offering special enterprise application server software for installation inside an enterprise's private corporate network. These programs fit into a category of software called front-office applications or application servers—so called because they sit close to the user end inside an enterprise and are customized to interface with the back-office applications inside the enterprise, which include commercial products from software suppliers as well as custom developed applications that handle internal business functions such as inventory tracking, financials, human resources and supplies, and similar Enterprise Resource Planning (ERP) systems.

### SUMMARY OF THE INVENTION

A computer-based system is used to communicate between a central location and distal locations to allow submission of bidding information on a project or elements of a project. A project manager (e.g., private or public organization, commercial or residential developers, general contractor, architect, etc.) establishes a membership on the website where potential bidders on a project or request for bid (RFB) can be accessed by the potential bidders to submit detailed bids. The bids and associated information are submitted in a defined format and enables the submission of exceptions in the bidding process. The system organizes individual bids according to elements of a project and can identify bidding errors and red flag extremes in bids. The system can categorize and organize bids for the project manager, but does not render decisions.

### BRIEF DESCRIPTION OF THE FIGURES

FIG. 1A shows an opening screen shot welcoming visitors to a bidding site.

FIG. 1 shows an opening screen shot showing a mission statement.

FIG. 2 shows a screen shot providing a copyright notice for the bidding site.

FIG. 3 shows a screen shot of a Members Login Area for the bidding site.

FIG. 4 shows a screen shot of a Usage Disclaimer for the bidding site.

FIG. 5 shows a screen shot of a Projects Index for accessing various biddable projects.

FIG. 6 shows a screen shot of General Contract Projects.

FIG. 7 shows a screen shot of the first page of a Project Name bid entry stream of forms.

FIG. 8 shows a screen shot of a first substantive Bid Control initial start screen.

FIG. 9 shows a screen shot of a continuation of the first substantive Bid Control initial start screen of FIG. 8.

FIG. 10 shows a screen shot of a login screen after a specific project has been identified.

FIG. 11 shows a status summary of a bid on a project that has been accessed by a Member.

FIG. 12 shows a further screen shot in the succession of screens that are displayed in the practice of the bidding sequence.

FIG. 13 shows a further screen shot in the succession of screens that are displayed in the practice of the bidding sequence.

FIG. 14 shows a further screen shot in the succession of screens that are displayed in the practice of the bidding sequence.

FIG. 15 shows a further screen shot in the succession of screens that are displayed in the practice of the bidding sequence.

FIG. 16 shows a further screen shot in the succession of screens that are displayed in the practice of the bidding sequence.

FIG. 17 shows a further screen shot in the succession of screens that are displayed in the practice of the bidding sequence.

FIG. 18 shows a further screen shot in the succession of screens that are displayed in the practice of the bidding sequence.

FIG. 19 shows a further screen shot in the succession of screens that are displayed in the practice of the bidding sequence.

FIG. 20 shows a further screen shot in the succession of screens that are displayed in the practice of the bidding sequence.

FIG. 21 shows a further screen shot in the succession of screens that are displayed in the practice of the bidding sequence.

FIG. 22 shows a further screen shot in the succession of screens that are displayed in the practice of the bidding sequence.

FIG. 23 shows a further screen shot in the succession of screens that are displayed in the practice of the bidding sequence.

FIG. 24 shows a further screen shot in the succession of screens that are displayed in the practice of the bidding sequence.

FIG. 25 shows a further screen shot in the succession of screens that are displayed in the practice of the bidding sequence.

FIG. 26 shows a further screen shot in the succession of screens that are displayed in the practice of the bidding sequence.

FIG. 27 shows a further screen shot in the succession of screens that are displayed in the practice of the bidding sequence.

FIG. 28 shows a further screen shot in the succession of screens that are displayed in the practice of the bidding sequence.

FIG. 29 shows a further screen shot in the succession of screens that are displayed in the practice of the bidding sequence.

FIG. 30 shows a further screen shot in the succession of screens that are displayed in the practice of the bidding sequence.

FIG. 31 shows a further screen shot in the succession of screens that are displayed in the practice of the bidding sequence.

FIG. 32 shows a further screen shot in the succession of screens that are displayed in the practice of the bidding sequence.

FIG. 33 shows a further screen shot in the succession of screens that are displayed in the practice of the bidding sequence.

FIG. 34 shows a further screen shot in the succession of screens that are displayed in the practice of the bidding sequence.

FIG. 35 shows a further screen shot in the succession of screens that are displayed in the practice of the bidding sequence.

FIG. 36 shows a further screen shot in the succession of screens that are displayed in the practice of the bidding sequence.

FIG. 37 shows a further screen shot in the succession of screens that are displayed in the practice of the bidding sequence.

FIG. 38 shows a further screen shot in the succession of screens that are displayed in the practice of the bidding sequence.

FIG. 39 shows a further screen shot in the succession of screens that are displayed in the practice of the bidding sequence.

FIG. 40 shows a further screen shot in the succession of screens that are displayed in the practice of the bidding sequence.

FIG. 41 shows a further screen shot in the succession of screens that are displayed in the practice of the bidding sequence.

FIG. 42 shows a further screen shot in the succession of screens that are displayed in the practice of the bidding sequence.

FIG. 43 shows a further screen shot in the succession of screens that are displayed in the practice of the bidding sequence.

FIG. 44 shows a further screen shot in the succession of screens that are displayed in the practice of the bidding sequence.

FIG. 45 shows a further screen shot in the succession of screens that are displayed in the practice of the bidding sequence.

FIG. 45A shows a further screen shot in the succession of screens that are displayed in the practice of the bidding sequence.

FIG. 46 shows a further screen shot in the succession of screens that are displayed in the practice of the bidding sequence.

FIG. 47 shows a further screen shot in the succession of screens that are displayed in the practice of the bidding sequence.

FIG. 48 shows a further screen shot in the succession of screens that are displayed in the practice of the bidding sequence.

FIG. 49 shows a further screen shot in the succession of screens that are displayed in the practice of the bidding sequence.

FIG. 50 shows a further screen shot in the succession of screens that are displayed in the practice of the bidding sequence.

FIG. 51 shows a further screen shot in the succession of screens that are displayed in the practice of the bidding sequence.

FIG. 52 shows a further screen shot in the succession of screens that are displayed in the practice of the bidding sequence that is a continuation of FIG. 51.

FIG. 53 shows a further screen shot in the succession of screens that are displayed in the practice of the bidding sequence that is a continuation of FIGS. 51 and 52.

FIG. 54 shows a further screen shot in the succession of screens that are displayed in the practice of the bidding sequence.

FIG. 55 shows a further screen shot in the succession of screens that are displayed in the practice of the bidding sequence.

FIG. 56 shows a further screen shot in the succession of screens that are displayed in the practice of the bidding sequence.

FIG. 57 shows a further screen shot in the succession of screens that are displayed in the practice of the bidding sequence.

FIG. 58 shows a further screen shot in the succession of screens that are displayed in the practice of the bidding sequence.

FIG. 59 shows a further screen shot in the succession of screens that are displayed in the practice of the bidding sequence.

FIG. 60 shows a further screen shot in the succession of screens that are displayed in the practice of the bidding sequence.

FIG. 61 shows a further screen shot in the succession of screens that are displayed in the practice of the bidding sequence, which is a continuation of FIG. 60.

FIG. 62 shows a further screen shot in the succession of screens that are displayed in the practice of the bidding sequence.

FIG. 63 shows a further screen shot in the succession of screens that are displayed in the practice of the bidding sequence.

FIG. 64 shows a further screen shot in the succession of screens that are displayed in the practice of the bidding sequence.

FIG. 65 shows a further screen shot in the succession of screens that are displayed in the practice of the bidding sequence.

FIG. 66 shows a further screen shot in the succession of screens that are displayed in the practice of the bidding sequence.

FIG. 67 shows a further screen shot in the succession of screens that are displayed in the practice of the bidding sequence.

FIG. 68 shows a further screen shot in the succession of screens that are displayed in the practice of the bidding sequence.

FIG. 69 shows a further screen shot in the succession of screens that are displayed in the practice of the bidding sequence.

FIG. 70 shows a further screen shot in the succession of screens that are displayed in the practice of the bidding sequence, which is a continuation of the screen in FIG. 69.

FIG. 71 shows a further screen shot in the succession of screens that are displayed in the practice of the bidding sequence, which is a continuation of the screen in FIGS. 69 and 70.

FIG. 72 shows a further screen shot in the succession of screens that are displayed in the practice of the bidding sequence.

FIG. 73 shows a further screen shot in the succession of screens that are displayed in the practice of the bidding sequence.

FIG. 74 shows a further screen shot in the succession of screens that are displayed in the practice of the bidding sequence, which is a continuation of the screen shot of FIG. 73.

FIG. 75 shows a further screen shot in the succession of screens that are displayed in the practice of the bidding sequence.

FIG. 76 shows a further screen shot in the succession of screens that are displayed in the practice of the bidding sequence.

FIG. 77 shows a further screen shot in the succession of screens that are displayed in the practice of the bidding sequence.

FIG. 78 shows a further screen shot in the succession of screens that are displayed in the practice of the bidding sequence.

FIG. 79 shows a further screen shot in the succession of screens that are displayed in the practice of the bidding sequence, which is a continuation of the screen shot of FIG. 78.

FIG. 80 shows a further screen shot in the succession of screens that are displayed in the practice of the bidding sequence, which is a continuation of the screen shots of FIGS. 78 and 79.

FIG. 81 shows a further screen shot in the succession of screens that are displayed in the practice of the bidding sequence, which shows an error/discrepancy indication on the screen shot of FIG. 80.

FIG. 82 shows a further screen shot in the succession of screens that are displayed in the practice of the bidding sequence.

FIG. 82A shows a further screen shot in the succession of screens that are displayed in the practice of the bidding sequence.

FIG. 82B shows a further screen shot in the succession of screens that are displayed in the practice of the bidding sequence, which is a continuation of the screen shot of FIG. 82A.

FIG. 83 shows a further screen shot in the succession of screens that are displayed in the practice of the bidding sequence.

FIG. 84 shows a further screen shot in the succession of screens that are displayed in the practice of the bidding sequence.

FIG. 85 shows a further screen shot in the succession of screens that are displayed in the practice of the bidding sequence.

FIG. 86 shows a further screen shot in the succession of screens that are displayed in the practice of the bidding sequence, which is a continuation of the screen shot of FIG. 85.

FIG. 87 shows a further screen shot in the succession of screens that are displayed in the practice of the bidding sequence.

FIG. 88 shows a further screen shot in the succession of screens that are displayed in the practice of the bidding sequence.

FIG. 89 shows a further screen shot in the succession of screens that are displayed in the practice of the bidding sequence.

FIG. 90 shows a further screen shot in the succession of screens that are displayed in the practice of the bidding sequence.

FIG. 91 shows a further screen shot in the succession of screens that are displayed in the practice of the bidding sequence.

FIG. 92 shows a further screen shot in the succession of screens that are displayed in the practice of the bidding sequence.

FIG. 93 shows a further screen shot in the succession of screens that are displayed in the practice of the bidding sequence.

FIG. 94 shows a further screen shot in the succession of screens that are displayed in the practice of the bidding sequence.

FIG. 95 shows a further screen shot in the succession of screens that are displayed in the practice of the bidding sequence.

FIG. 96 shows a further screen shot in the succession of screens that are displayed in the practice of the bidding sequence.

FIG. 97 shows a further screen shot in the succession of screens that are displayed in the practice of the bidding sequence.

FIG. 98 shows a further screen shot in the succession of screens that are displayed in the practice of the bidding sequence.

FIG. 99 shows a further screen shot in the succession of screens that are displayed in the practice of the bidding sequence.

FIG. 100 shows a further screen shot in the succession of screens that are displayed in the practice of the bidding sequence.

FIG. 101 shows a further screen shot in the succession of screens that are displayed in the practice of the bidding sequence.

FIG. 102 shows a further screen shot in the succession of screens that are displayed in the practice of the bidding sequence with an error notification identifying a specific deficiency in the bid process or specific entry error.

FIG. 103 shows a further screen shot in the succession of screens that are displayed in the practice of the bidding sequence.

FIG. 104 shows a further screen shot in the succession of screens that are displayed in the practice of the bidding sequence.

FIG. 105 shows a further screen shot in the succession of screens that are displayed in the practice of the bidding sequence.

FIG. 106 shows a further screen shot in the succession of screens that are displayed in the practice of the bidding sequence.

FIG. 107 shows a further screen shot in the succession of screens that are displayed in the practice of the bidding sequence.

FIG. 108 shows a further screen shot in the succession of screens that are displayed in the practice of the bidding sequence, with an overlay requiring specific alterations in the entry by the Member.

FIG. 109 shows a further screen shot in the succession of screens that are displayed in the practice of the bidding sequence.

FIG. 110 shows a further screen shot in the succession of screens that are displayed in the practice of the bidding sequence.

FIG. 111 shows a further screen shot in the succession of screens that are displayed in the practice of the bidding sequence, which is a continuation of the screen shot of FIG. 110.

FIG. 112 shows a further screen shot in the succession of screens that are displayed in the practice of the bidding sequence, which is a continuation of the screen shots of FIGS. 110 and 111.

FIG. 113 shows a further screen shot in the succession of screens that are displayed in the practice of the bidding sequence, which may be a summary screen shot of all Projects bid upon by the Member.

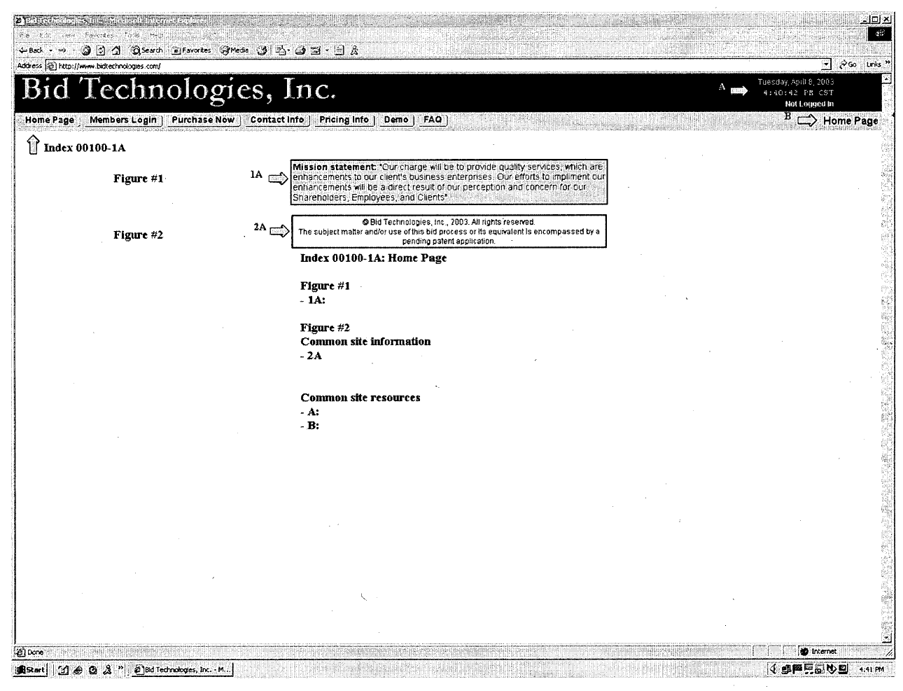

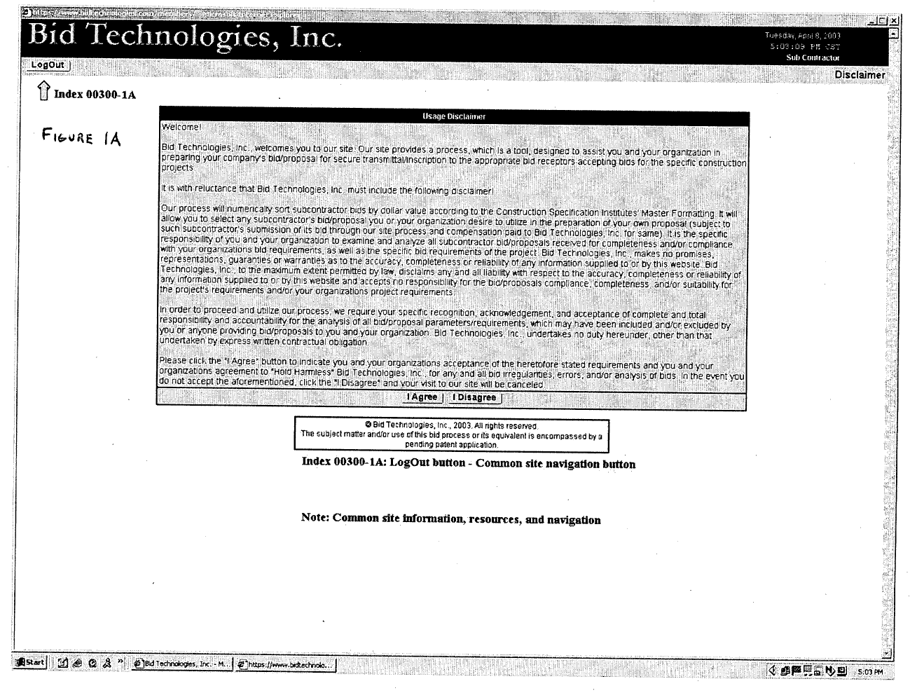

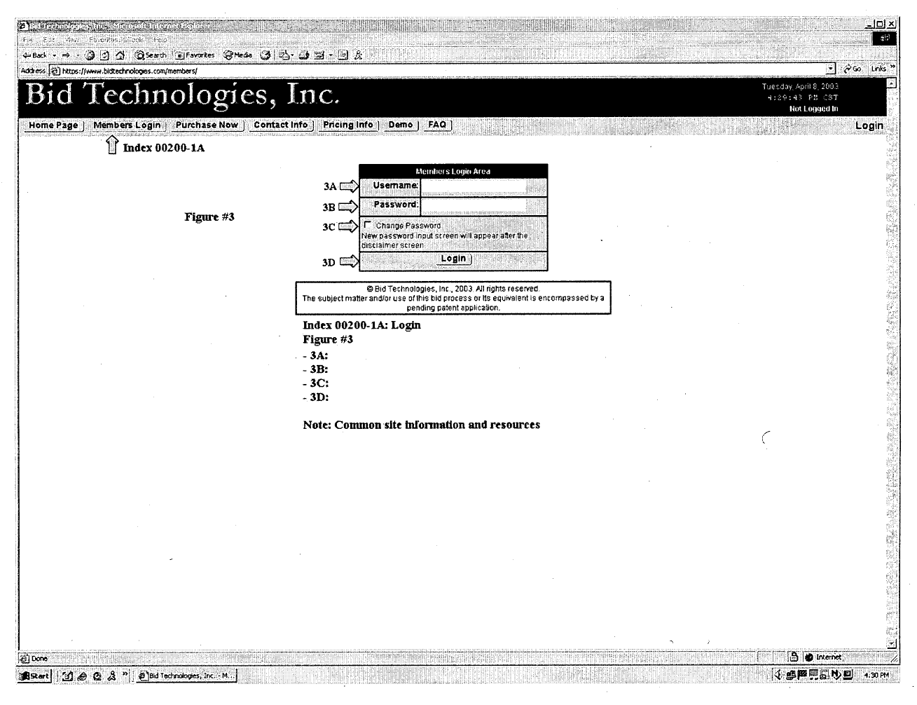

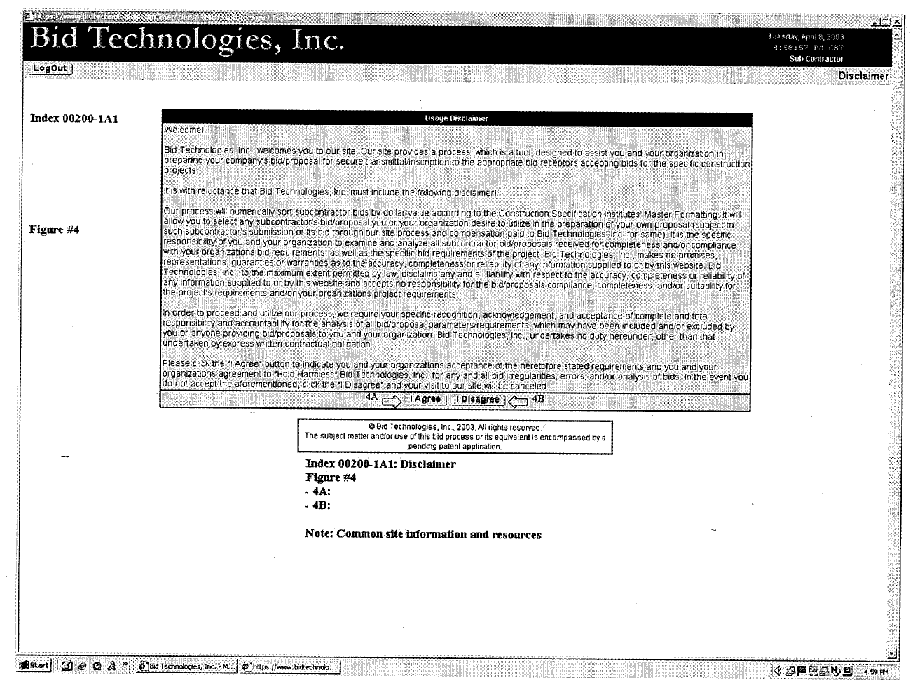

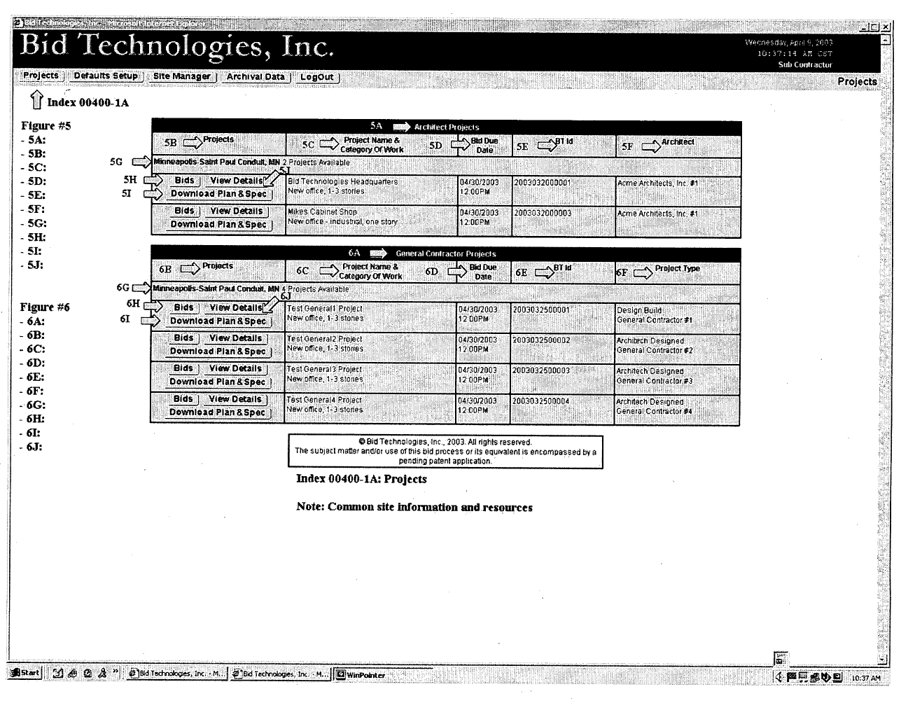

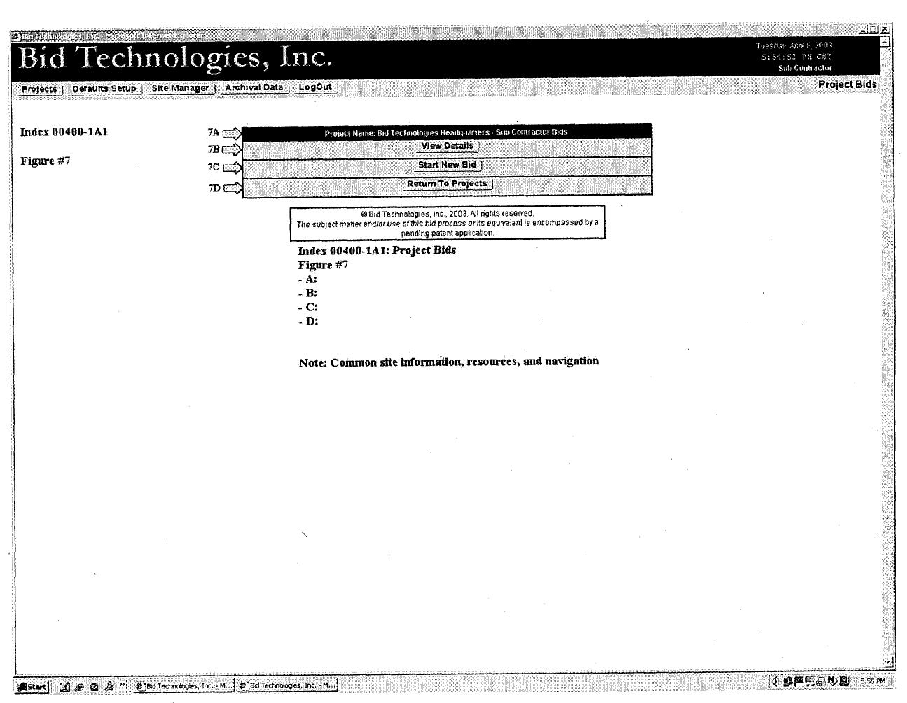

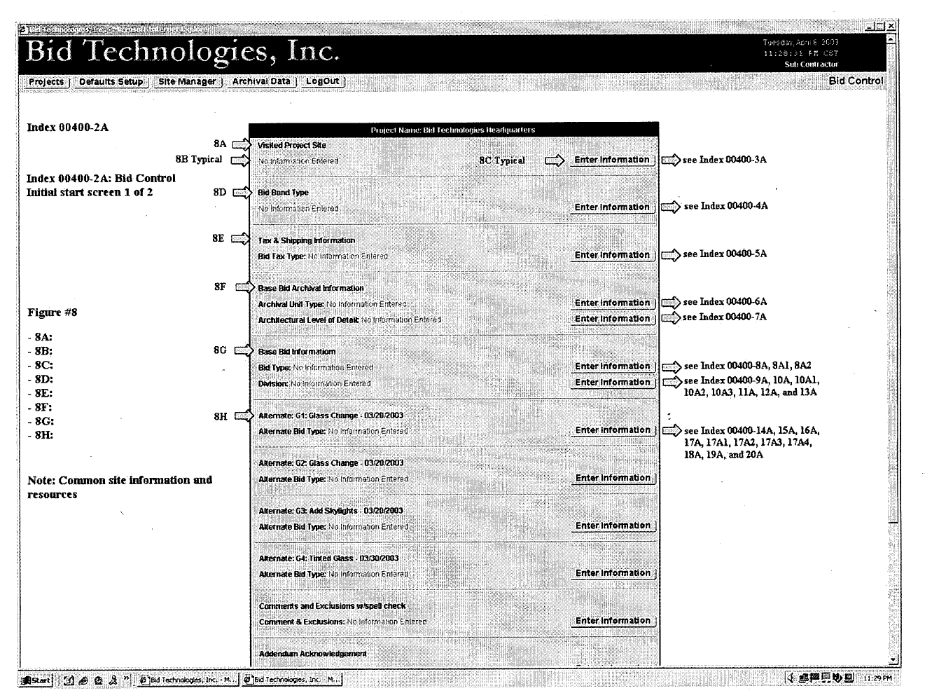

### DETAILED DESCRIPTION OF THE INVENTION

The bid process experienced by today's construction industry is a result of adversarial bidding. While the projects and players may differ from bid to bid, the goal of obtaining the lowest possible price for the best possible materials and labor remains unchanged. The process typically includes a final deadline for bid submission at a specific time. In addition, it is commonplace to believe that standardized organization of the bid documents by trade discipline would result in better bids. In a public works environment, projects are open to anyone that qualifies to bid the project. This creates a highly adversarial bid environment. Similarly, in a private ownership bid environment where more than one General Contracting bid is desired, a highly adversarial bid environment is created among general contractors and subcontractors. Lastly, in a negotiated bid environment, an owner places confidence in a single General Contractor who will solicit bids from qualified subcontractors and suppliers (a team effort) that tends to be a non-adversarial bidding environment. Today, it is common for plans and specifications to be prepared in a way that enables all participants to narrow down their required scope of work and submit a qualified bid. However, although a negotiated bid environment is utilized in pre-construction phases, the construction industry traditionally relies on manual methods of bid collaboration, and dissemination of information and results. The bid manager's task is enormous and highly susceptible to inefficiencies and inaccuracies due to the predominantly manual means employed for completing the bidding task. While the construction industry bidding process is well known, the bidding management tasks have not been centralized for use with available computer technology.

By example, in the pre-construction phase, the construction industry bidding task traditionally concerns: a) an owner purchasing land and employing the services of an architect and other consultants, b) an architect employs services of specialty engineers and consultants, c) an architect prepares bid documents concerning the construction project involved, d) architects and owners seek low bids from qualified general contractors, e) general contractors seek low bids from qualified subcontractors and suppliers, f) subcontractor seek low bids from suppliers, wholesalers and building products manufacturer, g) suppliers and wholesalers seek low bids from specified building product manufactures, h) building product manufacturers submit bids, i) suppliers and wholesalers submit bids, j) subcontractor submits bid, k) general contractors submit an all-inclusive bid, and l) Alternatives and Addenda prior to bid submission and/or Bulletins after contracts have been awarded. The activities involved by each bidder (by example providing specifications, plans and drawings) for winning the lowest bid are intense and involves an enormous amount of manual manipulation and dissemination of information by each bid participant. As bid deadlines are reached, banks of telephones and fax machines are ordinarily provided, which is very labor intensive. Bids are received in handwriting, in typed formats, or with mixtures of the two. Terminology may vary in the data entered by each bidder, with no uniformity. This creates additional burdens on the general contractor and/or the persons making decisions on bids. The complexity of the problem is multiplied because of the segmentation of bids into projects and subcontracts.

Accordingly, a need is seen to exist for a system for managing each element of the bidding process in the building and construction industries, including architecture, engineering and construction (AEC) projects, up to the point of actual contract award, which still should be done by decisions of individuals. This system should preferably include an integrated solution composed of a modular set of bid elements where various project data progresses in a reasoned workflow. This system may facilitate collaboration between intra- and inter-company participants (contractors and subcontractors, for example) wherein project data and workflow may be accessed and manipulated electronically via the Internet.

Optionally, this system may interface to traditional non-Internet based processes of AEC project management via printing, scanning, e-mail, FAX in/out, file import/export, or forms of import/export. From a more global perspective, a need is seen to exist for a system that facilitates managing bidding procedures in the building and construction industries, including architecture, engineering and construction (AEC) project phases, including design, specification, research, bidding, procurement, and construction. The services provided by the system may be integrated to include, by example, document management, document viewing, document redlining, account management, permissions management, contact management, design professional directories, bidding process management, construction administration management, and reprography services.

The present invention provides an electronic-commerce based bidding project evaluation-assisting system and a method applicable to bidding on works projects in the construction community or by general contractors in an on-line system using computerized telecommunications technologies, known as the Internet or the web.

The engine system site may contain all the software, hardware and database functions to create and support complete operations of the bidding communities. The engine system website may have, by way of non-limiting example, a webserver containing standard webserver software. In one embodiment, the public domain Apache Webserver™ software is used, but those skilled in the art will appreciate that any of a number of other webserver software products could be used, such as that provided by Microsoft Corporation's Internet Information Server (IIS) product or Netscape Corporation's Fasttrack™ or Enterprise Server products or any of several of UNIX™ or linux Operating system server software products available from many vendors or available for free over the internet.

The webserver enables communications in the TCP-IP format (for example), to be received from the internet and forwarded into a central bidding engine system site or a relay site to various bidding engine sites, which may include a server farm. Data in these communications may be transferred through an IP firewall. Those skilled in the art will appreciate that IP firewalls, that is, firewalls such as those supplied by RAPTOR”□ IP firewalls from Axent Technology Corporation, SOLSTICE 1™ and SOLSTICE 2™ firewalls from Sun Microsystems, Inc., and PIX™ Firewalls and from Cisco Systems, Inc. among others, are capable of screening the incoming and outgoing information at all the levels of the TCP-IP OSI 7-layer model. Thus they provide greater security than simpler router or proxy server firewall approaches. The webserver also transmits out to the internet, when transmissions are sent out from multivariate negotiations engine system's site. Thus, the data about negotiations and transactions in a community is kept safe behind an IP firewall at multivariate negotiations engine system's site. Data is kept secure by an IP firewall and communications over the internet may be kept secure by, for example, a Secure Socket Layer (SSL) encryptions. Accordingly, the foregoing objects are accomplished by an integrated electronic commerce based construction industry bidding and project management system and method, including document distribution, supply chain automation and on-line auctioning. In a pre-construction setting, the e-commerce based bidding and project management system and method of the present invention provides for a user, such as an owner, and architect, engineer, consultant, general contractor, sub-contractor, retail and wholesale supplier and building products manufacturer, the means for participating and competing in the bidding and construction project management tasks using on-line computerized telecommunications technologies, known as the Internet, fully integrated with conventional telecommunications means such as facsimile transmission. The on-line system and methodologies of the present invention help the participant to achieve cost efficiencies and performance enhancements that traditional prior art manual bidding and construction management systems and methods have not achieved.

The present invention provides a system for managing each phase of the bidding process up to, but preferably not including the actual decision on which bids to accept. This function may be included, or a default acceptance may be included where there is only a single bid on a project or element of the project, or where there are multiple bids, but a filter has been provided that reduces the bids to a single acceptable bid. The bids are to be for projects in the building and construction industries, including architecture, engineering and construction (AEC) projects. The bidding process is performed and accessed electronically via the internet. In addition, the system may have the capacity to interface with traditional non-internet based processes of AEC project management via printing, scanning, e-mail, FAX in/out, file import/export, or forms of import/export.

The present invention encompasses an integrated electronic commerce (e-commerce) based construction industry bidding and project management system and methods, including document distribution, supply chain automation and on-line auctioning. In a pre-construction setting, the e-commerce based bidding and project management system and method of the present invention provides for a user, such as an owner, and architect, engineer, consultant, general contractor, sub-contractor, retail and wholesale supplier and building products manufacturer, the means for participating and competing in the bidding and construction project management tasks using on-line computerized telecommunications technologies, known as the Internet. The on-line system and methodologies help the participants to achieve cost efficiencies and performance enhancements that traditional prior art manual bidding and construction management systems and methods have not achieved.

FIG. 1 shows an Index 00100-1A which displays the “home page” for Bid Technologies, Inc.'s registered domain name bidtechnologies.com. Its URL (Uniform Resource Locator) using the “http” (HyperText Transfer Protocol) scheme is <URL:http://www. bidtechnologies.com>, which informs the user or the user's application the type of resource they are attempting to access and/or the mechanism to use to obtain the resource. It is a standard Internet protocol method of accessing resources. Upon entering our URL into their WWW client or browser's “location” box, selecting “go”, “search”, or the enter key, the user is given access to our systems “home page”.

In the presentation of the figures of this invention, a format is presented because of the nature of the use of screen shots as illustrations of actual displays provided in the practice of the present invention. This will be explained on each figure, but initially explained with respect to FIG. 1. There are two numbered figure's visible on our home page in FIG. 1A. FIG. #1 item1A presents our entity's Mission Statement, and informs our visitors and members of our approach to conducting business operations with them, our employees, and our shareholders. FIG. #2 item 2A is a common site information notice that informs visitors and members of the copyright status for the screens and the patent pending status for our bid transmission business process. Also, found on our home page are additional menu buttons. These button allow visitors and members to accomplish the following tasks: “Members Login” allows members to authenticate and access our business process; “Purchase Now” allows visitors to purchase membership access to our business process; “Contact Info” informs visitors and members how to contact us in the event they have queries or service needs; “Pricing Info” informs our visitors of the membership costs they will be required to expend to purchase membership; “Demo” provides our members a professionally developed online training media for their use in learning and understanding our bid transmission business process; and last a “FAQ” (frequently asked questions) area within which are provided appropriate responses to questions concerning our bid transmission business process that we believe will be most often asked by our members. The letters “A” and “B” indicate common site resources. “A” indicates an area on screen where we indicate the following common resources to our members:

Day, Month, Date, and Year

Hour, Minute, Second AM/PM, and Central Standard Time (CST) zone

The Member company name (after member is logged in)

“B” indicates the screen name to our members, which will inform us exactly where our Member is within our bid transmission business process in the event the Member requires our assistance at some point in their transition through our process. Additionally, the user will be able to stop bids during presentation, essentially freeze the bid implementation, close or freeze the process, and complete the process later. This is an important capability, as the user during the bid process may require access to information to complete the bid or may be interrupted in the bid process by other matters. The freeze and retention of the bid can also be automatically established by us so that if there is a line-break, a system shutdown at the user end, or other unwanted interruption, the bid-to-date in the system can be maintained. In order to access our bid transmission business process, a member must select the “Members Login” button on the home page menu. Upon selection, the member is re-directed to Index 00200-1A.

Index 00200-1A, FIG. #3 provides text dialog boxes, check box, and login button each of which is indicated by a combination of the figure number and a letter. Beginning with item 3A, a member is provided with a text dialog box to input their unique Username. The Username must be between 6 and 20 characters in length and be unique system wide. Item 3B provides a member with a text dialog box to input their unique password. A member password must be between 6 and 31 characters in length. Item 3C provides a check box for members to change their password. The check box indicates to the system the member's request to change their password. This request is honored if the member successfully provides a valid username and password to login to the system, logs on, and agrees to the Member's Disclaimer (yet to be discussed). Item 3D is a login button, which grants the member access to authorized membership activities within our bid transmission business process, upon selection and the Member's previous input of valid username and password. Selection re-directs the member to Index 00200-1A1 Disclaimer screen.

Index 00200-1A1, FIG. #4 welcomes our members to our site, and provides our disclaimer for their acceptance or non-acceptance. Acceptance or non-acceptance of our disclaimer is a logged event, which occurs in conjunction with every login attempt. FIG. #4 item 4B is a Member's choice button that indicates to the system the Member's non-acceptance of our disclaimer when selected. Upon selection of item 4B, the “I disagree” button links the Member to the Login Index 00200-1A to re-login again. This re-direction will re-occur on each occasion when a Member chooses the “I disagree” button. FIG. #4 item 4A is a Member's acceptance choice button that indicates to the system the Member's acceptance of our disclaimer when selected by the Member. Upon selection of item 4A, the “I Agree” button links to Index 00400-1A, if the Member has not informed the system of a password change. If the Member has chosen to change their password they will first be linked to Index 00200-1A3. This sequencing of Indexes occurs because the login process must validate a Member by completion of the logon process in order for the Member to receive permission to change their password. Authentication Usernames and Password are logged in database tables to assist in system security.

Index 00200-1A3, FIG. #107, item 107A provides a “New Password” text dialog input box for Members to input a new/revised password that can vary from 6 to 31 alphanumeric characters in length. Item 107B provides a “Confirm Password” text dialog input box for the Members to re-enter their new password choice as a confirmation of item 107A. Item 107C is a “Continue” button, which upon Member selection executes and updates the change in password, and re-directs the Member to Index 00200-1A5, FIG. #109. Index 00200-1A5, FIG. #109 gives confirming notice of the Member's success in changing their password. FIG. #109 item 109A provides the Member a button to continue to the next screen in the process through selection of the “Continue” button indicated by item 109A, which re-directs the Members to Index 00400-1A or the “Projects” screen. There are occasions when a Member may enter incorrectly a change password input in either the New Password or Confirm Password text entry dialog box indicated on Index 00200-1A3, items 107A and 107B. Should this occur, the Member would be linked to Index 00200-1A4, FIG. #108 with its message displayed as item 108A to “submit” the new data input within text dialog boxes thereon for “New Password” and “Confirm Password”. Upon the Member's selection of the continue button item 107C, they are re-directed to Index 00200-1A5 (if Members have inputted the aforementioned New and Confirm password according to the system naming convention (See FAQs)).

Also shown on the Index 00200-1A1 screen is Index 00300-1A. Index 00300-1A adds to the common site information text, resources text, and navigation buttons. Index 00300-1A provides the Member a button to select that withdraws the Member from our process after its selection. If the Member has entered data from the many indexes after Index 00300-1A the data is held in the database and the Member may chose to complete the project data entry or delete it upon re-login, in further Indexes yet to be detailed herein. Re-entry to the system under the Member name, specific contract indentification and password will automatically log the member back into the program. An icon may be provided to place the Member back into the process at either the last point of entry or at the first position in the process where information is still required. This last event can occur when the Member has skipped bid elements in an earlier session and proceeded to complete subsequent bid elements before shutting off or logging out of the system. This will assist in avoiding intermediate data elements from being overlooked or omitted.

Index 00400-1A is a complex index containing FIGS. #5 and #6 that are essentially displays of projects that are receiving various bids at the specific “due” time and date of the imputer's designation,. FIGS. #5 and #6 contain numerous duplications of displayed information. The difference between these FIGS. #5 and #6 lies in the origination of the inputted data. FIG. #5 item 5A “Architect Projects” designates project data inputted by various Member Architects seeking bids for the various categories of work contained within their inputted project or projects. FIG. #6 item 6A “General Contractor Projects” designates project data inputted by General Contractors, Construction Managers, Bid Receptors, or entities other than Architects seeking bids for the various categories of work contained within their inputted project or projects. Typically this inputer is the sole Bid Receptor entity. Utilizing the common item numbers and letters of each Figure results in the following common activities, which activities are organized in the manner of a database or a table within a database with Field labels and record labels:

Items 5B & 6B—The “Projects” field column contains the operational buttons items 5H & 6H, items 5I & 6I, and items 5J & 6J all of which bear a relationship similar to horizontal records within a database and apply to projects named in fields' items 5C or 6C “Project Name & Category of Work.” The Figures also contain the item 5G & 6G designations. Beginning with the item 5G & 6G designations within these figures, both designations provide Members with a geographical designation for the site location of the projects based upon “Conduits”, which are geographic areas designated by Bid Technologies, Inc. One or more Conduits are selected by Members through the Membership Agreement and are displayed herein based upon the selections made therein by the various individual Members (Additional Conduits may be purchased by the Members after selection within the Members Agreement. This matter is covered in another Index). Project(s) displayed within fields items 5C or 6C are limited to the logged-on individual Member's specific Conduit selections. The Conduits items 5G or 6G also inform the Members of the amount or number of projects available for bid within the specific Conduit. In item 5G there are two projects available for bid, and in item 6G there are four projects available for bid. “Bid” record buttons items 5H & 6H allow Members to select a specific project as displayed within the “Project Name & Category of Work” of fields items 5C or 6C of their chosen Conduit(s) to input their bid data for bid transmission to the Bid Receptor(s) accepting Bids for the chosen project; at the specific time and date indicated in “Bid Due Date” fields items 5D or 6C; designated by Bid Technologies, Inc. as a 13 digit identification number in columns items 5E & 6E; with the project inputer type as noted in either field column “Architect” item 5F or Field column “Project Type” item 6F. The buttons “Download Plan & Spec” 5I & 6I and “View Details” items 5J & 6J follow this same pattern. The “Download Plan & Spec” button allows Members to download plan and spec, if they have been uploaded and made available by the inputers in such file formats as the Members find useful for their bid tasks. The uploading of “Plan and Spec” and the subsequent download operation of “Plan and Spec” are similar to other upload/download operation choices the Members may make at other sites on the Internet. The download operation may require the use of a “viewer” application to enable the Member to view the specific file format of the uploaded file. The “View Details” button displays the pertinent details for each project upon its selection as follows, although there are differences in the Architect/Project Type that are noted below:

Originator Information: Architect/Bid Receptor Name, Street Address, City, State, Zip Code, E-Mail address, Office telephone number, Fax telephone number, and Contact information (The Architect or Project Type designation within field 5F or 6F determines whether the Architect or Bid Receptor displays here). In the event the project is a Project Type and the Bid Receptor has chosen an Architect, the Architect will be inputted by the Bid Receptor and display following the Originator data in the Project Type designation).

Owner: Name, Street Address, City, State, Zip Code, E-Mail address, Office telephone number, Fax telephone number, and Contact.

Project Information: Project number (Bid Technologies, Inc. number), Project Name, Street Address, City, State, Zip Code, Project due date & time, Specifications date, Plan date, Project type, Status, Project type, Category of Work, Foot print of building given in square feet, and Number of stories.

How Divisions 15 and/or 16 Will Be Bid: Subcontractor or Assigned Prime

Alternate Information: Date of plan, spec, number, descriptive text or other documents describing the work to be contemplated by each individual Alternate(s), if any.

Addendum Information: Date of Addendum and/or descriptive specification and plans assigned to each Addendum, if any.

Member General Contractors currently accepting bids as inputted by Bid Receivers (“Project Type” will not indicate additional Member bid receptors, as only the inputer will be receiving the bid transmissions. The Bid Receptor will display as the originating entity within the Originator Information).

Non-Member General Contractors currently accepting bids as inputted by Bid Receivers (“Project Type” will not indicate any Non-Members as bid receptors, as the inputer is the only bid receptor receiving bid transmissions for this specific project).

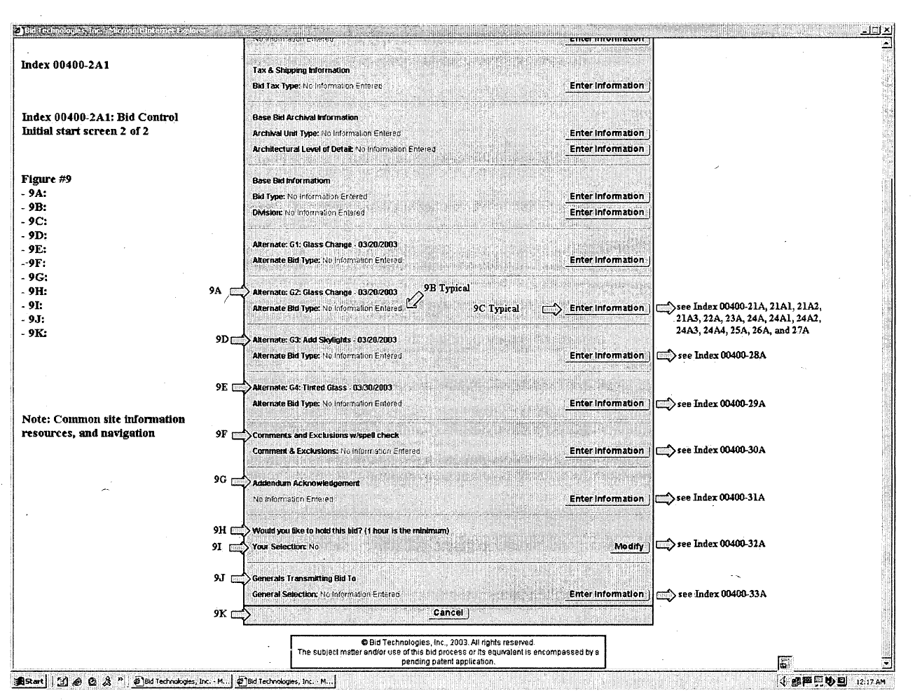

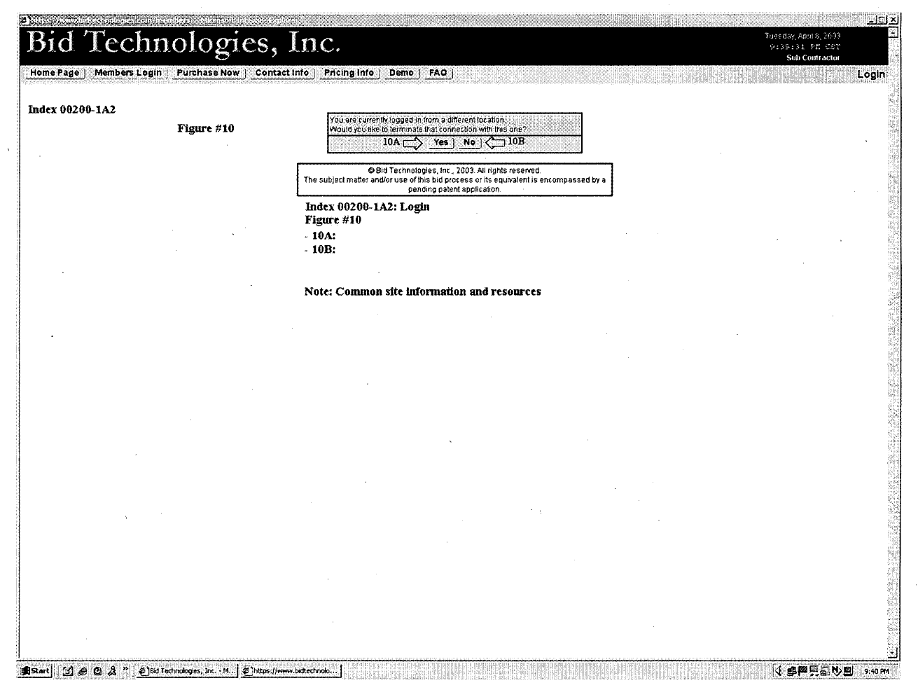

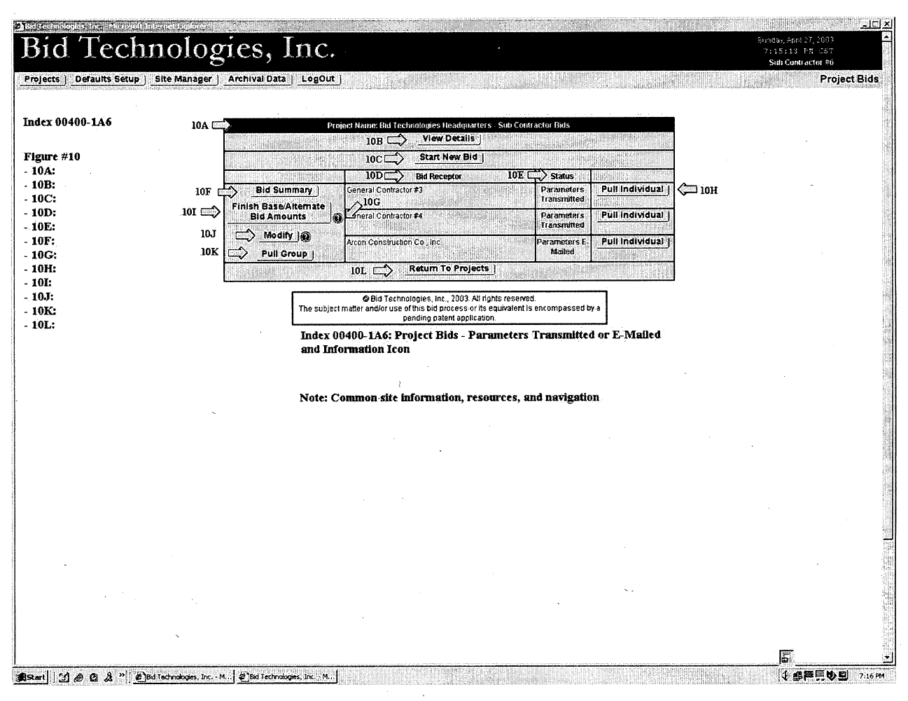

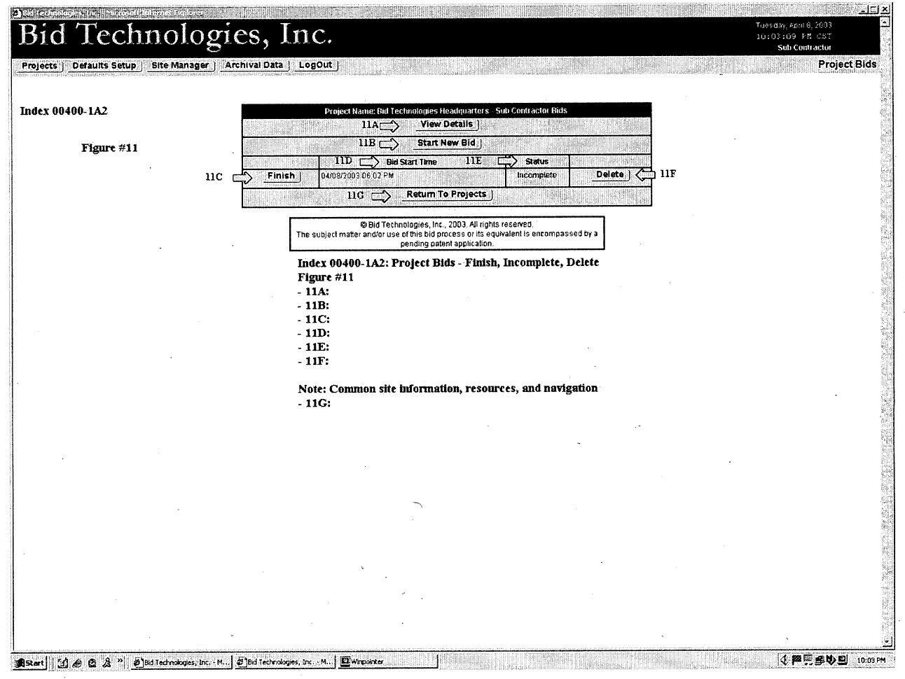

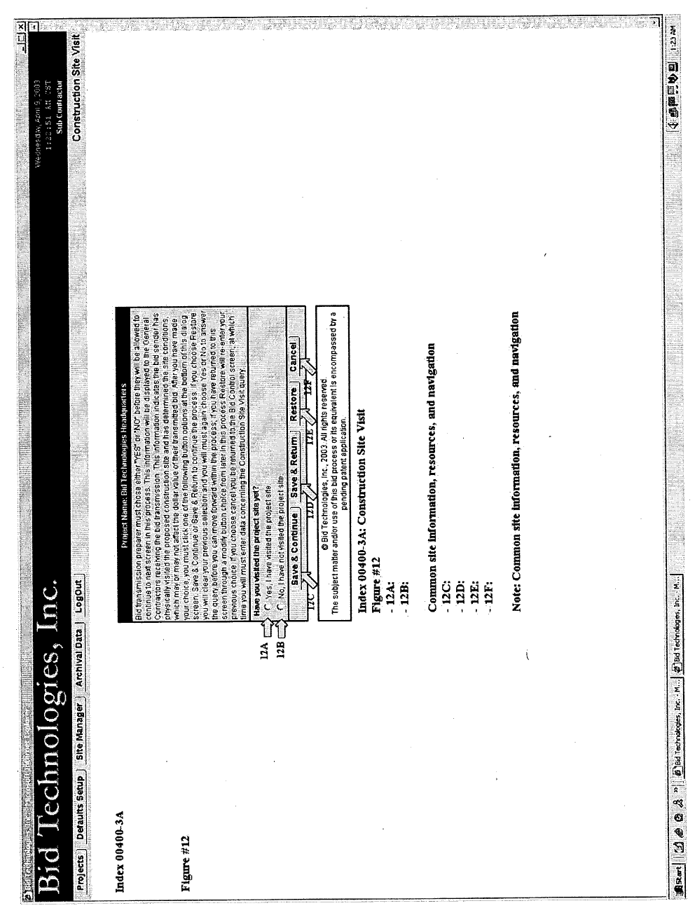

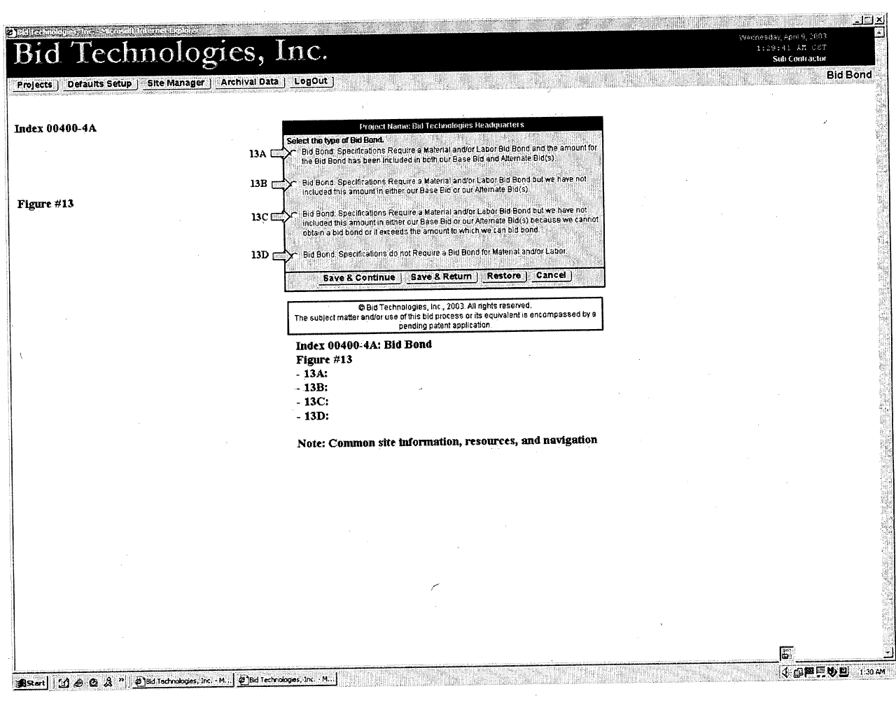

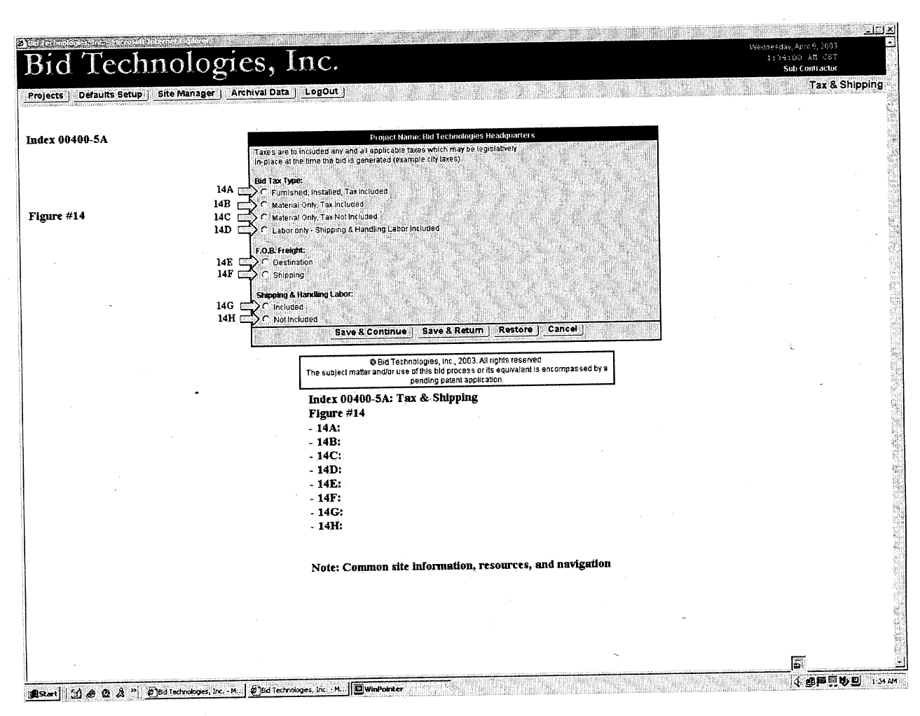

Upon selection of the “Bid” button for a specific project, the Member is re-directed to Index 00400-1A1, FIG. #7. The primary purpose of this Index is to provide the Member with a method to indicate to the process the start of new bid data input for the specific project the Member has chosen. The indication occurs when the Member selects the FIG. 7C—“Start New Bid” button. FIG. 7A displays the project for which the Member has chosen to enter bid transmission data. FIG. 7B—“View Details” is a button that provides the Member another opportunity to review the project's pertinent details that have been previously described within Index 00400-1A's—“View Details” button discussion. FIG. 7D—“Return to Projects” re-directs the Member to Index 00400-1A in the event the Members desires to begin a different project bid transmission data entry. Indexes 00400-1A2, 1A3, 1A4, 1A5, and 1A6 will be discussed as the Member utilizes our process creating their need here herein.

The system does present additional Indexes to the Member depending upon the Members previous actions that are similar to Index 00400-1A1, and provides the Members similar opportunities. These opportunities are the direct result of previous input actions taken by the Members. Index 00400-1A2, for example, results because the Member may have timed out (was inactive while logged on for a predetermined (by Bid Technologies, Inc.) time period of, for example, 20 minutes), may have either accidentally or intentionally closed their browser, may inadvertently shut down their computer, or may have suffered a computer crash. If any of these events occur, the Member will have to re-logon and proceed to the Project screen, re-choose the “Bids” button for the project they were working on and through redirection to the Project Bids screen displayed as Index 00400-1A2, FIG. #11. Hereupon the system displays items 11C, 11D, 11E, and 11F; in addition to the items that were previously displayed within Index 00400-1A1, FIG. #7. This index provides Members information relative to the system status of the specific project. Item #11C “Finish” button choice indicates to the system the Member has previously entered data within the project, and desires to complete the previous data entry indicated thus by item 11E “Status” column's “Incomplete” display, upon Member selection of the “Finish” button. Item 11D informs the Members of the projects original start time or rather the start time they began data input. Item 11F “Delete” button allows the Members to delete the entire input for the specific project. Again, as noted previously, the Member will have to re-logon and proceed to the Project screen, re-choose the “Bids” button for the project they were working on and through redirection to the Project Bids screen displayed as Index 00400-1A3, FIG. #20. Again, this Index provides information to the Members relative to the system status of the specific project. The system displays items as noted previously in Indexes 00400-1A and 1A2, as well as additional items. The additional items are items 20G, 20H, 20I, 20J, 20J, and new “Status” column text displayed. Item 20G “Bid Summary” button, item 20H “Modify” button, and item 20I “Pull Group” button are all located within the same cell. Item 20G “Bid Summary” button, upon Members' selection, redirects the Member to the Bid Summary Print screen. The Member options thereon are described within Indexes 00400-36A1 and 36A2. Item 20H “Modify” button, upon Members' selection, redirects the Member to the Modify Bid screen. The Member options described thereon are described within Indexes 00400-39A, 39A1, and 39A2. Item 20I “Pull Group” button, upon Members' selection deletes the bid to the “group” of Bid Receptors who are displayed within the Bid Receptor column (note—all of which have received the same bid) for the specific project bid. For additional information regarding item 20I see Index 00400-38A1, and 38A2. Item 20J “Pull Individual” button, upon Members selection deletes the bid to the specific line item Bid Receptor displayed regardless of whether the Bid Receptor is and individual line item or is a member of a “group”. For additional information regarding item 20J see Index 00400-38A and 38A2. To the right of this “group” cell are individual cells that co-align with this cell. These individual cells contain the names of each individual Bid Receptor that is a member of the “group” and to whom the Member has transmitted the same bid. Within the Status column two additional text descriptions Member indicators are displayed. The first of these is the “Complete Needs Review” status indicator. Further information relative to this status indicator is provided within Indexes 00600-1A5, Index 00600-1A51, and Index 00400-34A4, and results from Members action within these Indexes. The second of these is the “E-Mailed” status indicator. Further information relative to this status indicator is provided within Index 00400-33A1, and results from Member actions within the Index.

Again, as noted previously, the Member will have to re-logon and proceed to the Project screen, re-choose the “Bids” button for the project they were working on and through redirection to the Project Bids screen displayed as Index 00400-1A4, FIG. #21. Again, this Index provides information to the Members relative to the system status of the specific project. The system displays items as noted previously in Indexes 00400-1A, A2, and 1A3.

Again, as noted previously, the Member will have to re-logon and proceed to the Project screen, re-choose the “Bids” button for the project they were working on and through redirection to the Project Bids screen displayed as Index 00400-1A5, FIG. #22. Again, this Index provides information to the Members relative to the system status of the specific project. The system displays items as noted previously in Indexes 00400-1A, 1A2, 1A3, and 1A4 as well as additional items 22H (previously displayed within Index 00400-1A3, but not indicated with an arrow for discussion thereon). Item 22H “Bid Receptor” is a text indicator that titles the individual Bid Receptors listed below it in column format. The additional item is a new “Status” column text display indicator titled “Transmitted”. This indicator results from Member action within Index 00400-33A, and as such additional information is detailed therein.

Again, as noted previously, the Member will have to re-logon and proceed to the Project screen, re-choose the “Bids” button for the project they were working on and through redirection to the Project Bids screen displayed as Index 00400-1A6, FIG. #10. Again, this Index provides information to the Members relative to the system status of the specific project. The system displays items as noted previously in Indexes 00400-1A, 1A2, 1A3, 1A4, and 1A5, as well as additional items. The additional items are new “Status” column text display indicators titled “Parameters Transmitted” and “Parameters E-Mailed”. These indicators are displayed as line item records immediately adjacent to the line item individual Bid Receptor(s). The significance of these indicators is they indicate bids which have previously been transmitted incomplete to the Bid Receptors for these Bid Types: Base Bid—“I will have a bid transmission, but wish to forward my “Comments and Exclusions” for informational purposes prior to the transmission of my dollar value submission to the General Contractor(s).” and Alternate Bid Type—“Acknowledge Alternate—Bid & Submit Dollar Amount At A Later Time.” With these indicators, Members are able to determine which transmitted bids have to be completed by entering the “Unit of Measure” and “Bid Amounts” to be discussed later herein. The options created within the aforementioned Indexes are possible because the system has previously buffered and logged the data as it was entered into the system for this project.

Upon Member selection of the Index 00400-1A1, FIG. #7, item 7C “Start New Bid” button, the Member is re-directed to Index 00400-2A our initial Bid Control screen. Index 00400-2A, FIG. #8, items 8A-8H is a complex index containing the initial part of the Bid Control screen that concludes with Index 00400-2A1, FIG. #9, items 9A-9K. The discussion herein will cover both indexes and their associated items. Index 00400-2A, FIG. #8, item 8A begins our discussion with a displayed query for the Member. Item 8B is typical of all items and displays the Member's response to the previously displayed items (8A, 8D-8H and 9A-9J) within each cell and will be displayed to Bid Receptor(s) in the Member's Bid Summary, which will be discussed later herein (except the input for the Members Unit of Measure). Item 8C designates a typical “Enter Information” button that provides the input displayed in item 8B. Throughout the Bid Control screen, this button re-directs the Member to other Indexes to provide the Member an opportunity to provide various required input values through Member selection of radio buttons, check boxes, or text dialog input boxes as provided within the various Indexes. Please note that additional unshown indexes will display after an initial input by the Member in certain cells. These additional indexes occur in the “Base Bid Information” (unshown: Index 00400-10A, 10A1, 10A2, 10A3, 10A4, 00400-11A, 00400-12A, 12A1, and 00400-13A), “Alternate” (if any) (unshown: Index 00400-15A, Index 00400-16A, Index 00400-17A, 17A1, 17A2, 17A3, 17A4, Index 00400-18A, Index 00400-19A, and Index 00400-20A), and “Would you like to hold this bid?” cells, and are dependent upon the Member choice made therein.

Therefore, item 8A's query is answered by the Members radio button choice made after selection of the “Enter Information” button, subsequent re-direction to Index 00400-3A, and the Member choice thereon. The radio button choices provided within Index 00400-3A, FIG. #12 are item 12A—“Yes, I have visited the project site”, and item 12B “No, I have not visited the project site”. Not noted as an item, but still displayed is a cell that provides the Members information concerning their radio button choices. In general, this text instructs the Members whether their radio button choice is required, what will happen with the input, what is significant concerning the Member's input, and what their expectation should be concerning the common site navigation buttons.

After the Member's choice is made, each Member is given additional choices regarding the manner by which the Member may continue completion of the data entry required throughout the Bid Control screen process. These opportunities are provided through the common site navigation buttons provided the Member at the bottom cell of most Indexes. These common site navigation buttons are item 12C—“Save and Continue”, item 12D—“Save and Return”, 12E—“Restore”, and item 12E—“Cancel”. The function of the Save and Continue entry is to save the Member's choice or input and “automatically” continue to the next incomplete index requiring Member input in the process without returning to the Bid Control screen. Although it saves the Member's choice or input, it does not allow the Member to view the data as noted previously in item 8B, as it presents the next choice or input Index to the Member for choice or input. Save and Return—saves the Member's choice or input, and returns the Member to the Bid Control screen Index 00400-8A and 9A, and the Member input is displayed as noted in item 8B. The Member's must manually choose the next or any “Enter Information” button to continue the bid data entry process. This manual selection and entry can be done in any order the Member desires. “Restore”—undoes the current Member choice and re-inputs the choice prior to the current choice. In some cases this may result in no choice being displayed, as the Member has not made a previous choice to their current selection and then chosen the Restore button. “Cancel”—negates the Member's choice and returns to the Bid Control screen with either no data change if there had been a previous choice by the Member, or with no data entered if no previous choice had been entered by the Member. Given this assortment of details, a Members choice of the item 8C—Enter Information, and subsequent choice of Index 00400-3A, item 12A—“Yes” radio button choice could result one of two continuation modes, both saved the data entry. If the Member chose the “Save and Continue” they will continue to Index 00400-4A; conversely, if the Member chose “Save and Return” they will return to Index 00400-2A or rather the “Bid Control” screen, and have the choice of any “Enter Information” button thereon to enter data. For purposes of clarity, this discussion will assume the Member consistently chooses the “Save and Return” option and then chooses the next “Enter Information” button in consecutive item order. Given these parameters the next item is item 8D—Bid Bond Type and with its “Enter Information” button selected the Member is re-directed to Index 00400-4A.

Index 00400-4A, FIG. #13 provides the Member with four radio button choices items 13A-13D relating to potential Member's Bid Bond types. A Bid Bond is either a specified amount of certified monetary funds set aside by the Owner/Bid Receptor or an insurance policy issued by authorized insurance companies to the benefit of the Owner/Bid Receptor, both of which are enforceable to insure the Member provides the requisite Materials or Materials and Labor necessary to complete its Bid category requirements. In either case the Bid Bond requirements are detailed within the specifications issued for the project. It is possible to provide a hypertext link or other direct on-line link to the issuer of a bond to certify the validity of a third party bond. Passwords for access to the hypertext link to the bond issuer may also be provided as needed, which password may be simply the transaction number for the bond issuer. In view of the extent to which fraud has occurred in the securing of bids, verification systems or mechanisms for items is desirable. Even references may be provided by hypertext links. Item 13A indicates the project's specification require either a Material and/or a Material and Labor Bid Bond, and by this choice the Member indicates its inclusion of the Bid Bond amount within its bid amounts transmitted for both base bid amounts and/or alternates bid amounts associated with the bid requirements. Item 13B indicates the Member's acknowledgement of a Bid Bond requirement within the specifications for the project, but explicitly excludes them from inclusion in its base bid amount and/or alternate bid amounts associated with the bid requirements. It does not indicate to the Bid Receptor that it can not obtain the requisite Bid Bond, but simple states it is not included in the Member's bid amount(s). Item 13C is similar to item 13B with the exception that it clearly indicates to the Bid Receptor(s) the Member either cannot obtain the requisite Bid Bond or that the requirement exceeds the amounts it can obtain for any reason for the Bid Bond requirement. This declaration may allow the Bid Receptor(s) to provide for this requirement in the event they later chose to contract with the Member for its work categories. Item 13D clearly indicates the project specification do not require a Bid Bond for either Material or Material and Labor bids. For purposes of discussion, we will assume a Member choice of 13D, and again, a choice of the “Save and Return” button. The next Bid Control item is item 8E—Tax & Shipping Information and with its “Enter Information” button selected the Member is re-directed to Index 00400-5A.

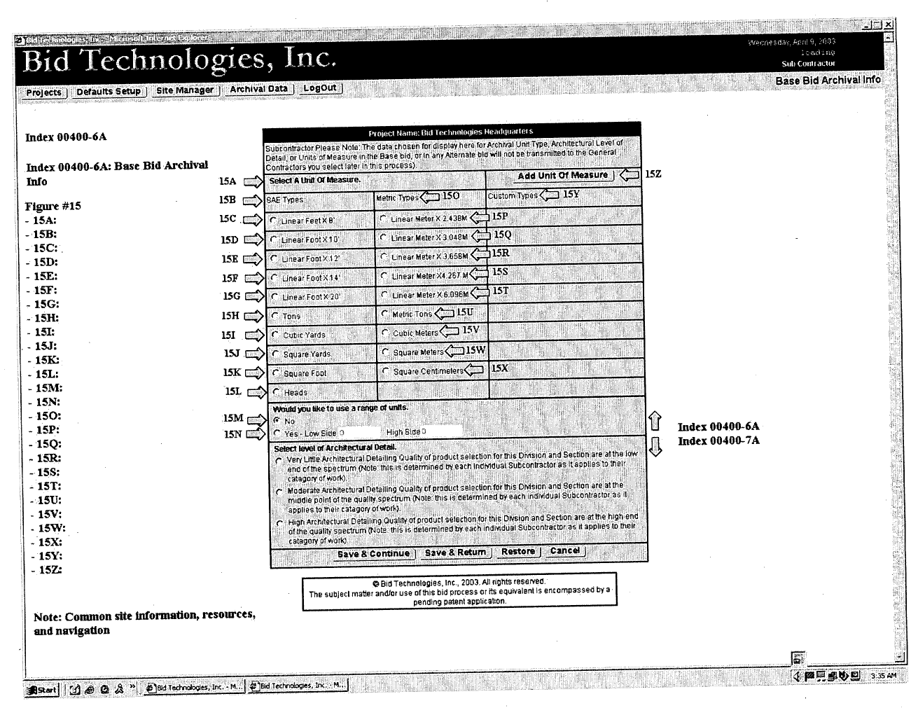

Index 00400-5A, FIG. 14 provides Members with four radio button choices items 14A-14D concerning it tax inclusion, two radio button choices relating to its F.O.B. designation items 14E-14F, and two radio buttons relating to its labor inclusion relative to items it will be shipping to the site items 14G-14H. Depending on the Members choices in items 14A-14D, button items 14E-14H may be available for Members' choice or not be available for Members' choices. This discussion can begin with the Member's choice of item 14A—Furnished, Installed, Tax Included. This radio button choice indicates to the Bid Receptor(s) the Member has included such taxes as Use Tax, City Taxes, County Taxes, or other taxes as required by governmental authorities for the Conduit the project is located within. By this choice the Member has included not only the taxes associated with its work categories but also shipping cost and all labor necessary to installed all materials furnished within its work categories subject to any limitations the Member may include, state, or make available to its Bid Receptor(s) within its “Comments and Exclusions” area yet to be described within the Bid Control screen process. A Member's choice of this radio button precludes their selection of any other radio button herein, because all other choices are included within this choice. The choice of a radio button by a Member disables the Member's ability to choose another button or button combination. Item 14B indicates to the Bid Receptor(s) the Member bid is for furnishing Materials only with taxes as required by governmental authorities. Item 14C indicates to the Bid Receptor(s) the Member's bid is for furnishing Materials only with no taxes as required by governmental authorities. These options requires the Member to further indicate to the Bid Receptor who will paying the shipping cost known as Free On Board (F.O.B.)—Destination or F.O.B.—Shipping. If the Member's bid includes shipping cost its bid is transmitted as F.O.B—Destination and therefore Member selection of item 14E. If the Member's bid does not include shipping cost it is transmitted as F.O.B.—Shipping and therefore Member selection of item 14F. Items 4B, 14C, 14E, and 14F require the Member to further indicate to the Bid Receptor(s) if “Shipping” labor is included to unload delivery vehicles and if “Handling” labor is included to delivery materials to the various locations from which they are to be installed from within/on the site. Item 14D is a special inclusion which may provide Bid Receptor(s) a methodology to recruit and have submitted Member bids for labor for work categories which are typically Material only categories. This inclusion for Bid Receptors may mean the Bid Receptor(s) are able to calculate their profit margins more closely or profitably due to the reduction of risk factor that generally accompanies a firm bid from a Member. For purposes of discussion, we will assume a Member choice of 14A, and again, a choice of the “Save and Return” button. The next Bid Control item is item 8F—Base Bid Archival Information—Archival Unit Type and with its “Enter Information” button selected the Member is re-directed to Index 00400-6A.

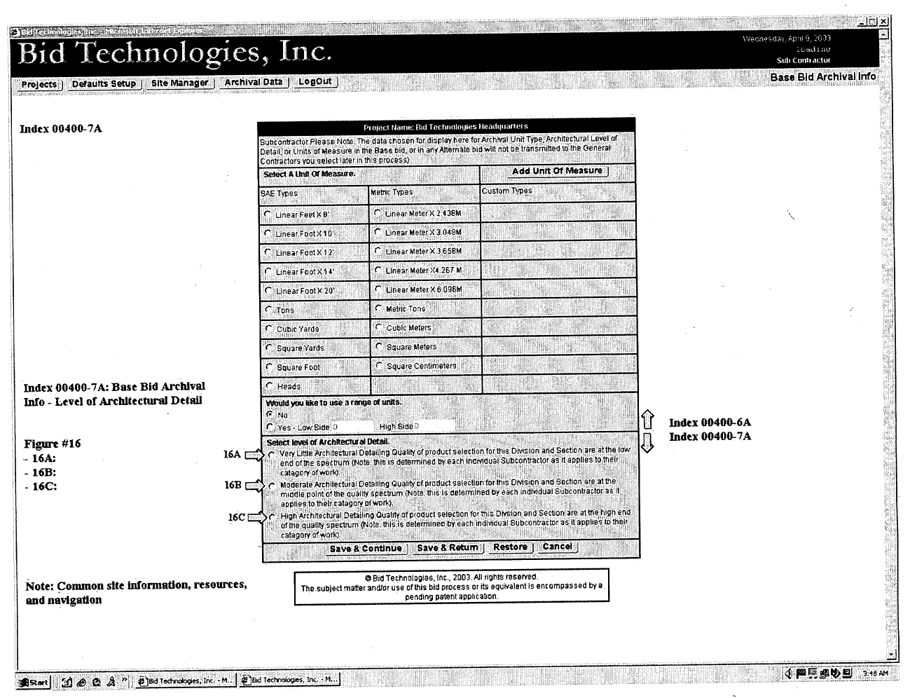

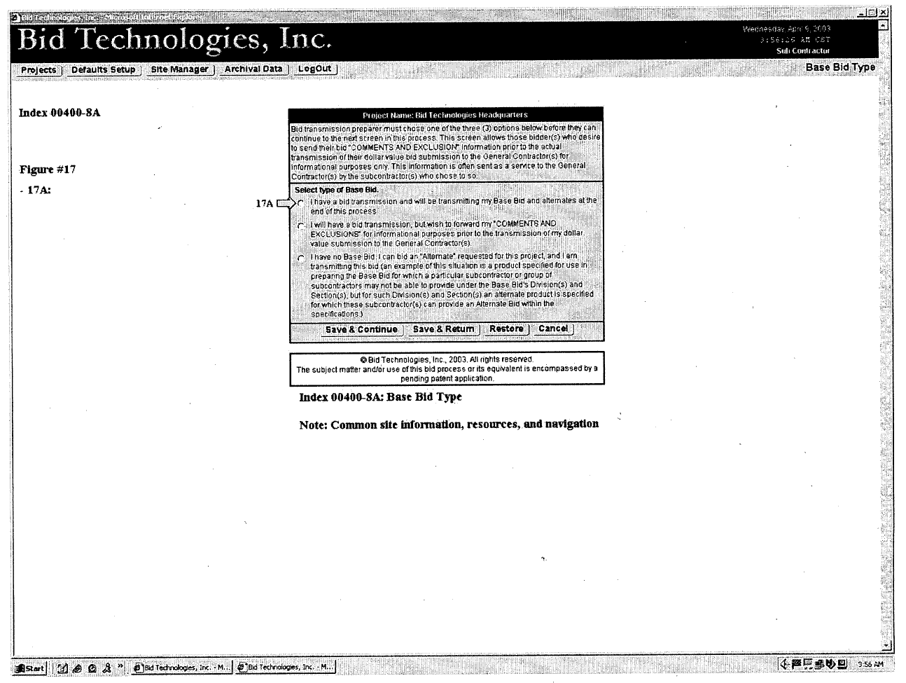

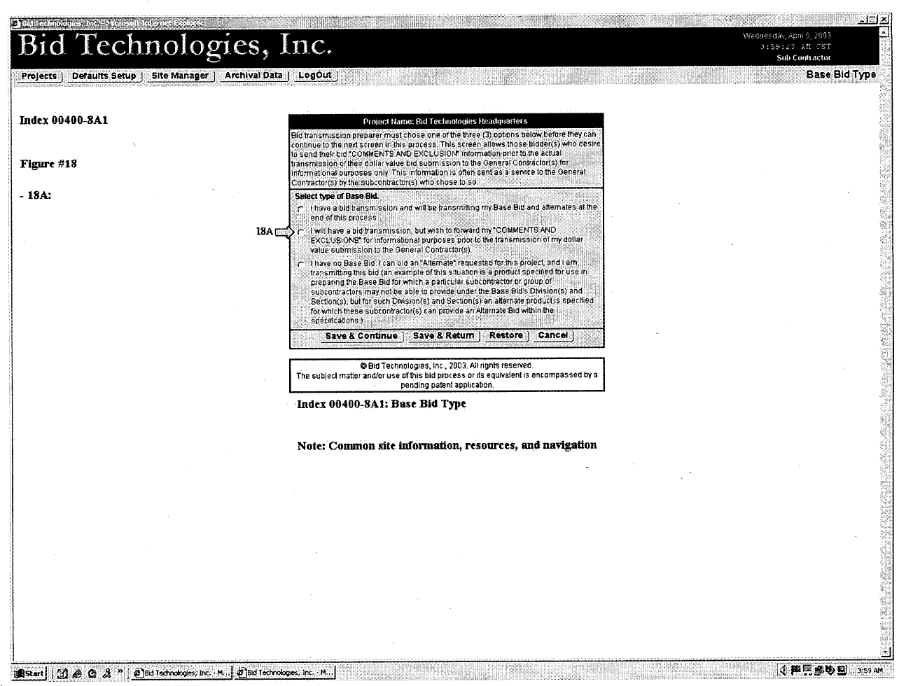

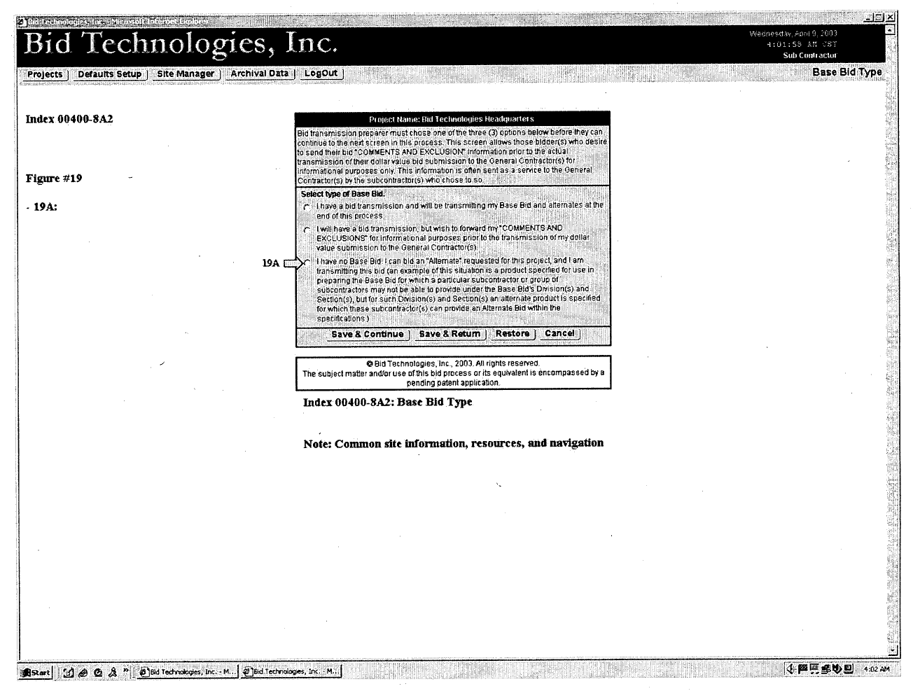

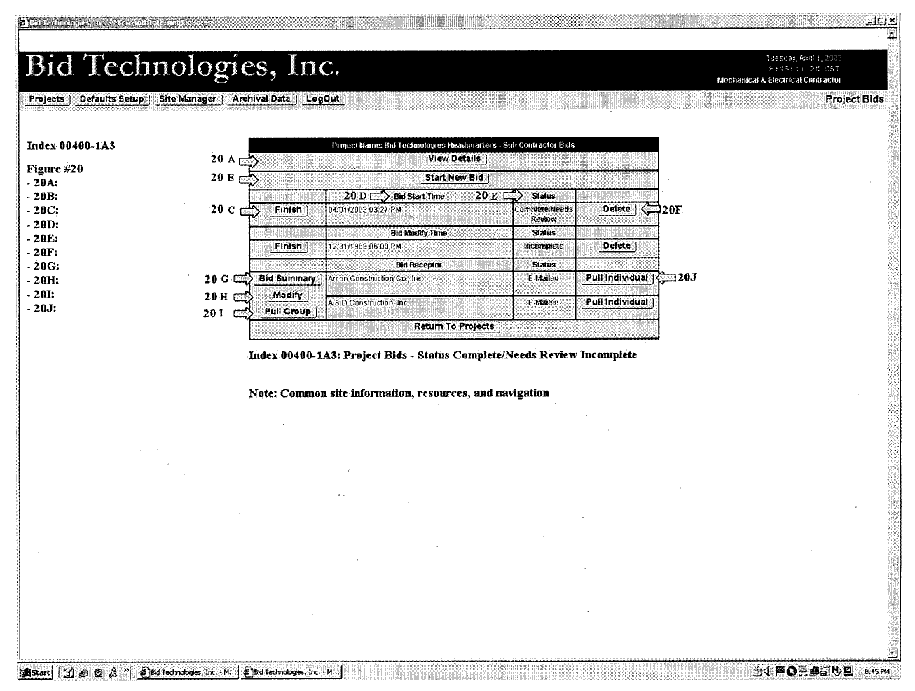

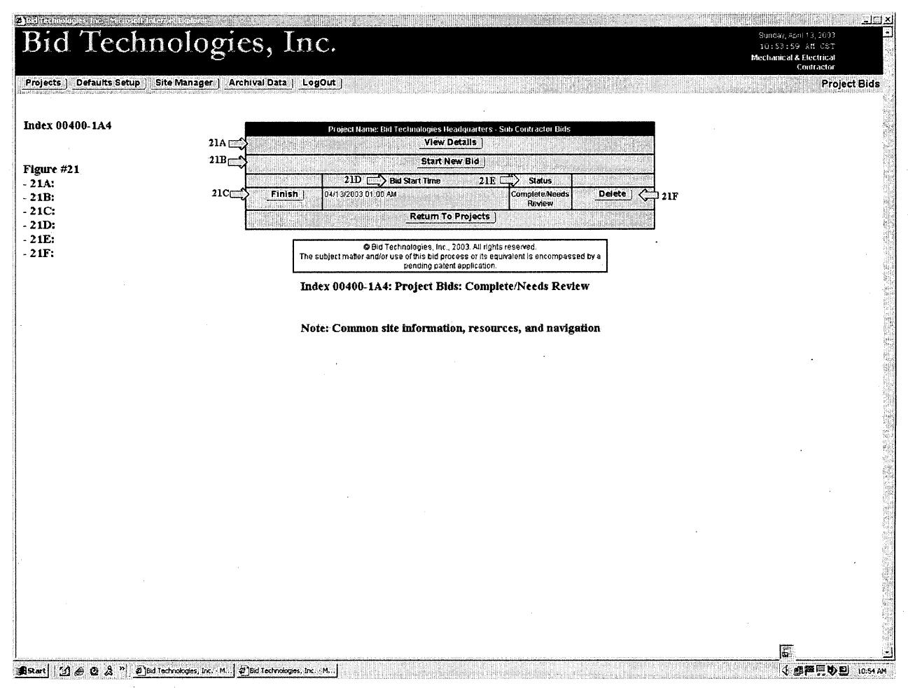

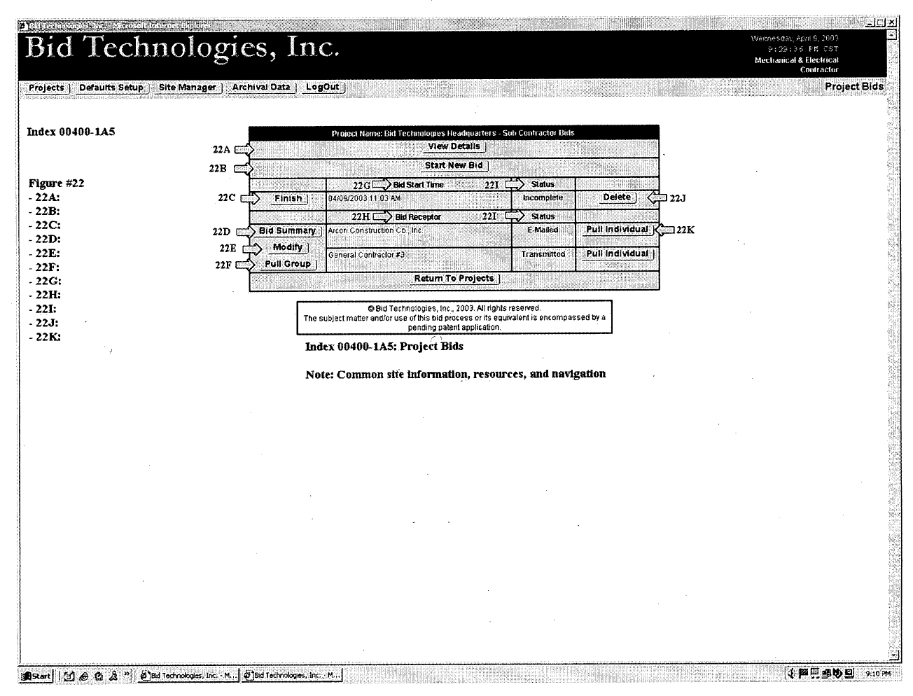

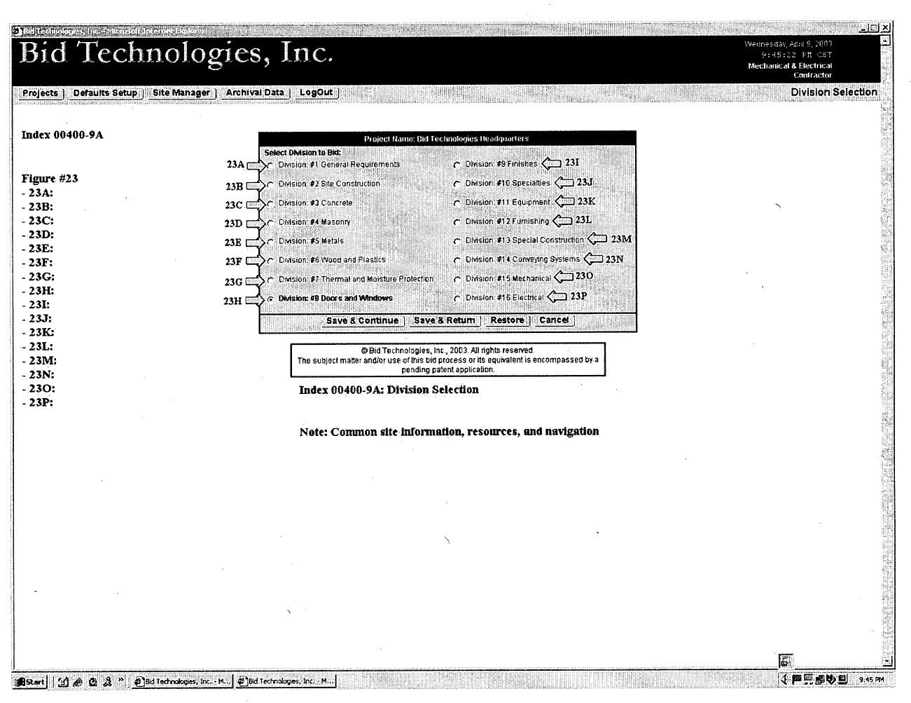

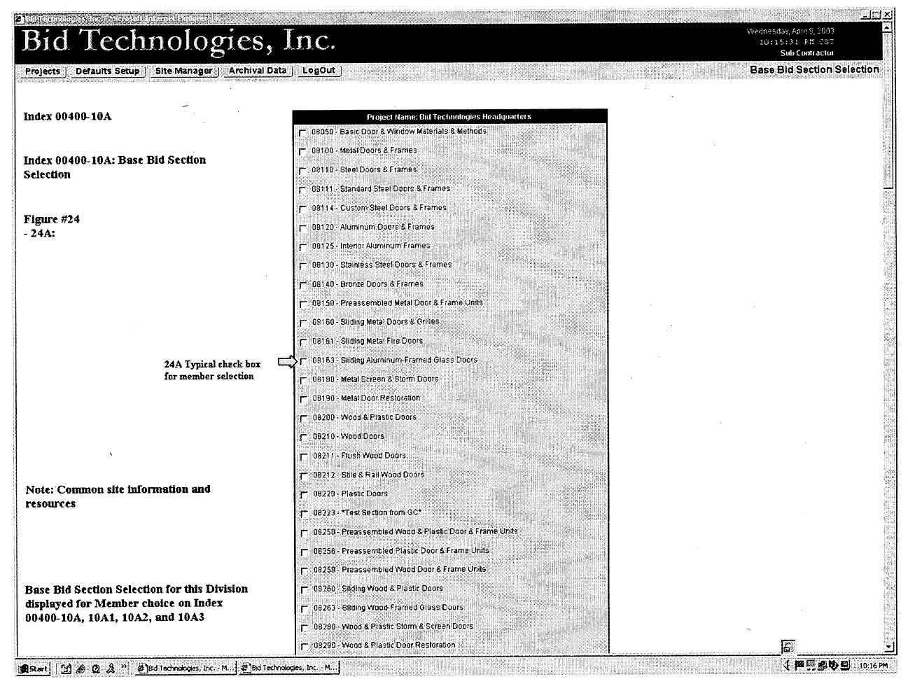

Index 00400-6A, FIG. 15 provides Members with a number of various default Unit of Measure choices defined as items 15C-15L SAE or items 15P-15X Metric. These choices are indicator values specific to each Member's work categories. They relate to system work categories as determined and inputted by the Originator of the projects. The values are the cumulative historical bid averages for a specific work category by which a Member may generally determine the success of their current bid based upon comparison of the current bid amounts to their individualized historical averages. They are relevant because the Member has previously inputted the specific work categories values into these archives during their previous bid activities. In a sense these values are individual books written by each Member and available to them in a real time basis for comparison should they elect to display the options either solely to the Member Site Manager or other Member users. This capture of Unit of Measure values by work categories also sets up the capability to have the Member visually notified when the current bid amount Unit of Measure of value measure is “Out of Parameter” due to comparison to the archive Unit of Measure of value measure for the same work category. This characteristic is described later herein under the Site Manager Index. In addition to the default values provided, Members may input a custom value through selection of item 15Z “Add Unit of Measure” button. For example a particular Member may utilize the average bid amount per ton of material supplied or installed as a bid checking method to determine quickly if their current bid amount is accurate. This value can be computed based upon the type of work category and the amount of architectural detail within the work category detailed. The project work category is an inputted item by either Architect or Bid Receptor, and is an item briefly discussed previously under Index 00400-2A Architect and/or Project Type. Each individual Member will determine the amount of architectural detail for its work categories within Index 00400-7A, described hereafter. The project being bid is a one-story office building. The general assumption made herein is the bid amount for a ton is less expensive for a one-story office building than it is for a twenty-story office building. Item 15A is a cell that instructs the Member to “Select a Unit of Measure”. Items 5B, 15O, and 15Y are descriptors labels of the Units of Measure a Member may chose to select. Members will notice they are able to make only one radio button choice at time, but they may change this indicator from project to project as required, or as detailed later—a Site Manager may setup a specific Unit of Measure as the Member's default Unit of Measure. Items 15M and 15N are unique in that they allow the Member to potentially dial in a specific range of Units of Measure to utilize for comparison within the current project which again has the potential to more accurately compare the current project Unit of Measure to historical Unit of Measure averages for the same range of Units. Item 15M is a default setting for the range, which is set to No, as in all likely hood a specific Member's archive will require a certain amount of time and number of bids in order for the range search to be effective. Item 15N allows the Member to input the low and high side of the Unit of Measure range search. This range search will limit the Unit of Measure comparison to the range selected provided there are previously inputted values within the inputted range. Item 15Z “Add Unit of Measure” provides the Member a methodology to input its own unique Unit of Measure for selection and system processing under the 15Y custom Unit of Measure label. The purpose of the Units of Measure is to provide the Member a methodology to quickly check the accuracy of their current bid amount based upon the following: #1 their unique Unit of Measure previously inputted bid amount history in comparison with their Unit of Measure current bid amount; #2 their bid category average Unit of Measure history in comparison with the chosen Conduit Unit of Measure history average for the same bid category; and #3 in future as we build out the system similar comparisons by region and national if the Member so desires to make such a comparison. The next Bid Control item is also an “8F” item—Architectural Level of Detail and with its “Enter Information” button selected the Member's re-direction to Index 00400-7A. Index 00400-7A co-inhabits on the Base Bid Archival Info screen along with the previous described Index 00400-6A. It should be further noted that both avoirdupois and metric units are enabled in the bid, allowing the system to be used in the U.S. for accepting international bids with greater facility. The system may also contain unit conversion software to facilitate such bids. For example, if the bid specification is in meters, a bid submitted in avoirdupois units of feet or yards would be automatically converted and the appropriate units inserted into the bid. This would help avoid errors by persons working in unfamiliar units.

Index 00400-7A, FIG. #16 provides the Members three radio button choices relative to the level of Architectural Detail associated with the current project. These options are inputted by the Member specifically to reflect their determination of the composite level of quality of the Materials to be bid for the project. For example: a Member who's primary bid activities are within the masonry work category may consider typical 6×8×11 cinder blocks to be very little architectural detail when compared to burnished block of the same dimensions. Because the Member determines the level of Architectural Detail within the project, they are enabled to further define their current bid values relative to their historical work category values. Continuing the previous example, cinder block masonry Unit of Measure values would generally be considered less expensive than burnished block masonry Unit of Measure values within the same work category designation. The system recognizes three separate level of classification for Architectural Level of Detail—item 16A-16C. Item 16A—“Very Little Architectural Detailing” indicates the quality of product selected for this Division and Section are at the low end of the quality spectrum as determined by the individual Member for its work categories. This does not mean the product is unsuitable for use on the project. Item 16B—“Moderate Architectural Detailing” indicates the quality of the product selected for this Division and Section are at the mid point of the quality spectrum as determined by the individual Member for its work categories. Again, this does not mean the product is unsuitable for use on the project. Item 16C—“High Architectural Detailing” indicates the quality of product selected for this Division and Section are at the high end of the quality spectrum as determined by the individual Member for its work categories. Again, these designations do not mean the product is unsuitable for use within the project. More to the point, these allowable variations in the bid relating to architectural detail allow flexibility on the part of the prime contractor to vary detail based on input from the ultimate customer and indicate a range of cost depending upon variations imposed by the ultimate client (e.g., the purchaser).

The combination of Unit of Measure selection within Index 00400-6A and Architectural Level of Detail selection within Index 00400-7A allows Members to refine and define comparisons between their current bid values and the archive values for similar projects as inputted by the project Originator, Units of Measure as determined by the Member, and Architectural Levels of Detail as determined by the Member. The next Bid Control item is item 8G—Base Bid Information—Bid Type and with its “Enter Information” button selected the Member is re-directed to Index 00400-8A. It is important in the submission of the bids to enable flagging of significant variations, exclusions and comments to the reviewer of the electronic bids. It is to be noted that bids can be evaluated automatically by this system for ranking. One of the parameters of the quality or merits of a bid could likely be the adherence to the specifications and the lack of variations from the originbal specification and the completeness of bidding on all components of the contract. Another aspect of flagging bids is the capability of the system analyszing bids to flag extreme variants in individual components of a bid or a total bid. For example, if all bids but one are within a standard deviation of ±20% and one bid is at a 50% variation from the standard or average, the system would alert the bid reviewer (which could be a processor or microprocessor for the initial evaluation), and the system could individually alert the bidder after the bid has been submitted (by electronic notice, immediately or subsequent to a collection of a substantial number of bids. This would alert the bidder during the open period of a desire to review specific aspects of the bid.

Index 00400-8A, FIG. #17, provides the Members three radio button choices to determine the manner in which they will input their Base Bid values and transmit them to the Bid Receptors. Item 17A—“I have a bid transmission and will be transmitting my Base Bid and Alternates at the end of this process” provides the Members a channel through which they enter their bid data, alternate data, comments and exclusions, select their Bid Receptors and transmit their bids in a sequential process from beginning to end of the process. In a sense it is the ordinary everyday type process. The next Bid Control item is item 8G—Base Bid Information—Division Selection and with its “Enter Information” button selected the Member's re-direction to Index 00400-9A. Before discussing this redirection, a discussion of Indexes 00400-8A1 and 00400-8A2 will be completed as they relate closely with Index 00400-8A.

Index 00400-8A1, FIG. #18, provides Members three radio button choices to determine the manner in which they will input their Base Bid Values and transmit them to the Bid Receptor(s). Item 18A—“I will have a bid transmission, but wish to forward my “Comments and Exclusions” for informational purposes prior to the transmission of my dollar value submission to the General Contractor(s).” provides the Members a channel to inform the Bid Receptor(s) about as much information concerning their bid's terms, conditions, and “Comments and Exclusions” relative to the project as the Member wishes to transmit to the Bid Receptor(s) prior to transmitting their bid dollar values at the time and day appointed for same. This channel allows the Members to inform the Bid Receptor(s) of the salient facts concerning their bid without transmitting a dollar value. Bid Receptor(s) receiving this channel information can better evaluate their own bid parameters based upon information they might not ordinarily know until bid day has arrived.

Index 00400-8A2, FIG. #19 provides Members three radio button choices to determine the manner in which they will input their Base Bid values and transmit them to the Bid Receptor(s). Item 17C—“I have no Base Bid. I can bid an “Alternate” request for this project, and I am transmitting this bid . . . ” indicates to the system the Members can not bid the Base Bid requirements for the project, but indicates and sets up the system for the Member to bid Alternates associated with the project. For example: The bases bid requirements are for product X that the member cannot normally provide a bid. Alternate G1 provides an opportunity to provide product M in lieu of product X. This channel allows the Member to designate they have no base bid to the system, but they will bid an alternate bid request for the specific project. This option directs the system to begin with the Alternate Bid Types beginning within Index 00400-14A.

Indexes 00400-8A, 8A1, and 8A2 each inform the system how the Members will transmit their Base Bid values and the manner in which the process will proceed in accomplishing the task. Only one of these specific Indexes can be active for the project at a time, although the Member may change their selection and proceed, indeed the system utilizes just such a change to transfer from Index 00400-8A1 and return to Index 00400-8A to complete the Base Bid dollar value transmission, as well as related operations necessary for this change to be processed (see Indexes 00400-2A4 “Comments and Exclusions” for 8A1 and Index 00400-2A3 “No Base Bid—Alternate” for 8A2 for further information relating to these modifications). We now continue with re-direction to the next Bid Control item noted as item 8G—Base Bid Information—Division Selection and with its “Enter Information” button selected the Member is re-directed to Index 00400-9A.

Index 00400-9A, FIG. #23 provides the Members various radio button choices “23A-23P” to designate their major work categories to Bid Receptor(s) which are commonly known as Divisions. Originators indicate the inclusions of the various Divisions when they put forth their “Plans and Specs” which detail which Divisions are included within them and consequently inform the prospective bidders. Within our process, a Member may bid and transmit one Division bid at a time. Consequently the Members are enabled to choose one radio button at a time. In order to bid additional Division(s), Members must enter each Division as a separate bid for each the project and transmit it as a separate bid transmission. Any terms, conditions, etc. concerning both Divisions may be set out within the “Comments and Exclusions” Index of both bid transmissions that will be discussed later herein. It is allowable in a variant of the present system to send multiple Division bids in a single transmission and have the receiving system parse the bids into separate Division bids.

Division selection can also be designated within the Default Setup—Index 00500-1A1 or setup within Site Manager—Index 00600-1A1, and both Indexes are discussed later herein. Members can override Division selection designated within Index 00500-1A1, but can only chose one Division from the Division(s) designated within Index 00600-1A1.

Index 00400-9A1, FIG. #77 is a special alternative case of Division selection for Members that are bidders of Divisions 15 Mechanical or 16 Electrical. The Originator of the project can designate these Divisions as Assigned Prime Bids. Assignment causes the Assigned Prime Divisions to appear bold when presented to the Members for Division selection within our process. Assignment has two implementations. Implementation #1 occurs when the Originator designates one or both of these Divisions for Assignment. Members transmit their completed bids to either the Originator or Owner's representative rather than to the various Bid Receptors. Upon receipt of the Assigned Prime Divisional Bids the Originator or Owner's Representative determines who the successful Assigned Prime Bidders are. Again, upon the Originator or Owner's Representative's selection of the successful Assigned Prime bidder(s) the Originator or Owner's Representative forwards the successful Member(s) bid data to the various Bid Receptor(s) for inclusion within their project bids as subcontractors to them. This implementation chooses the Member(s) the Originator or Owner's Representative designates to the various Bid Receptor(s) to utilize in the construction of their own bids for the Assigned Prime Division(s). Implementation #2 follows Implementation #1 except the various Bid Receptors are not provided the Members bid data to prepare their own bids, but rather the Bid Receptors are required to provide an Assigned Prime Bid percentage add on to used by the Originator or Owner's Representative to calculate, review, and utilize in determining the successful project bidder. The next Bid Control item noted as item 8G results from the Member selection of a Division and results in additional Indexes 00400-10A, 11A, 12A, and 13A being displayed with the Sections “Enter Information” button selected the Member is re-directed to Index 00400-10A.

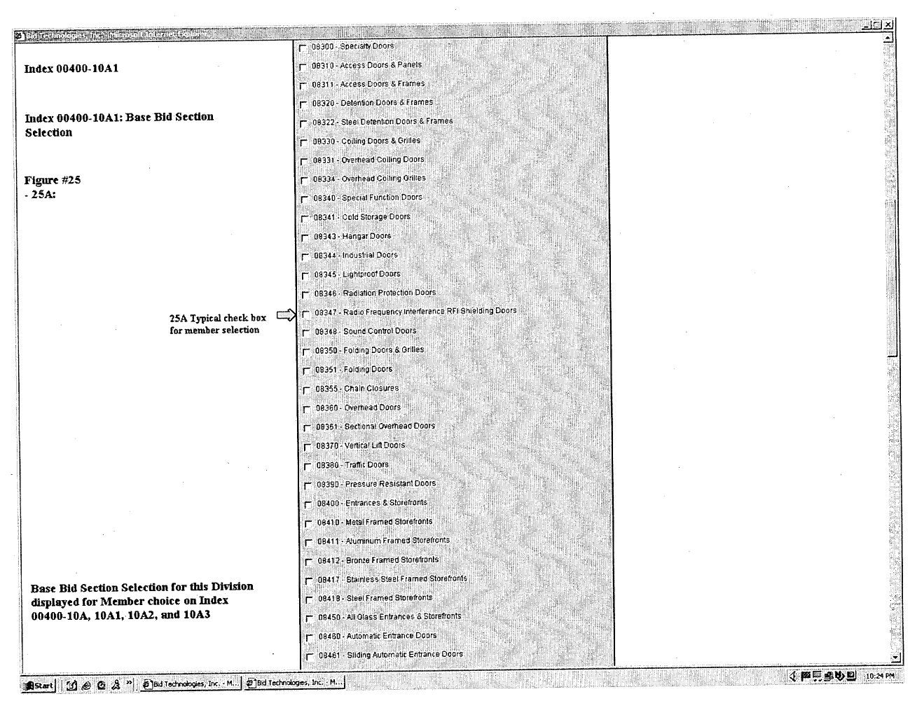

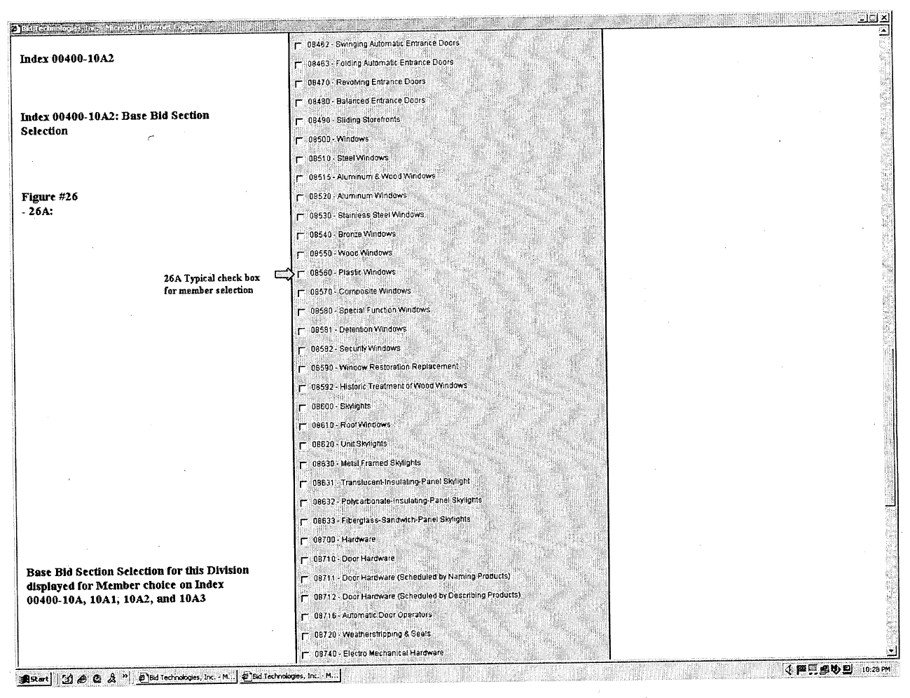

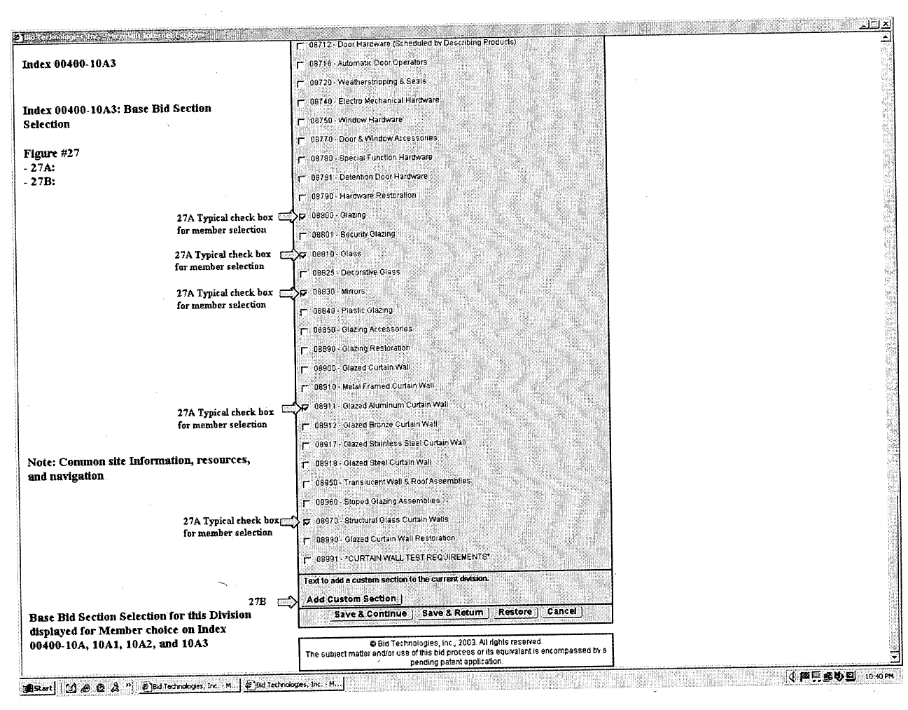

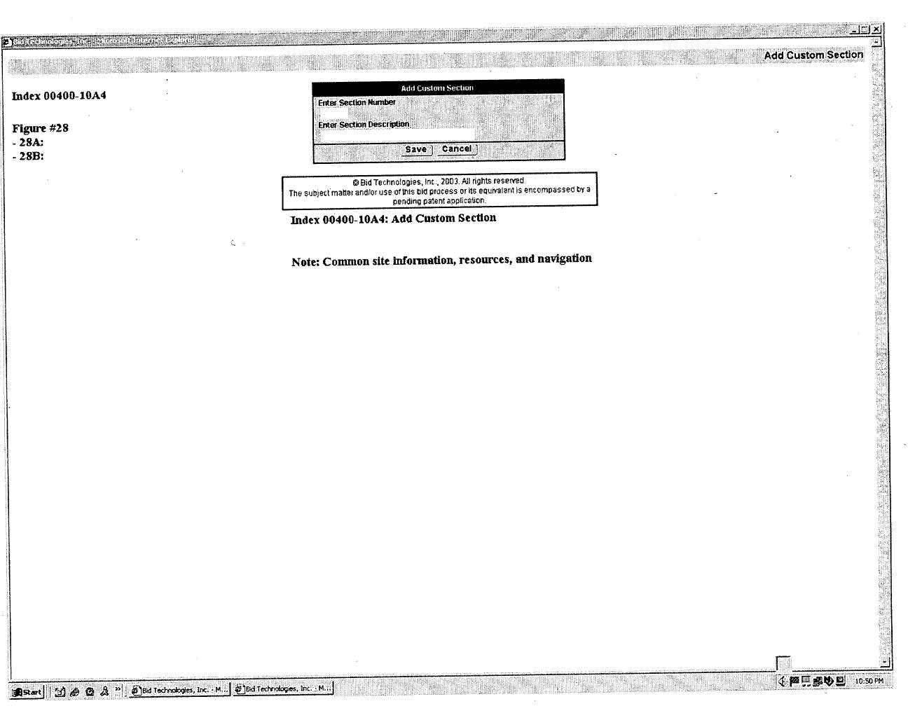

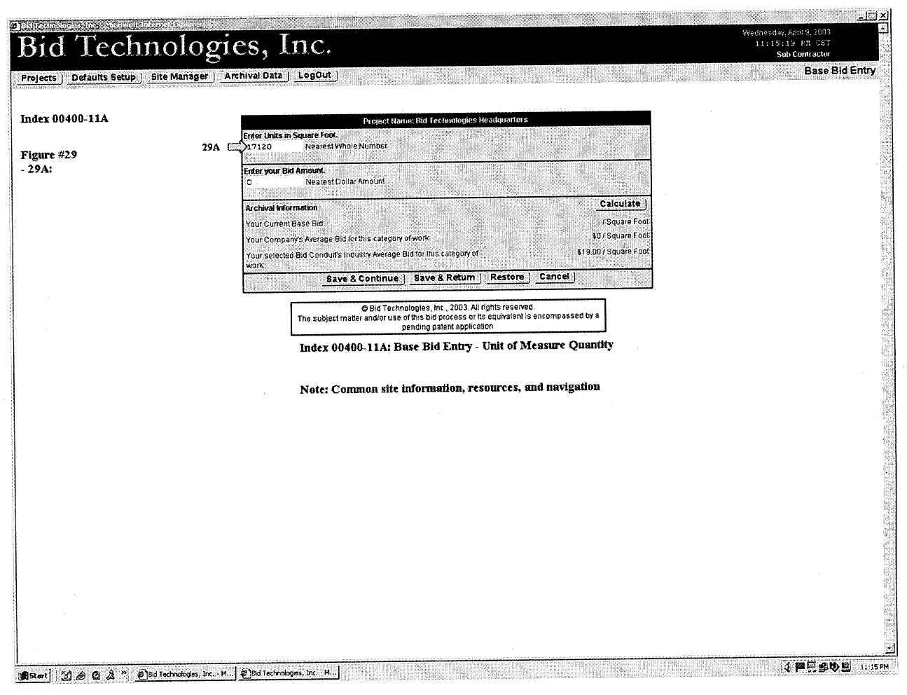

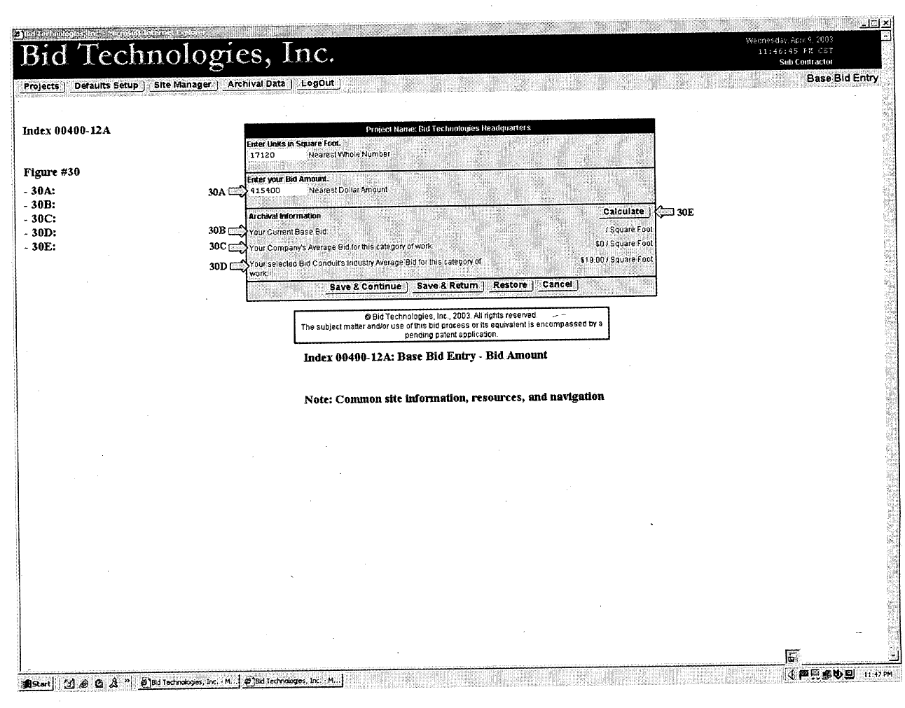

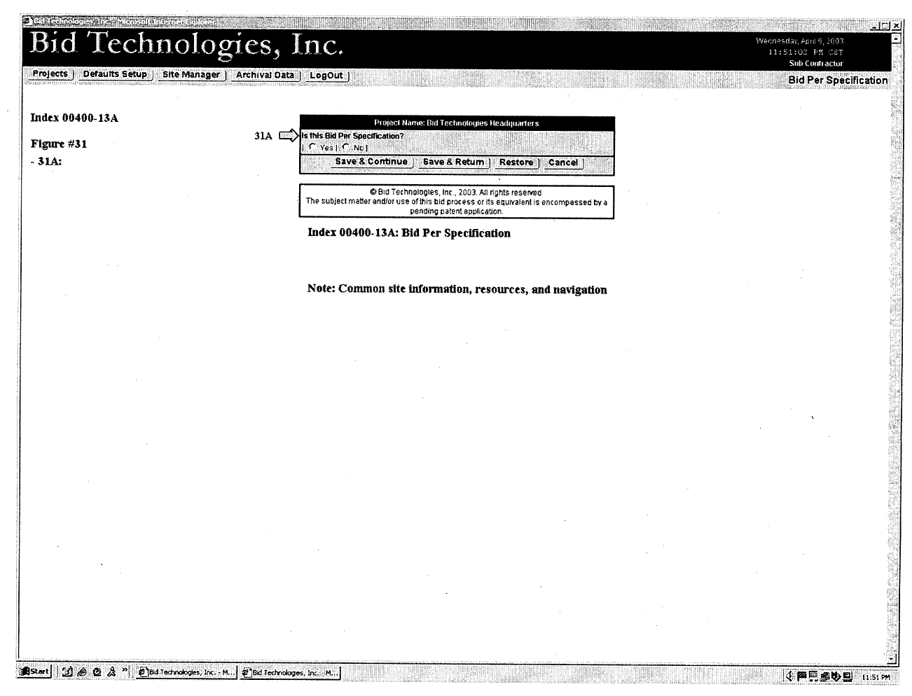

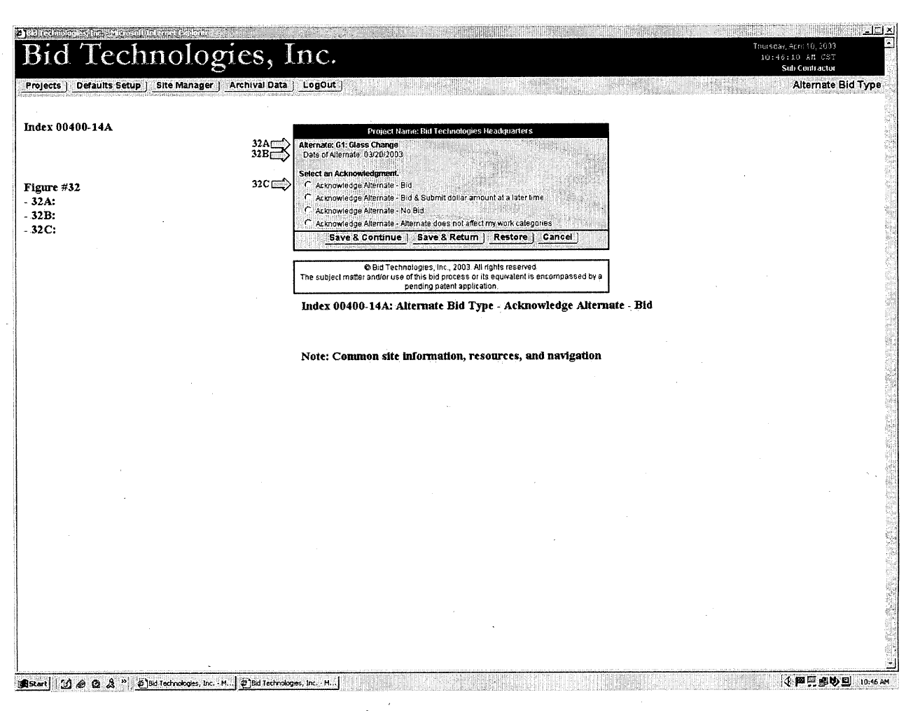

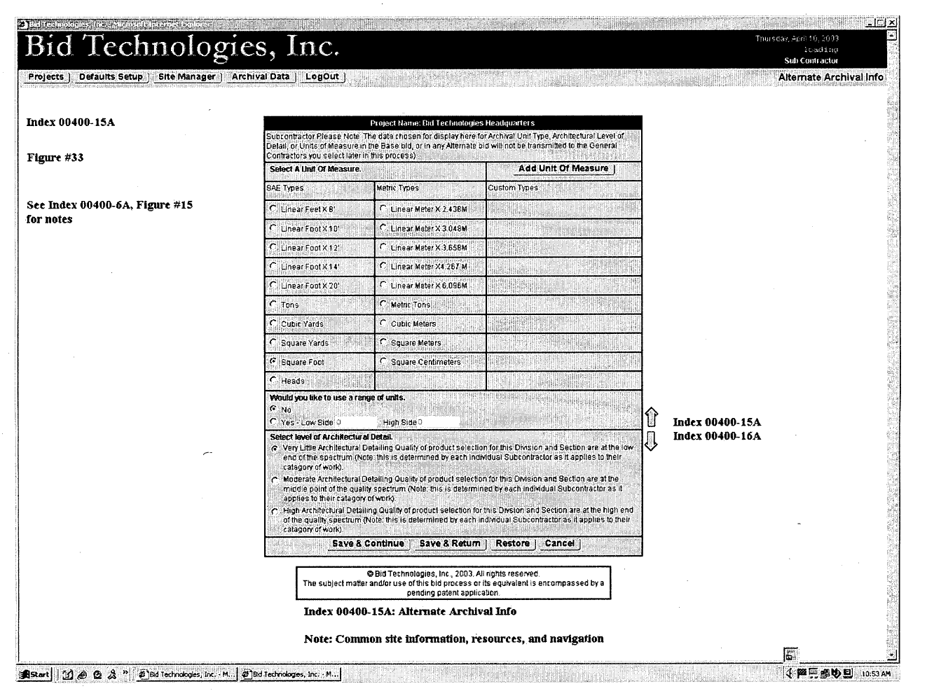

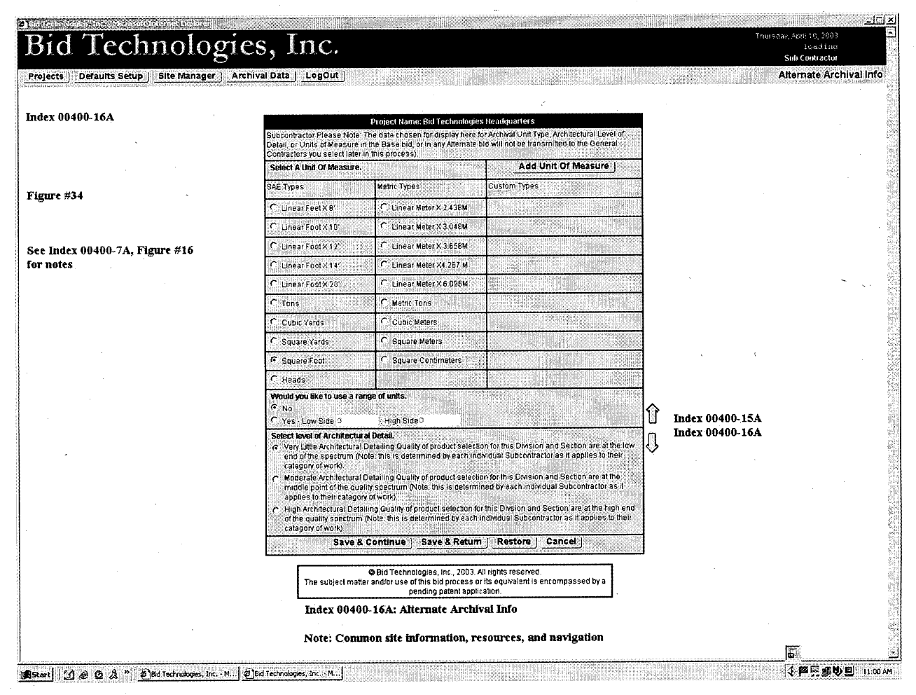

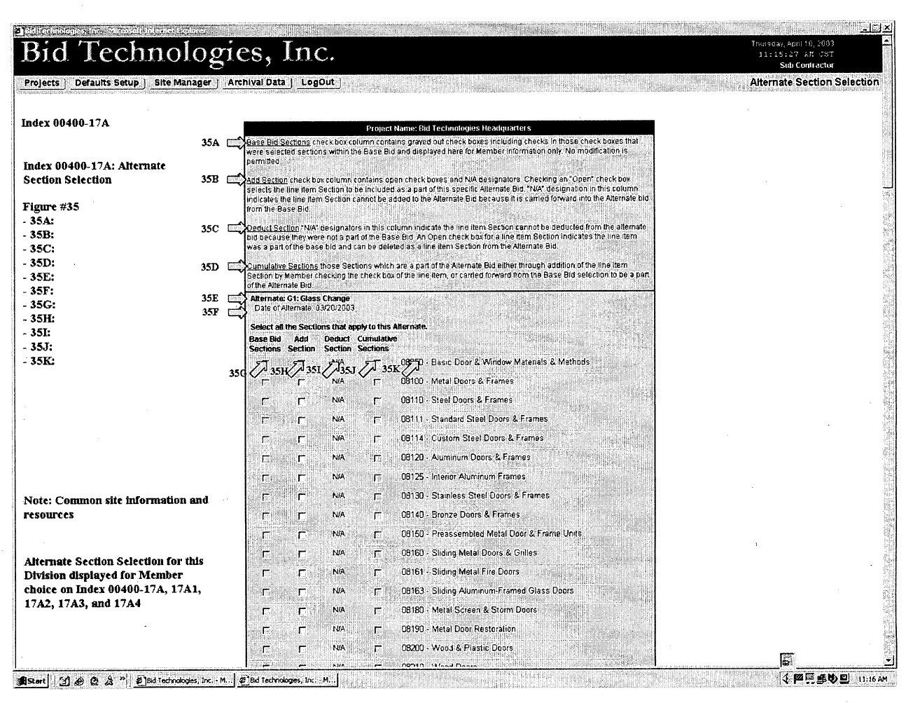

Index 00400-10A, FIG. #24, presents the various Sections within the Division to the Members for Section selection. Sections are sub-categories of work within a major work category known as a Division. Members choose as many Sections within a Division as they are providing bid data for. The number of Sections per Division varies with the project. Some Sections may not be required to complete the project, and are therefore excluded from the “Plan and Spec's” included Divisions and/or Sections designations. Sections are not available for Default Setup or for Site Manager designation as default Sections. Members must choose each Section under a specific Division for each project. A Member may bid each Division with one Section as a separate bid transmittal to the Bid Receptor(s), but the normal operation is to select all Sections within a Division and transmit the cumulative Sections and bid data to the Bid Receptor(s). Sections provide lists of standard variations known in the art for the performance under a specific element of the bid component. For example, FIGS. 24, 25 and 26 shows many variants for window and door treatments or constructions.

Bid Receptors, generally speaking, desire to contract with as few subcontractors as possible on a given project. This desire is based upon the premise that the fewer entities to organize, supervise, and watch over on a project, the lower the given risk will be to the Bid Receptor and consequently the greater the profit generation possible from the project. Given this premise, our system places a higher value on multiple Section bid transmissions, and defaults within the Bid Receptors area to multiple Section bidders as opposed to a combination of single Section bid transmitters to determine the default low bidder. Bid Receptor(s) do not have to accept the defaults and have additional methods to select the bids they wish to utilize in constructing their transmitted project bids.

Section selection, as noted herein, requires additional indices to display the sum of the various Sections for the chosen typical Division as displayed within the Section selection screen. The additional Indices required to Display all of the various Sectional choices displayed within the Section choice screen are Indexes 00400-10A1, FIG. #25; 10A2, FIG. #26; and 10A3, FIG. #27. Given these Indexes and 10A all have a typical check box noted as 24A, 25A, 26A, and 27A. These typical check box choices are indicative of all the various other check boxes displayed that a Member may chose to select and consequently designate a specific Section as an included Section for which the Member will be transmitting bid data as a part of their bid transmission. Index 00400-10A3, FIG. #27, item 27B “Add a Custom Section” button provides Members a methodology to enter a Section not included within the displayed Section and transmit same to the Bid Receptor(s). In the event a custom section is require and upon the Member's selection of the “Add a Custom Section” button, the Member is linked to Index 00400-10A4, FIG. #28. This Index provides item 28A that provides a text entry box that enables the Member to provide a custom Section number. FIG. #28 also contains item 28B that provide the Member a text entry box that enables the Member to provide a descriptive text for the Section number entered in item #28A. Upon completion of the text entry and selection of the common site navigation button “Save”, the Member is returned to Index 00400-10A3, whereupon the Member may check the Custom Section check box. Upon completion of the Member's Sectional choices, the next Bid Control item noted as item 8G again results from the Member selection of a Division and results in additional Indexes 00400-10A, 11A, 12A, and 13A being displayed with the Units of Measure “Enter Information” button selected the Member is re-directed to Index 00400-11A.

Index 00400-11A, FIG. #29 provides the Members an opportunity to input the value of the Unit of Measure for the specific project within the text entry box designated as item 29A for the project. The Member is also prompted in text to enter their Unit of Measure as “Nearest Whole Number”.

Our chosen typical Division is Division #8; consequently the Unit of Measure for this Division is the Square Foot. Note the Member has previously designated their Unit of Measure to the system, and it is displayed immediate above the text entry box provided for Member Unit of Measure data entry. After the Member has entered their Unit of Measure value the next Bid Control item noted as item 8G again results from the Member selection of a Division and results in additional Indexes 00400-10A, 11A, 12A, and 13A being displayed with the Bid Amount “Enter Information” button selected the Member is re-directed to Index 00400-12A.

Index 00400-12A, FIG. #30 provides the Member an opportunity to input the dollar value of their bid transmission for the specific project within the text entry box designated as item 30A for the project. The Member is also prompted in text to enter their Bid Amount as “Nearest Dollar Amount”. Item 30B—“Your Current Base Bid” is a display of the Unit of Measure value divided by the Bid Amount. To view this calculation the Member must select item 30E “Calculate” button. This is necessary because until either a “Save and Continue” or “Save and Return” navigation button has been selected the inputted Bid Amount is only displayed within the Browser. It has not been inputted to the system. Selecting the Calculate button enters the input into the system, allowing the calculations to be executed and displayed below the Calculate button. Items 30C and 30D must be enabled by the Site Manager in order for them to display here. The default setting for these items is to not display values. See Index 00600-1A1, Site Manager for additional information relative to Out of Parameter definition, settings, Member notice, and procedures for handling bids. Also, see Index 00500-1A1 for percentage of difference between current bid and archival averages alert. Index 00400-12A1, FIG. #72, item 72A provides a notice of an Out of Parameter bid notice; again, see Index 00600-1A1 for additional information relating to this notice and the procedures to correct bid entry data and complete bid transmission.

After the Member has entered their Bid Amount value the next Bid Control item noted as item 8G again results from the Member selection of a Division and results in additional Indexes 00400-10A, 11A, 12A, and 13A being displayed with the Bid Per Specification “Enter Information” button selected the Member is re-directed to Index 00400-13A.

Index 00400-13A, FIG. #31 provides the Member a “Yes” or “No” query specifically designed to determine the status of the Member's bid to the Specifications. Item 31A provides the query “Is this Bid Per Specification” and both a Yes and No radio button for the Member to indicate to the Bid Receptors if they have computed their bid pursuant to the Originator's specification. If the Member chooses the Yes radio button choice their display to the Bid Receptor(s) will indicate they have complied and bid according to the Originator's specifications. If the Member chooses the No radio button choice their display to the Bid Receptor(s) will indicate they have not complied and bid according to the Originator's specifications. It should be noted that in some cases the Originator's specifications may not be the current state of technology for the work category. In this situation the Member would indicate a No choice and further detail the issue within the “Comments and Exclusions” area to be discussed later herein. The next Bid Control item noted as item 8H—Alternate Bid Type—and with its “Enter Information” button selected the Member is re-directed to Index 00400-14A. The system can also identify specific certain bid elements that are Out of Specification and alert both the Member and the Bid Receptor automatically.

Index 00400-14A, FIG. #32 begins the Members data entry for the first Alternate for this project—Alternate: G1—Mar. 20, 2003. Item 32A provides the Alternate's Name and description, if any, to the Members. Item 32B indicates the Alternate's date of record to the Members. Item 32C—“Acknowledge Alternate—Bid” provides Members a radio button choice to indicate acknowledgement of the Alternate, and either their intent to bid or designate the effects of the Alternate on their work categories to the Bid Receptor(s). This specific acknowledgement choice (item 32C) indicates the Members' acknowledgement of the Alternate, and the effect the Acknowledgement type will have on the Members—to provide a bid transmission upon completion of the system process to the Bid Receptor(s) for this specific Alternate.

By definition, Alternate's are requests by the Owner to modify or make changes in either the plans or specs for the project, or both. These modifications and/or changes result in a new bid based upon the modifications and changes the specific Alternate makes to the base bid plan and specs. Upon the completion of the estimate for both Base Bid “Plan & Spec” and the resultant new “Plan & Spec” created by the Alternate's modifications and/or changes, a comparison is made between the two bids. The difference between the Base bid and Alternate bid is noted. The dollar difference of the comparison may be an addition to the Base bid, a deduction to the Base bid, or No change to the Base bid. It is this comparison of Base bid to Alternate bid that informs the Owner if they will spend more for an Alternate method of construction, less for an Alternate method of construction, or have no change in cost for an Alternate method of construction. Consequently, dollar presentation to the Owner or Owner's Representative by the various Bid Receptor(s) is accomplished using the dollar value add, dollar value deduct, or no change dollar value cost parameters to submit their bids. Given these parameters, we shall again chose the common navigation “Save and Return” in order to review the effects of Member data entry. The Bid Control item noted as item 8H—Alternate Bid Type displays additional indexes after the Member has inputted their acknowledgement type and utilized the “Save and Return” button parameter as previously noted. The additional displayed Indexes are 00400-15A, 16A, 17A-17A4, 18A, 19A, and 20A. Archival Unit of Measure (Alternate Archival Info screen) and with its “Enter Information” button selected the Member is re-directed to Index 00400-15A.

Index 00400-15A, FIG. #33 by default re-displays the Members' Unit of Measure choice previously made within Index 00400-6A. See previous Index 00400-6A, FIG. #15 for notes. Members may change their Units of Measure in the event of change, but it must be noted herein this change is most unlikely. Note the Division is not re-displayed for Member choice, as the Division the Member is bidding will not change from Base Bid to Alternate, although the Member may be bidding more than one Division each is transmitted separately. The Bid Control item noted as item 8H—Alternate Bid Type displays additional indexes after the Member has inputted their acknowledgement type and utilized the “Save and Return” button parameter as previously noted. The additional displayed Indexes are 00400-15A, 16A, 17A-17A4, 18A, 19A, and 20A. Architectural Level of Detail (Alternate Archival Info screen) and with its “Enter Information” button selected the Member is re-directed to Index 00400-16A.

Index 00400-16A, FIG. #34 by default re-displays the Members' Architectural Level of Detail choice previously made within Index 00400-7A. See previous Index 00400-7A, FIG. #16 for notes. Members may change their Architectural Level of Detail based upon their review of this Alternate's “Plan & Spec” requirements. Members are to be highly cautioned to review the Alternate bid parameters carefully, as the Unit of Measure and Architectural Level of Detail designations are utilized by the system to determine additional bid checking parameters. The Bid Control item noted as item 8H—Alternate Bid Type displays additional indexes after the Member has inputted their acknowledgement type and utilized the “Save and Return” button parameter as previously noted. The additional displayed Indexes are 00400-15A, 16A, 17A-17A4, 18A, 19A, and 20A. Sections (Alternate Section Selection screen) and with its “Enter Information” button selected the Member is re-directed to Index 00400-17A.

Index 00400-17A, FIG. #35 is the initial index of multiple indexes required to provide screen shots of the entire display screen. Therefore, the following Indexes and figures are included within this discussion: 00400-17A1, FIG. #36: 17A2, FIG. #37; 17A3, FIG. #38; and 17A4, FIG. #39.

Let's begin with item 35A—“Base Bid Sections check box column contains grayed out check boxes including checks in those boxes that were selected within the Base Bid and displayed here for Member information only. No modification is permitted.” This column indicates those sections that are a part of the Members' Base Bid; see item 35G, 37A, 38A, 39A, 39E, and 39I for examples. Item35B—“Add Section check box column contains open check boxes and N/A designators. Checking an “Open” check box selects the line item Section to be included as a part of this specific Alternate Bid. “N/A” designation in this column indicates the line item Section cannot be added to the Alternate Bid because it is carried forward into the Alternate Bid from the Base Bid.” Simply put a Section cannot be added if it is already a part of the Base Bid Sections; see items 35H, 39B, 39F, and 39J for examples. Item 35C—“Deduct Section “N/A” designators in this column indicate the line item Section cannot be deducted from the Alternate bid because they were not a part of the Base Bid. An “Open” check box for a line item Section indicates the line item was a part of the Base Bid and can be deleted as a line item Section from the Alternate Bid.” Simply put a Section cannot be deducted if it was not part of the Base Bid section selection; see item 35J, 39C, 39G, and 39K for an examples. Item 35D—“Cumulative Sections those Sections which are a part of the Alternate Bid either through addition of the line item Section by Member checking the check box of the line item, or carried forward from the Base Bid selection to be a part of the Alternate Bid.” Simply put, this column indicates the Sections that are selected by the Member as the work categories their bid for the Alternate will include input data for bid transmission; see item 35K, 37B, 39D, 39H, and 39L for examples. Also note Section 08991 is a custom section entry that has its check box checked in both Add Section and Cumulative Section columns. These checked boxes indicate this section is the only additional section added by this Alternate. This section may have been the bases for the Alternate: G1: Glass Change which is indicated by item 35E and the Date of the Alternate: Mar. 20, 2003 indicated by item 35F. The Bid Control item noted as item 8H—Alternate Bid Type displays additional indexes after the Member has inputted their acknowledgement type and utilized the “Save and Return” button parameter as previously noted. The additional displayed Indexes are 00400-15A, 16A, 17A-17A4, 18A, 19A, and 20A. Units of Measure (Alternate Bid Entry screen) and with its “Enter Information” button selected the Member is re-directed to Index 00400-18A.

Index 00400-18A, FIG. #40 provides for the Members' entry of the Alternate's Unit of Measure similar to Index 00400-11A. This index provides for the Member designation to the system and Bid Receptor(s) the effects of this specific Alternate bid. Item 40A indicates the Alternate's Name and description, if any, to the Members. Item 40B indicates the Alternate's date of record to the Members. Item 40C provides the Members a text input box for inputting the change, if any, in the quantity of the Member's determination of the Units of Measure required for the Alternate Bid as compared to the Base Bid (Note the cell indicates the Member's designated Units of Measure choice, and the quantity the Member inputted within the Base Bid Unit of Measure designation). The Member is further provided with three radio button choices within the cell to specifically indicate to the system the following: Item 40D—an addition to the Base Bid Units of Measure; Item 40E—a deduction to the Base Bid Units of Measure; and Item 40F—no change to the Base Bid Units of Measure. The Bid Control item noted as item 8H—Alternate Bid Type displays additional indexes after the Member has inputted their acknowledgement type and utilized the “Save and Return” button parameter as previously noted. The additional displayed Indexes are 00400-15A, 16A, 17A-17A4, 18A, 19A, and 20A. Bid Amount (Alternate Bid Entry screen) and with its “Enter Information” button selected the Member is re-directed to Index 00400-19A.

Index 00400-19A, FIG. #41, provides for the Member's entry of the Alternate's Bid Amount similar to Index 00400-12A. This index provides for the Member designation to the system and Bid Receptor(s) the effects of this specific Alternate bid. Item 41A provides the Members a text input box for inputting the change, if any, in the dollar value of the Member's determination of the Bid Amount required for the Alternate Bid as compared to the Base Bid (Note the cell indicates the Member's Base Bid Amount). The Member is further provided with three radio button within the cell as choices to specifically indicate to the system the following: Item 41B—an addition to the Base Bid—Bid Amount dollar value; Item 41C—a deduction to the Base Bid—Bid Amount dollar value; and Item 41D—no change to the Base Bid—Bid Amount dollar value Units. Items 41E-41I remain as noted in Index 00400-12A. The Bid Control item noted as item 8H—Alternate Bid Type displays additional indexes after the Member has inputted their acknowledgement type and utilized the “Save and Return” button parameter as previously noted. The additional displayed Indexes are 00400-15A, 16A, 17A-17A4, 18A, 19A, and 20A. Bid Per Specification (Alternate Bid Per Specification screen) and with its “Enter Information” button selected the Member is re-directed to Index 00400-20A.

Index 00400-20A, FIG. #42, item 42C provides the Members the same Bid Per Specification options noted in Index 00400-13A. It adds Item 42A that indicates the Alternate's Name and description, if any, to the Members, and Item 42B that indicates the Alternate's date of record to the Members.

The Member's data entry within Index 00400-2A concluded the Index 00400-8A-H data input operations, but did not concluded the Bid Control screen operations. The next Bid Control item continues within Index 00400-2A1, FIG. #9 for which the beginning text of Index 00400-2A herein addresses its continuation as Index 00400-2A1. This occurs because two screen shots were necessary to display the Bid Control screen herein. Therefore, item 9A is equivalent to item 8A, item 9B is equivalent to 8B, and 9C is equivalent to 8C. Consequently, the next Bid Control item noted as item 9C Typical “Enter Information” button begins the Member's data input for item 9A—Alternate Bid Type, and with the Member's selection of item 9C's “Enter Information” button re-directs to Index 00400-21A and continues the data input operations of the Bid Control screen.

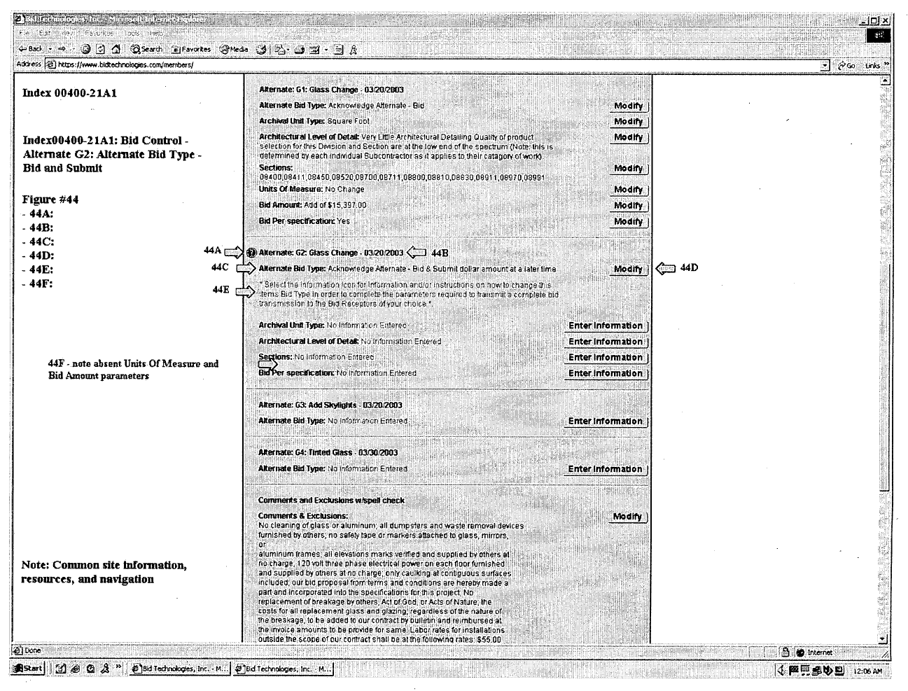

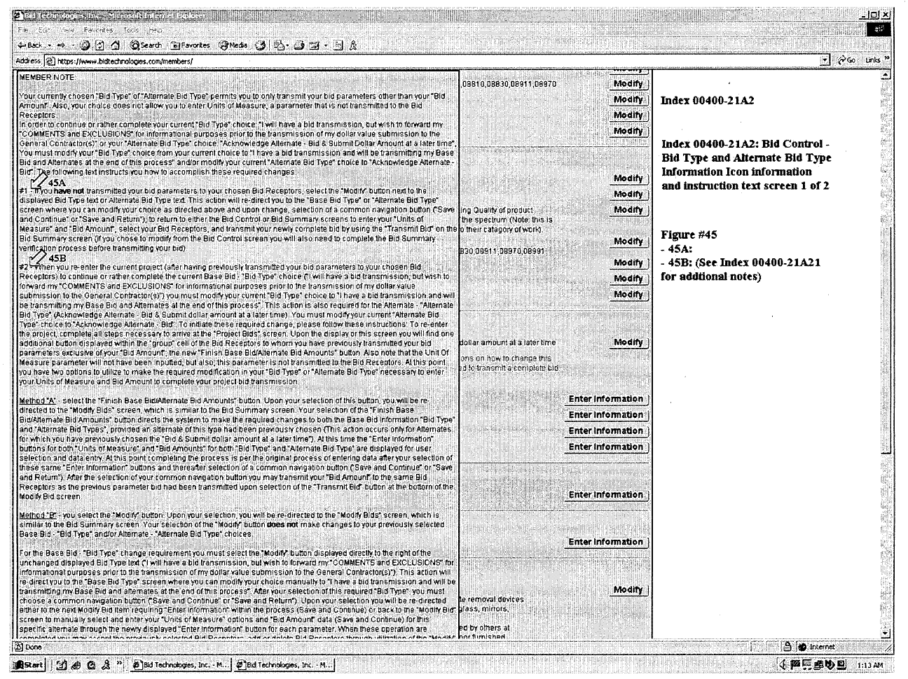

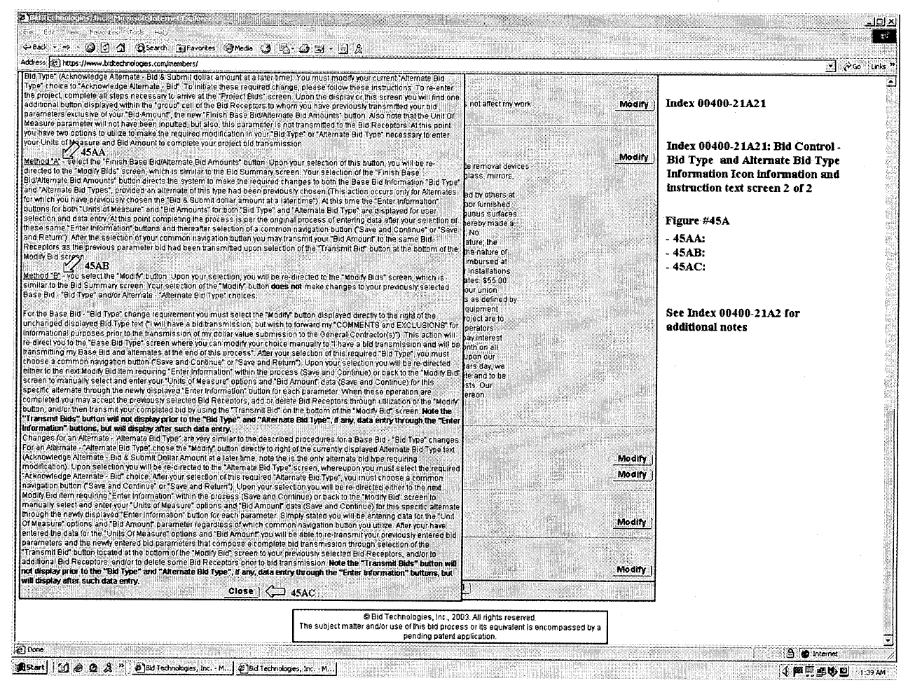

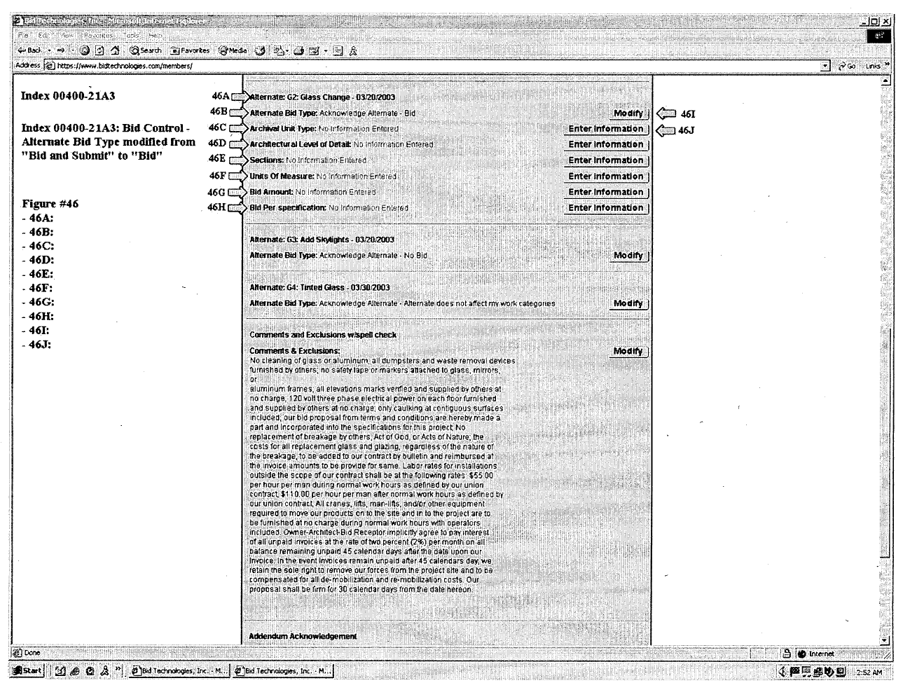

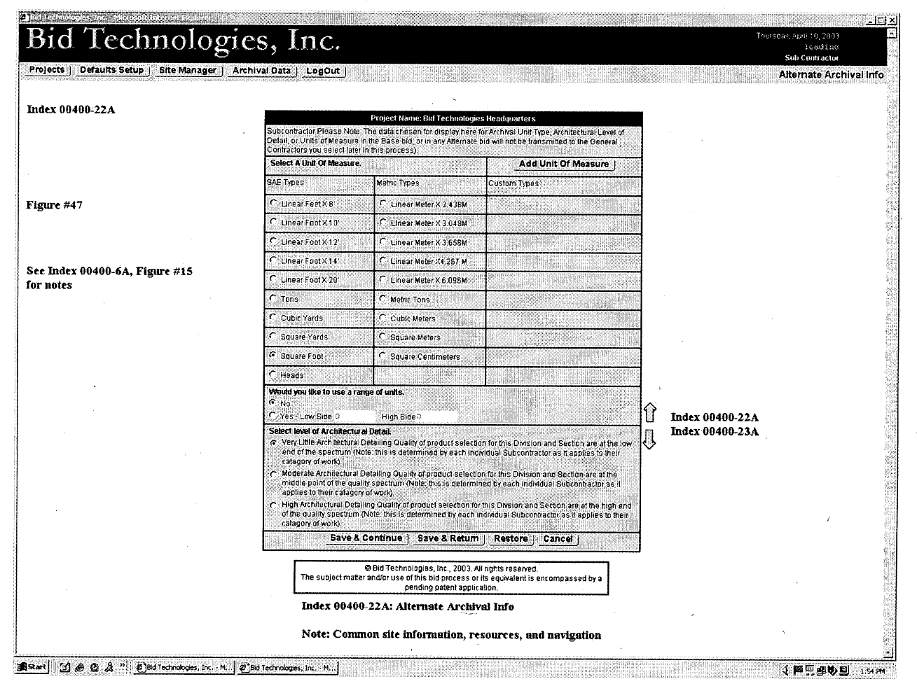

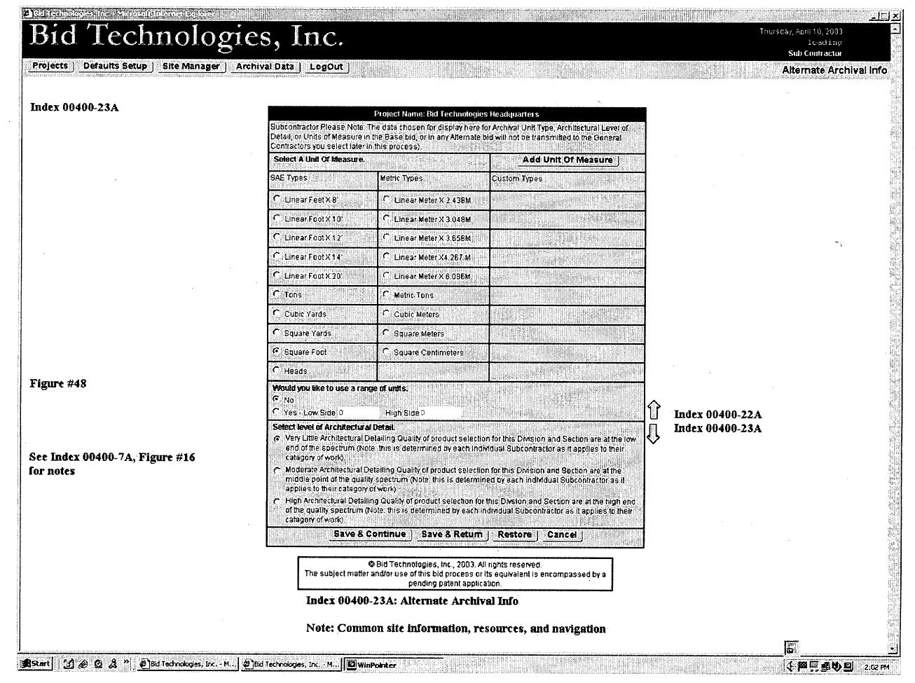

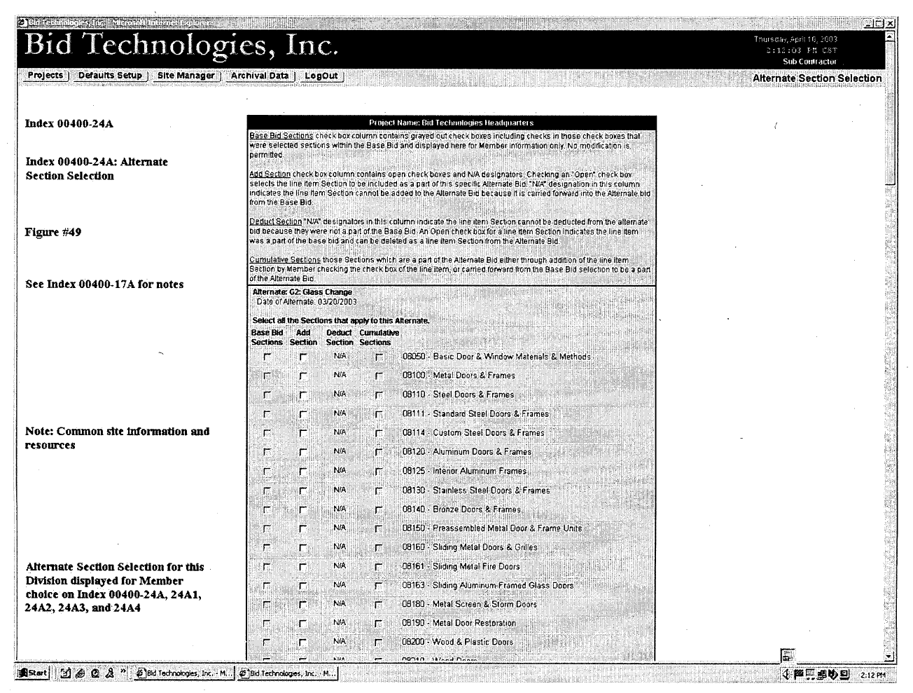

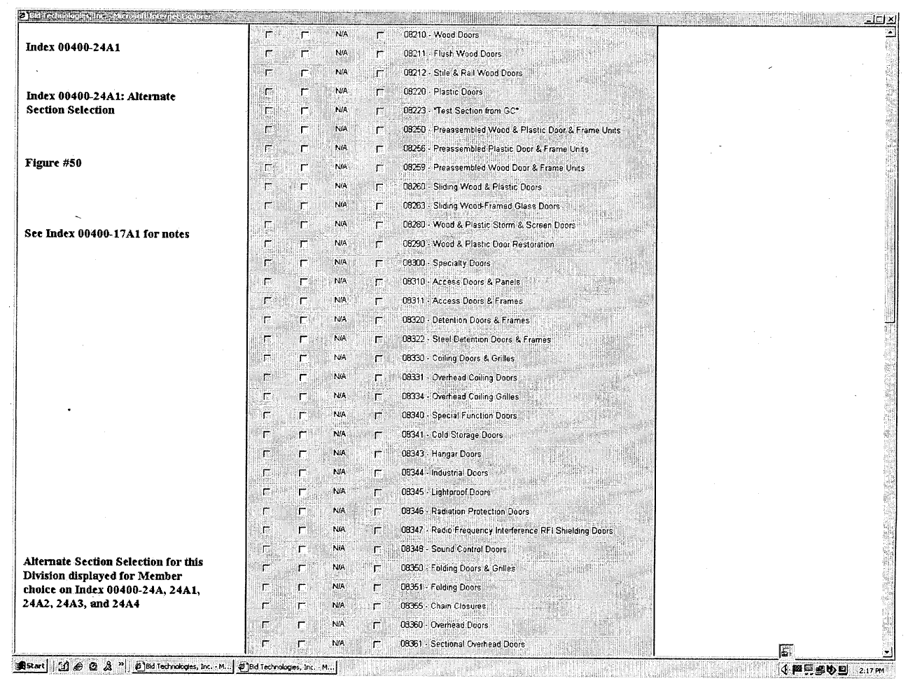

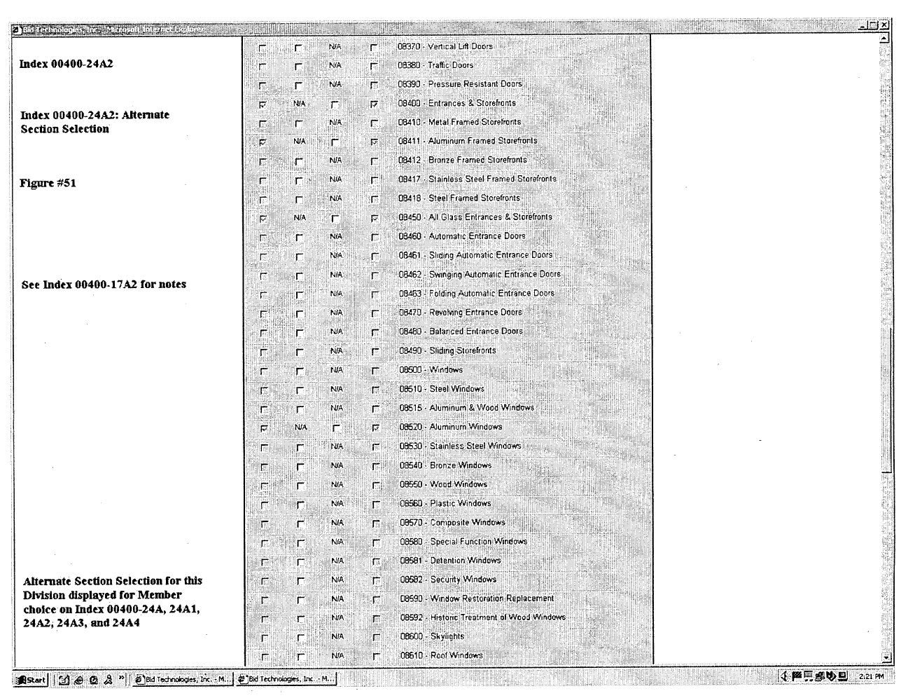

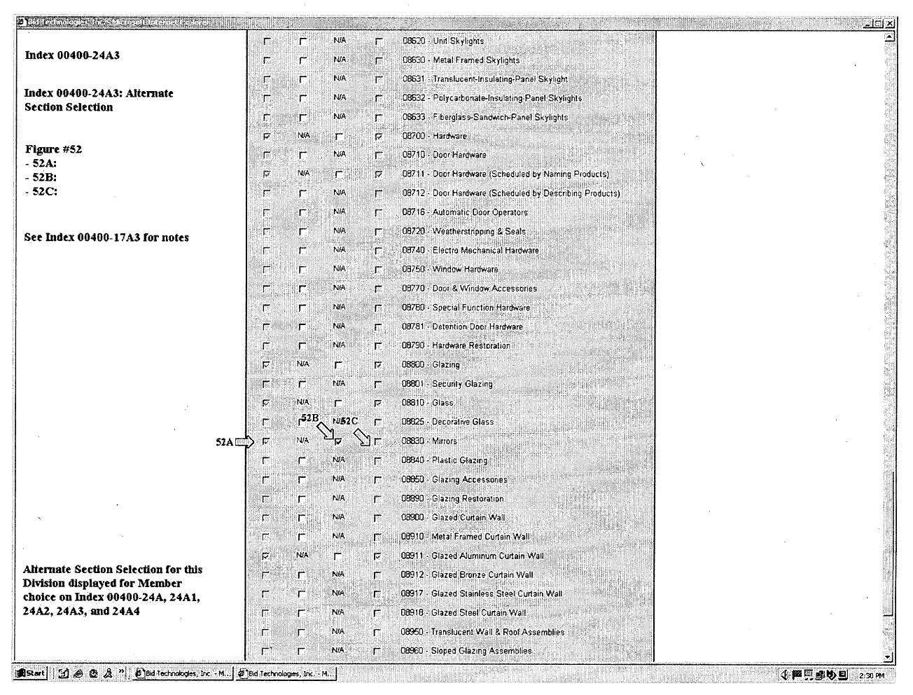

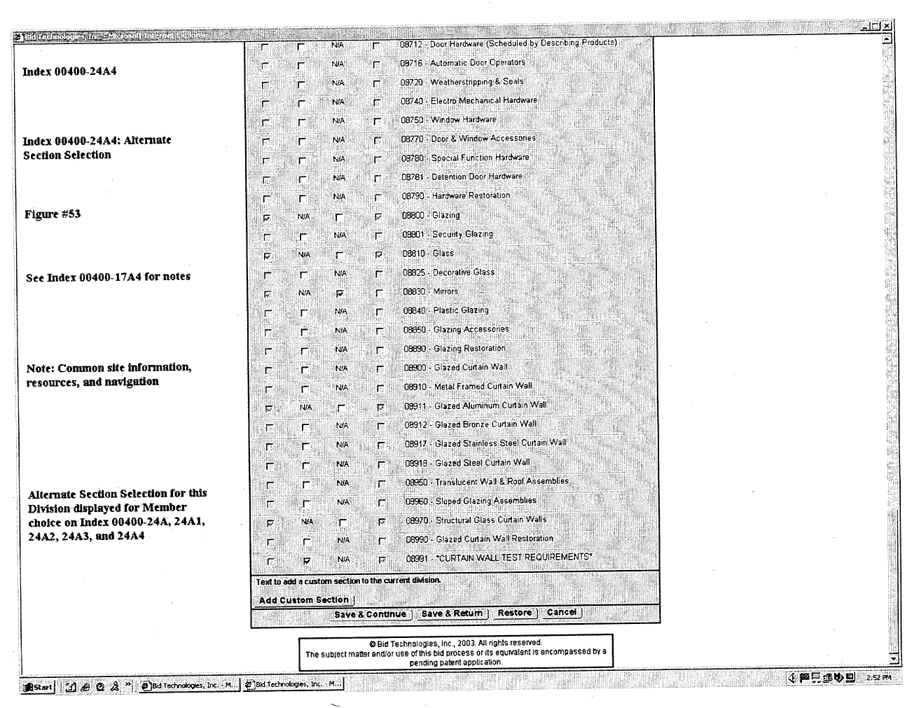

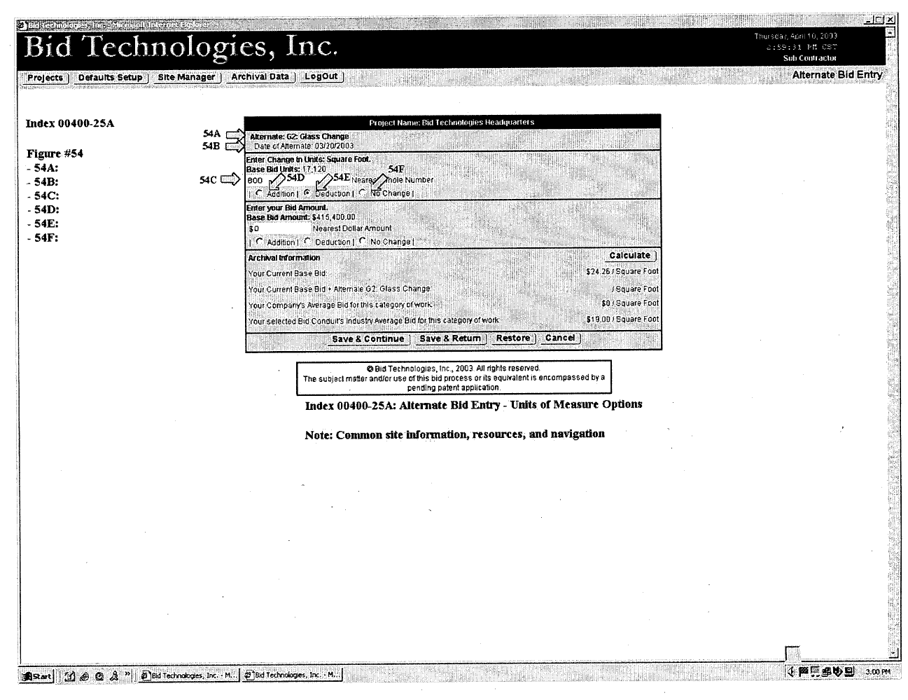

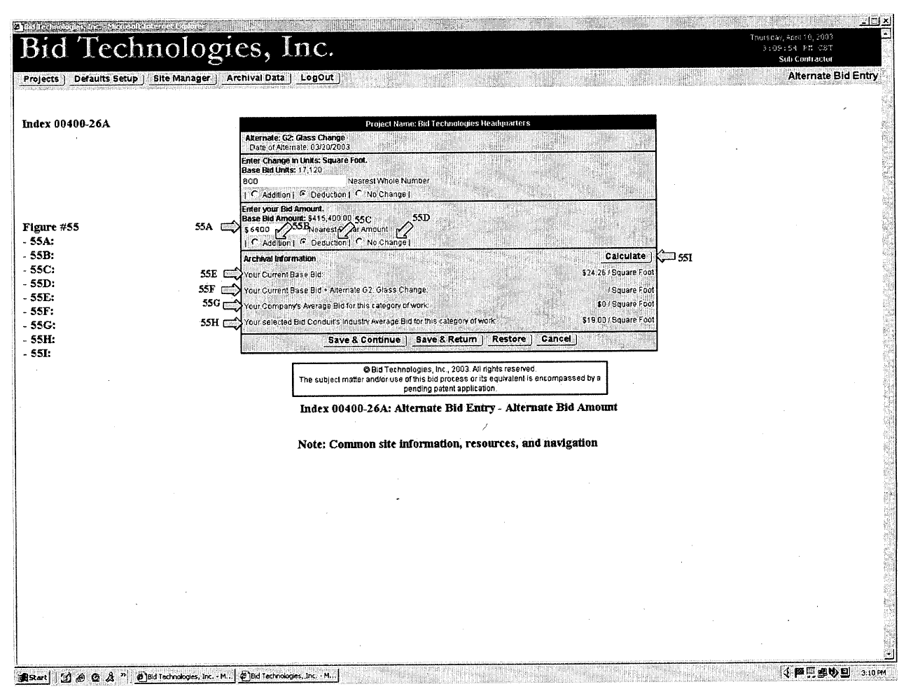

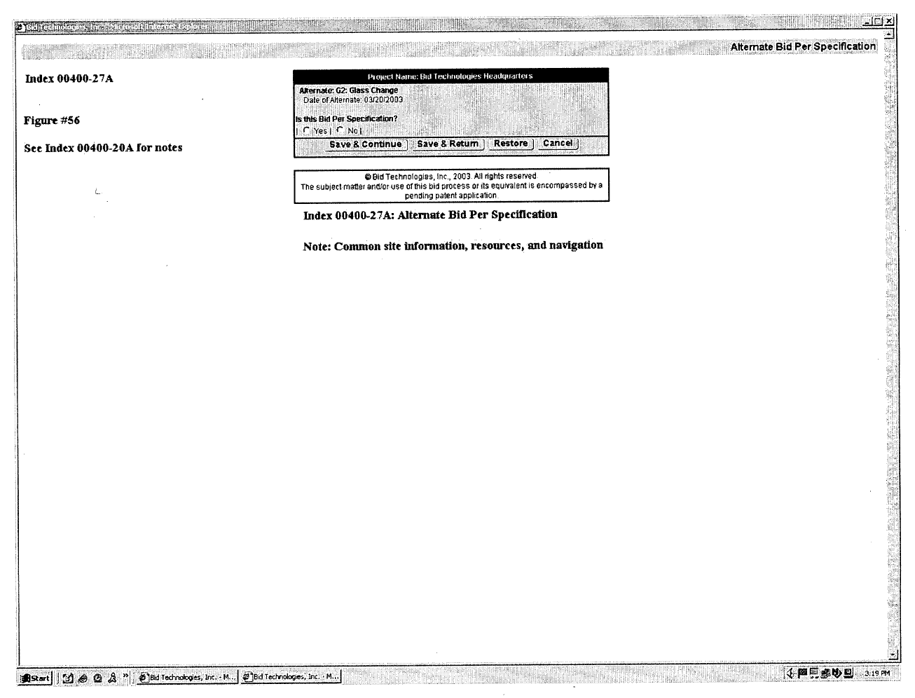

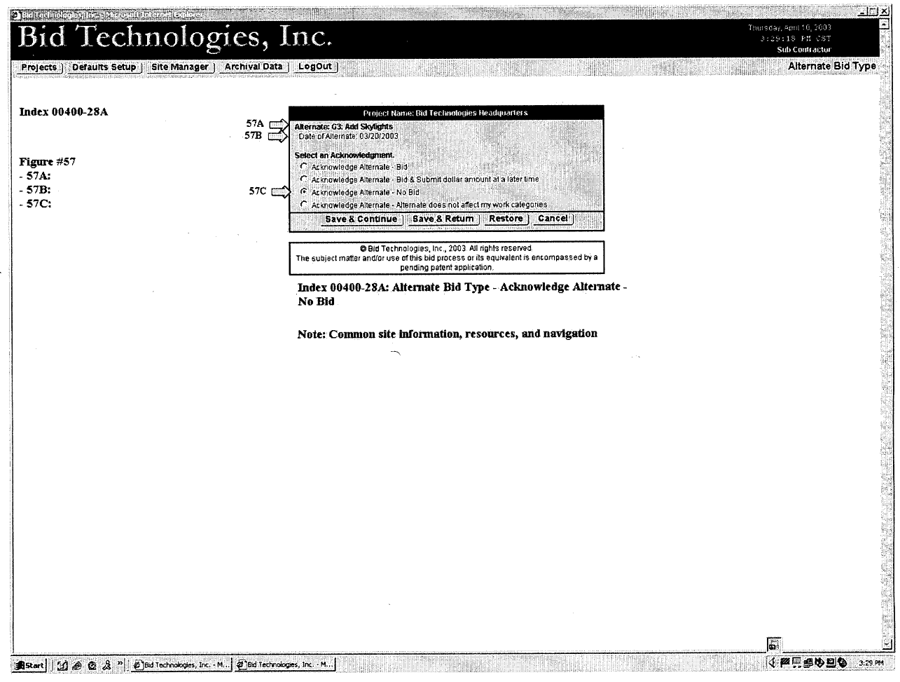

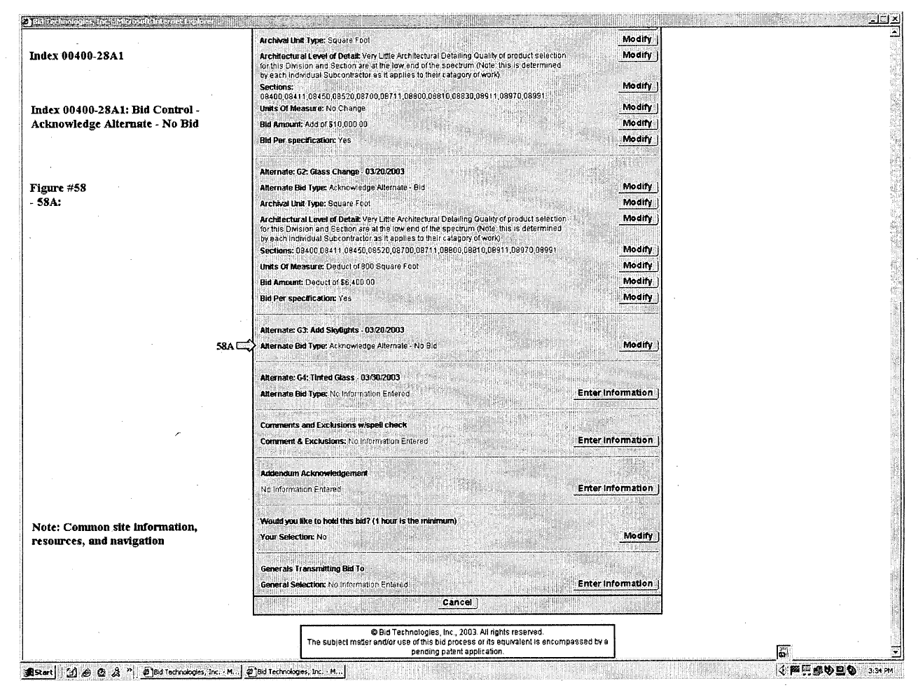

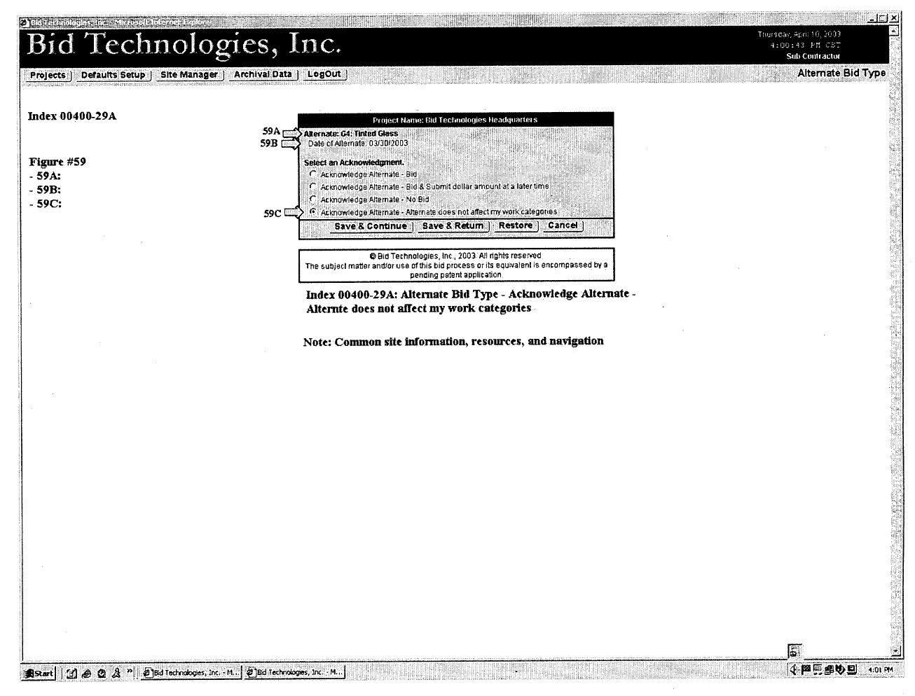

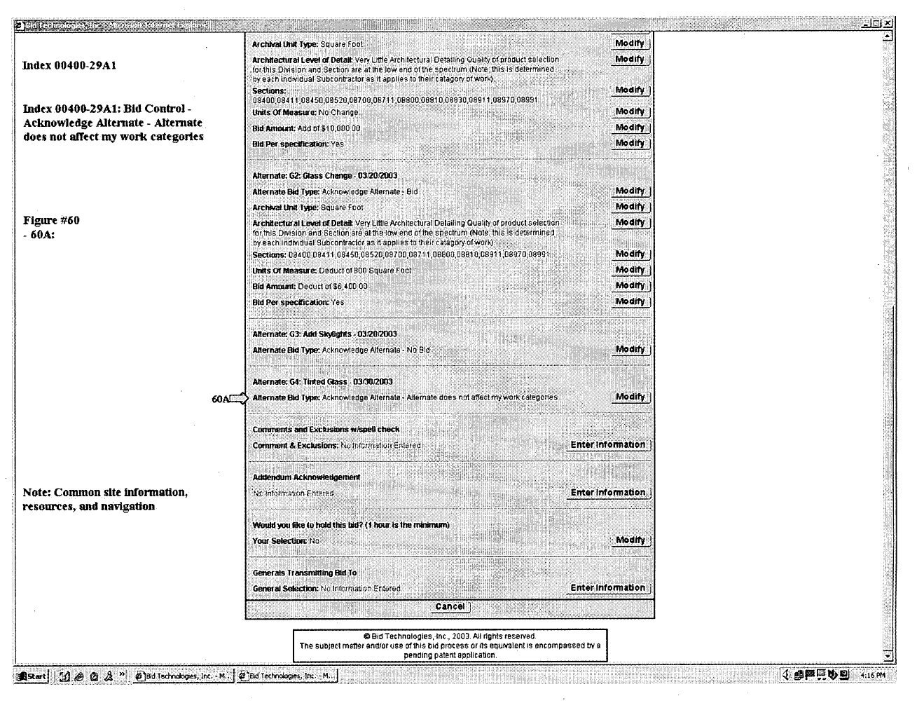

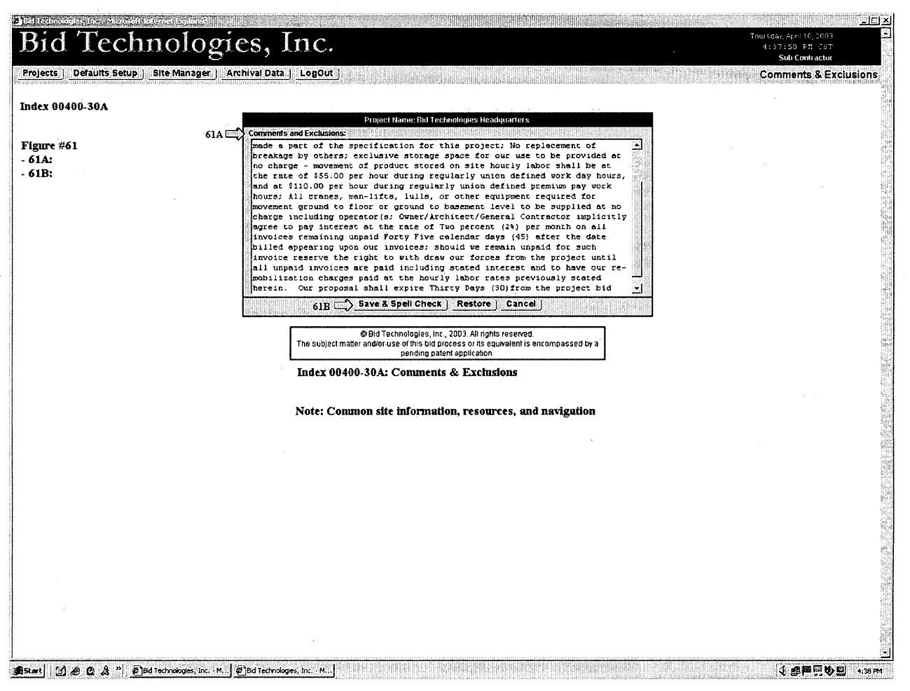

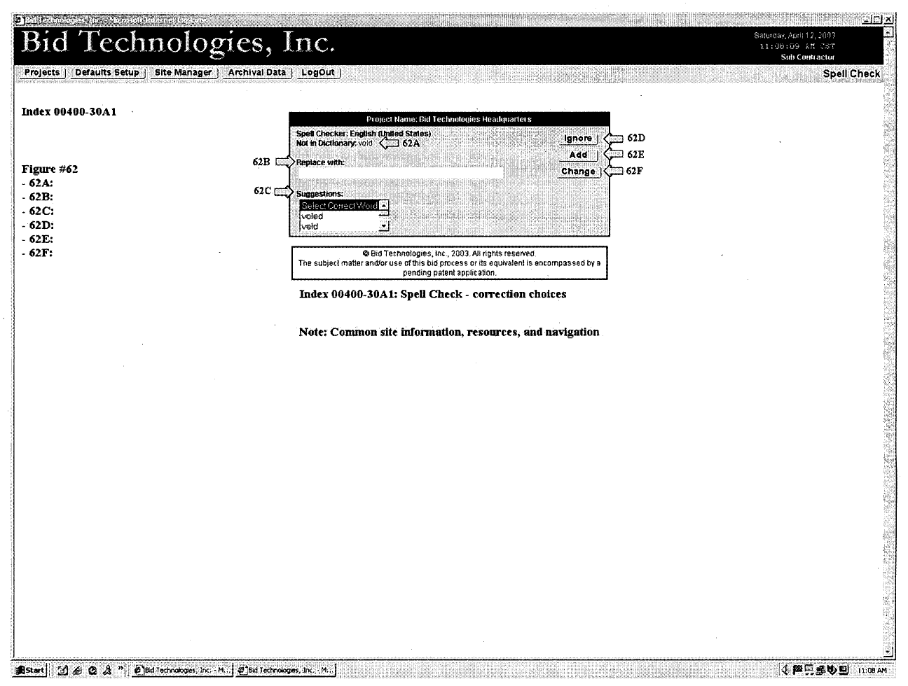

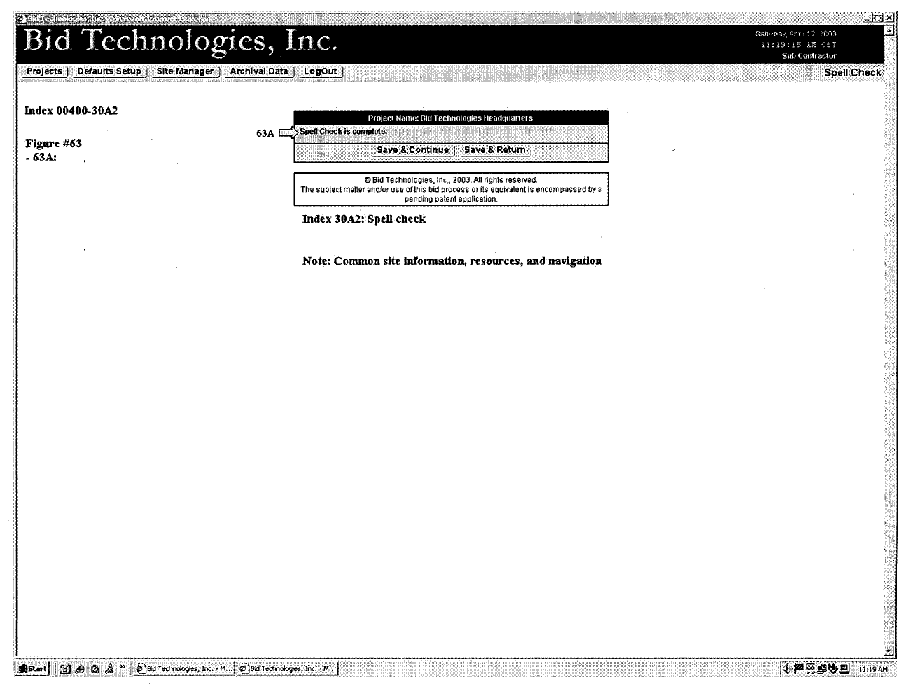

Index 00400-21A, FIG. 43 begins the Members' data entry for the second Alternate for this project—Alternate: G2—Mar. 20, 2003. Item 43A displays the Alternate's Name and description, if any, to the Members. Item 43B displays the Alternate's date of record to the Members. Item 43C—“Acknowledge Alternate—Bid & Submit dollar amount at a later time” provides Members a radio button choice to indicate acknowledgement of the Alternate, and either their intent to bid or designate the effects of the Alternate on their work categories to the Bid Receptor(s). As displayed within this Index item 43C's radio button is not selected. This specific acknowledgement choice (item 43C) indicates the Members' acknowledgement of the Alternate, and the effect of this Acknowledgement choice will provide to the Bid Receptors—to provide specific information about the Members' bid prior to the “Bid Amount” being transmitted to the Bid Receptor(s). These parameter choices allow the Members to transmit their clarifications, terms, and other condition relating to their bid to the various Bid Receptors. Also, with this choice, the system does not provide for the Members' input of the Units Of Measure parameter with this Alternate Bid Type choice. Upon the Members selection of a common site navigation button the Members indicate to the process their Acknowledgement and Bid effect thereof, whereupon the system displays additional Indexes within the Bid Control screen Index 00400-21A1. The additional displayed Indexes are 00400-22A—Archival Unit Type, 23A—Architectural Level of Detail, 24A-24A4—Alternate Section Selection, and 27A—Bid Per Specification discussed later herein. These additional indexes allow the Member to input the parameters of their choice for transmission to the Bid Receptors, but exclude the Units Of Measure (not transmitted in any case) and the Alternate Bid Type—Bid Amount from transmission at this time to the Bid Receptors.

Index 00400-21A1, FIG. #44 displays the results of the specific Acknowledge Alternate choice made in Index 00400-21A, item 43C. Item 44A “Information Icon” (see FAQ Index 50000 for additional information regarding this item), which upon the Members selection displays information and instructions relative to the modification of either the “Bid Type” parameter of the Base Bid or the “Alternate Bid Type” parameters of a specific Alternate. These modified parameters are required to transmit a bid with all the necessary parameters for a complete bid transmission for either the Base Bid “Comments and Exclusions” Bid Type and/or Alternate “Bid and Submit” Alternate Bid Type. As a matter of course, the body of text displayed when a Member selects item 44A is within one vertically scrollable screen; herein it must be broken into two indexes. Therefore, Indexes 00400-21A2 and 00400-21A21. Index 00400-21A2, FIG. #45, item 45A—#1 displays the specific instructions required for the Members to utilize item 44D's “Modify” button to successfully revise the Base Bid—Bid Type or Alternate—Alternate Bid Type parameters.

Prior to the instructions the Index displays informational text for the Members' overview of the subject matter as follows: Your currently chosen “Bid Type” of “Alternate Bid Type” permits you to only transmit your bid parameters other than your “Bid Amount”. Also, your choice does not allow you to enter Units of Measure, a parameter that is not transmitted to the Bid Receptors. In order to continue or rather complete your current “Bid Type” choice: “I will have a bid transmission, but wish to forward my “COMMENTS and EXCLUSIONS” for informational purposes prior to the transmission of my dollar value submission to the General Contractor(s)” or your “Alternate Bid Type” choice: “Acknowledge Alternate—Bid & Submit Dollar Amount at a later time”, You must modify your “Bid Type” choice from your current choice to “I have a bid transmission and will be transmitting my Base Bid and Alternates at the end of this process” and/or modify your current “Alternate Bid Type” choice to “Acknowledge Alternate—Bid”. The following text instructs you how to accomplish these required changes. Following the informational overview the Index display instruction #1: If you have not transmitted your bid parameters to your chosen Bid Receptors, select the “Modify” button next to the displayed Bid Type text or Alternate Bid Type text. This action will re-direct you to the “Base Bid Type” or “Alternate Bid Type” screen where you can modify your choice as directed above and upon change, selection of a common navigation button (“Save and Continue” or “Save and Return”), to return to either the Bid Control or Bid Summary screens to enter your “Units of Measure” and “Bid Amount”, select your Bid Receptors, and transmit your newly complete bid by using the “Transmit Bid” on the Bid Summary screen (if you chose to modify from the Bid Control screen you will also need to complete the Bid Summary verification process before transmitting your bid). Thereafter, Item 45B displays a portion of instruction #2, which initiates when a member is required to re-enter the system for reasons previously noted herein. Instruction #2 is continued within Index 00400-21A21, FIG. #45A. Item 45AA displays the text for method “A”. Item 45AB displays the text for method “B”. The displayed text found within both Indexes concerning instruction#2 follows: #2—When you re-enter the current project (after having previously transmitted your bid parameters to your chosen Bid Receptors) to continue or rather complete the current Base Bid—“Bid Type” choice (“I will have a bid transmission, but wish to forward my “COMMENTS and EXCLUSIONS” for informational purposes prior to the transmission of my dollar value submission to the General Contractor(s)”) you must modify your current “Bid Type” choice to “I have a bid transmission and will be transmitting my Base Bid and Alternates at the end of this process”. This action is also required for the Alternate—“Alternate Bid Type” (Acknowledge Alternate—Bid & Submit dollar amount at a later time). You must modify your current “Alternate Bid Type” choice to “Acknowledge Alternate—Bid”. To initiate these required changes, please follow these instructions: To re-enter the project, complete all steps necessary to arrive at the “Project Bids” screen. Upon the display or this screen you will find one additional button displayed within the “group” cell of the Bid Receptors to whom you have previously transmitted your bid parameters exclusive of your “Bid Amount”; the new “Finish Base Bid/Alternate Bid Amounts” button. Also note that the Unit Of Measure parameter will not have been inputted, but also, this parameter is not transmitted to the Bid Receptors. At this point you have two options to utilize to make the required modification in your “Bid Type” or “Alternate Bid Type” necessary to enter your Units of Measure and Bid Amount to complete your project bid transmission.

Method “A”—select the “Finish Base Bid/Alternate Bid Amounts” button. Upon your selection of this button, you will be re-directed to the “Modify Bids” screen, which is similar to the Bid Summary screen. Your selection of the “Finish Base Bid/Alternate Bid Amounts” button directs the system to make the required changes to both the Base Bid Information “Bid Type” and “Alternate Bid Types”, provided an alternate of this type had been previously chosen (This action occurs only for Alternates for which you have previously chosen the “Bid & Submit dollar amount at a later time”). At this time the “Enter Information” buttons for both “Units of Measure” and “Bid Amounts” for both “Bid Type” and “Alternate Bid Type” are displayed for user selection and data entry. At this point completing the process is per the original process of entering data after your selection of these same “Enter Information” buttons and thereafter selection of a common navigation button (“Save and Continue” or “Save and Return”). After the selection of your common navigation button you may transmit your “Bid Amount” to the same Bid Receptors as the previous parameter bid had been transmitted upon selection of the “Transmit Bid” button at the bottom of the Modify Bid screen.

Method “B”—you select the “Modify” button. Upon your selection, you will be re-directed to the “Modify Bids” screen, which is similar to the Bid Summary screen. Your selection of the “Modify” button does not make changes to your previously selected Base Bid—“Bid Type” and/or Alternate—“Alternate Bid Type” choices. For the Base Bid—“Bid Type” change requirement you must select the “Modify” button displayed directly to the right of the unchanged displayed Bid Type text (“I will have a bid transmission, but wish to forward my “COMMENTS and EXCLUSIONS” for informational purposes prior to the transmission of my dollar value submission to the General Contractor(s)”). This action will re-direct you to the “Base Bid Type” screen where you can modify your choice manually to “I have a bid transmission and will be transmitting my Base Bid and alternates at the end of this process”. After your selection of this required “Bid Type”, you must choose a common navigation button (“Save and Continue” or “Save and Return”). Upon your selection you will be re-directed either to the next Modify Bid item requiring “Enter Information” within the process (Save and Continue) or back to the “Modify Bid” screen to manually select and enter your “Units of Measure” options and “Bid Amount” data (Save and Continue) for this specific alternate through the newly displayed “Enter Information” button for each parameter. When these operation are completed you may accept the previously selected Bid Receptors, add or delete Bid Receptors through utilization of the “Modify” button, and/or then transmit your completed bid by using the “Transmit Bid” on the bottom of the “Modify Bid” screen. Note the “Transmit Bids” button will not display prior to the “Bid Type” and “Alternate Bid Type”, if any, data entry through the “Enter Information” buttons, but will display after such data entry. Changes for an Alternate—The ‘Alternate Bid Type” is very similar to the described procedures for a Base Bid—“Bid Type” changes. For an Alternate—“Alternate Bid Type” chose the “Modify” button directly to right of the currently displayed Alternate Bid Type text (Acknowledge Alternate—Bid & Submit Dollar Amount at a later time; note the is the only alternate bid type requiring modification). Upon selection you will be re-directed to the “Alternate Bid Type” screen, whereupon you must select the required “Acknowledge Alternate—Bid” choice. After your selection of this required “Alternate Bid Type”, you must choose a common navigation button (“Save and Continue” or “Save and Return”). Upon your selection you will be re-directed either to the next Modify Bid item requiring “Enter Information” within the process (Save and Continue) or back to the “Modify Bid” screen to manually select and enter your “Units of Measure” options and “Bid Amount” data (Save and Continue) for this specific alternate through the newly displayed “Enter Information” button for each parameter. Simply stated, you will be entering data for the “Unit Of Measure” options and “Bid Amount” parameter regardless of which common navigation button you utilize. After your have entered the data for the “Units Of Measure” options and “Bid Amount” you will be able to re-transmit your previously entered bid parameters and the newly entered bid parameters that compose a complete bid transmission through selection of the “Transmit Bid” button located at the bottom of the “Modify Bid” screen to your previously selected Bid Receptors, and/or to additional Bid Receptors, and/or to delete some Bid Receptors prior to bid transmission. Note the “Transmit Bids” button will not display prior to the “Bid Type” and “Alternate Bid Type”, if any, data entry through the “Enter Information” buttons, but will display after such data entry. The Information Icon display is closed utilizing the “Close” button at its conclusion. Item 44B indicates the Alternate's Name and description, if any, to the Members, and it indicates the Alternate's date of record to the Members. Item 44C displays the Member's Alternate Bid Type choice “Acknowledge Alternate—Bid & Submit Dollar Amount At A Later Time.” Item 44D “Modify” button provides the Members with one of the methods to change the displayed Alternate Bid Type of the specific Alternate to the required Alternate Bid Type, or for that matter the “Bid Type” of the Base Bid to the required Bid Type, necessary to complete the parameter data input and either subsequently transmit this bid or in the event of a previously transmitted bid the opportunity to re-transmit the bid with all necessary parameters for a complete bid transmission (see item 44A “Information Icon”). Item 44E provides notice to the Members, when displayed on the “Bid Control” screen, as to methodology they must follow in order to transmit their “Units Of Measure” and “Bid Amounts” parameters due to their previously selected Alternate Bid Type. Members may select the Information Icon for information and/or instructions on how to change this item's Bid Type in order to complete the parameters required to transmit a complete bid transmission to the Bid Receptors of your choice”. Item 44F simply indicates the location of the uncompleted parameters. Note the item 44E text is displayed in red font color. It should be noted that, although this message is displayed, it pertains specifically to the “Units of Measure” and “Bid Amount” parameters, which are not displayed herein and consequently have no “Enter Information” button associated with them until they are displayed through the required modification (see item 44F for the typical location when they are displayed). Note again, item 44D's “Modify” button. Upon Member selection this “Modify” button re-directs the Member to Index 00400-21A, FIG. #43; from which the Member is able to change their Acknowledgement Alternate type to the prescribed “Acknowledge Alternate—Bid” (from item 43C to item 43D). Whereupon the Member must utilize the common navigation buttons “Save and Continue” or “Save and Return” to execute the required change, and in so doing indicate the revision to the system. Note that the name of the alternate is again indicated (item 43A), and the record date of the Alternate is indicated (item 43B). With these changes and continuation completed, the Member is again presented with a Bid Control screen as shown in Index 00400-21A3, FIG. #46, Note the name of the alternate is again indicated (item 46A), and the record date of the Alternate is also indicated. Item 46B displays the Members revised Alternate Bid Type—“Acknowledge Alternate—Bid” as required for completion. Item 46C “Archival Unit Type” becomes input able through Member's selection of the typical item 46J “Enter Information” button or changeable through the typical 46I “Modify” button. Upon the Members' selection they are redirected to Index 00400-22A discussed later herein. Item 46D “Architectural Level of Detail” becomes input able through the Members' choice of the typical item 46J “Enter Information” button or changeable through the typical item 46I “Modify” button. Upon the Members' selection they are redirected to Index 00400-23A discussed later herein. Item 46E “Sections” that becomes input able through the Members' choice of the typical item 46J “Enter Information” button or changeable through the typical item 46I “Modify button”. Upon the Members' selection they are redirected consecutively to Index 00400-24A, 24A1, 24A2, 24A3, and 24A4 discussed later herein. Item 46F “Units Of Measure” and associated options becomes input able through the Members' choice of the typical item 46J “Enter Information” button or changeable through the typical item 46I “Modify” button. Upon the Members' selection they are redirected to Index 00400-25A discussed later herein. Item 46G “Bid Amount” and its associated options becomes input able through Member's selection of the typical item 46J “Enter Information” button or changeable through the typical 46I “Modify” button. Upon the Members' selection they are redirected to Index 00400-26A discussed later herein. Item 46H “Bid Per Specification” choices become input able through Member's selection of the typical item 46J “Enter Information” button or changeable through the typical 46I “Modify” button. Upon the Members' selection they are redirected to Index 00400-27A discussed later herein. Item 46I “Modify” button and Item 46J “Enter Information” button are common navigation buttons. Item 46I redirects the Members to previous Indexes for the purpose of instituting revisions to the Index. Item 46J redirects the Members to an Index for the purpose of inputting data into the Index. Upon completion of these operations the Member utilizes additional common navigation buttons to continue within the process. Please note: Index 00400-25A and 00400-26A are displayed together on the “Alternate Bid Entry” screen, but for purposes of explanation are discussed as separate Indexes herein. The discussion now proceeds to the input Indexes identified within the discussion of Index 00400-21A3. Again, we will assume the common navigation button “Save and Return” is utilized.

This continuation begins with Index 00400-22A, FIG. #47, “Archival Unit of Measure” parameter of the “Bid Control” screen. The Members access this index by their selection of either the “Enter Information” or the “Modify” button displayed. Upon selection of either the “Enter Information” or the “Modify” button for “Archival Unit Type” parameter the Members are redirected to this index. This parameter could have been entered previously, and is not affected by the “Alternate Bid Type” modification the Members have been required to perform. Therefore, the Members' choice of “Enter Information” or “Modify” button will depend on their previous input actions relevant to this parameter. In all probability the Members have already entered this data in some system provided manner previously, and will not be required to re-enter it here, in the event they have previously done so. The Members may make modifications to their previous “Archival Unit Type” selection. This parameter is not a transmittable parameter, but is utilized by the system to determine archival bid averages. Therefore, the notes depicted within Indexes 00400-6A and 00400-15A are also appropriate herein, as well (Note: within the system these index are displayed within the “Base Bid Archival Info” or “Alternate Archival info” screens which also display the Architectural Level of Detail parameter input).

The next index in this continuation is Index 00400-23A, FIG. #48, “Architectural Level of Detail” parameter of the “Bid Control” screen. The Members access this index by their selection of either the “Enter Information” or the “Modify” button displayed. Upon selection of either the “Enter Information” or the “Modify” button for “Architectural Level of Detail” parameter the Members are redirected to this index. This parameter could have been entered previously, and is not affected by the “Alternate Bid Type” modification the Members have been required to perform. Therefore, the Members' choice of “Enter Information” or “Modify” button will depend on their previous input actions relevant to this parameter. In all probability the Members have already entered this data in some system provided manner previously, and will not be required to re-enter it here, in the event they have previously done so. The Members may make modification to their previous “Architectural Level of Detail” selection. This parameter could have been entered previously, and is not affected by the “Alternate Bid Type” modification the Members have been required to perform. In all probability the Members have already entered this data, and will not be required to re-enter it here, in the event they have previously done so. The Members may make modification to their previous “Architectural Level of Detail” selection. This parameter is a not a transmittable parameter, but is utilized by the system to assist in defining archival bid averages. The notes depicted within Indexes 00400-7A and 00400-16A are also appropriate herein, as well (Note: within the system these index are displayed within the “Base Bid Archival Info” or “Alternate Archival info” screens which also display the Archival Unit Type parameter input).

The next index in this continuation is the Index 00400-24A, FIG. #49; 24A1, FIG. #50; 24A2, FIG. #51; 24A3, FIG. #52 and 24A4, FIG. #53, “Section Selection”. The composite of these Indexes is the “Alternate Section Selection” screen. The Members access this indexes by their selection of either the “Enter Information” or the “Modify” button displayed. Upon selection of the “Enter Information” or “Modify” button for “Sections” parameter the Members are redirected to these indexes. This parameter could have been entered previously, and is not affected by the “Alternate Bid Type” modification the Members have been required to perform. Therefore, the Members' choice of “Enter Information” or “Modify” button will depend on their previous input actions relevant to this parameter. In all probability the Members have already entered this data in some system provided manner previously, and will not be required to re-enter it here, in the event they have previously done so. The Members may make modification to their previous “Section” selection. This parameter is a transmittable parameter, and may be transmitted by the Members as a bid parameter prior to the final bid transmission to the Bid Receptors. The notes depicted within Indexes 00400-17A, 17A1, 17A2, 17A3, and 17A4 are appropriate herein, as well (Note: within the system these indexes are displayed within the single “Alternate Section Selection” screen).

The next index in this continuation is the Index 00400-25A, FIG. #54, “Unit of Measure” options of the “Bid Control” screen. The Members access this index by their selection of the “Enter Information” button displayed as one the results of their required modification of “Alternate Bid Type” previously discussed. Previous to the modification required this parameter did not display for the previously selected Bid Type (Base Bid or Alternate) upon the “Bid Control” screen. Upon selection of the ‘Enter Information” button for “Unit Of Measure” parameter the Members are redirected to this index to input this data. This parameter could not have been entered previously, it is not transmittable, and it is affected by the “Alternate Bid Type” modification the Members have been required to perform. In most cases this parameter is not determinable without Members knowledge of the “Bid Amount” parameter. There are cases where the Members may determine this value independent of the “Bid Amount” value. Consequently, we have chosen to require its input when the Members are able to input the “Bid Amount” value rather than leave it an undetermined case. This parameter is not transmittable to the Bid Receptors. Along with the “Bid Amount” this index completes the required parameter entry by the Members, and allows them to transmit a complete bid transmission to the Bid Receptors of either their previous or modified choices. The notes depicted within Index 00400-19A are appropriate herein, as well (Note: within the system this index is displayed within the “Alternate Bid Entry” screen together with the “Bid Amount” option parameter input).

The next index in this continuation is the Index 00400-26A, FIG. #55, “Bid Amount” options of the “Bid Control” screen. The Members access this index by their selection of the “Enter Information” button displayed as one the results of their required modification of “Alternate Bid Type” previously discussed. Previous to the modification required this parameter did not display for the previously selected Bid Type (Base Bid or Alternate) upon the “Bid Control” screen. Upon selection of the ‘Enter Information” button for “Bid Amount” parameter the Members are redirected to this index to input this data. This parameter could not have been entered previously, it is transmittable, and it is affected by the “Alternate Bid Type” modification the Members have been required to perform. This parameter is transmittable to the Bid Receptors. Along with the “Units of Measure” this index completes the required parameter entry by the Members, and allows them to transmit a complete bid transmission to the Bid Receptors of either their previous or modified choices. The notes depicted within Index 00400-19A are appropriate herein, as well (Note: within the system this index is displayed within the “Alternate Bid Entry” screen together with the “Unit of Measure” option parameter input).

The next index in this continuation is the Index 00400-27A, FIG. #56, “Bid Per Specification” of the “Bid Control” screen. The Members access this index by their selection of either the “Enter Information” or the “Modify” button displayed. Upon selection of the “Enter Information” or “Modify” button for “Bid Per Specification” parameter the Members are redirected to these index. This parameter could have been entered previously, and is not affected by the “Alternate Bid Type” modification the Members have been required to perform. Therefore, the Members' choice of “Enter Information” or “Modify” button will depend on their previous input actions relevant to this parameter. In all probability the Members have already entered this data in some system provided manner previously, and will not be required to re-enter it here, in the event they have previously done so. The Members may make modification to their previous “Bid Per Specification” selection. This parameter is a transmittable parameter, and may be transmitted by the Members as a bid parameter prior to the final bid transmission to the Bid Receptors. The notes depicted within Indexes 00400-13A or Index 00400-20A are appropriate herein, as well (Note: within the system these index is displayed within the “Alternate Bid Per Specification” screen). This concludes the discussion of Index 00400-2A1, item 9A and begins the discussion of item 9D upon the Members' selection of the typical item 9C “Enter Information” button which redirects the Member to Index 00400-28A.

Index 00400-28A, FIG. #57, begins our discussion of Index 00400-2A1, FIG. #9, item 9D, which is a third Alternate for this specific project that presents another “Alternate Bid Type” screen item for discussion relative to Members' input. The indicated index displays item 57A that displays the Alternates text description to the Members, and item 57B that displays the record date of the Alternate to the Members. Item 57C “Acknowledge Alternate—No Bid”, this specific acknowledgement choice indicates the Members' acknowledgement of the Alternate, and the effect of this Acknowledgement choice will provide to the Bid Receptors. This Member choice Acknowledges the Member has seen and reviewed the Alternate's plans and specification to the chosen Bid Receptors. Also it indicates to these same Bid Receptors that the Member will not be providing a dollar value bid for this specific project alternate. The reasons for this Member choice are varied and complex. For example, the Alternate might request a bid transmission for a product, installation technique, out of date product specification, conflict between plan and specification that has not been responded to by the Owner/Architect/Bid Receptors sufficiently to allow the Members to provide a bid transmission for same, or for a multitude of other reasons. It effectively designates the Members' intent not to provide a bid transmission for the specific project alternate to the Bid Receptors when executed in the course of transmitting them either a parameter or complete bid to them. Again, parameter bids are bid transmission to Bid Receptor that provide information to the Bid Receptors for their consideration, but are not complete bids in that they lack vital parameter that need to be transmitted within the complete bid (See Indexes 00400-2A2 and/or 00400-21A for additional information relative to this Member choice). Members who have chosen this “Alternate Bid Type” parameter often provide additional detail relating to this choice within the item 9F “Bid Control” screen “Comments and Exclusions” parameter that is yet to be discussed (see Index 00400-30A). Upon the Members' selection of a common navigation button the Member is redirected to Index 00400-28A1, FIG. #58 that displays the Members choice within the Bid Control screen as item 58A. This concludes the discussion of Index 00400-2A1, item 9D and begins the discussion of item 9E upon the Members' selection of the typical item 9C “Enter Information” button which redirects the Member to Index 00400-29A.

Index 00400-29A, FIG. #59, begins our discussion of Index 00400-2A1, FIG. #9, item 9E, which is a fourth Alternate for this specific project that presents another “Alternate Bid Type” screen item for discussion relative to Members' input. The indicated index displays item 59A that displays the Alternates text description to the Members, and item 59B that displays the record date of the Alternate to the Members. Item 59C “Acknowledge Alternate—Alternate does not affect my work categories”, this specific acknowledgement choice indicates the Members' acknowledgement of the Alternate, and the effect of this Acknowledgement choice will provide to the Bid Receptors. This Member choice acknowledges that the Member has seen and reviewed the Alternate's plans and specification to the chosen Bid Receptors. Also it indicates to these same Bid Receptors that the Member will not be providing a dollar value bid for this specific project alternate, because the Alternate does not affect any of the Members bid parameter. This fact results in the acknowledgement the alternate does not affect the Members' work categories. It effectively designates the Members' intent not to provide a bid transmission for the specific project alternate to the Bid Receptors when executed in the course of transmitting them either a parameter or complete bid to them. Again, parameter bids are bid transmission to Bid Receptor that provide information to the Bid Receptors for their consideration, but are not complete bids in that they lack vital parameter that need to be transmitted within the complete bid (See Indexes 00400-2A2 and/or 00400-21A for additional information relative to this Members' choice). Upon the Members' selection of a common navigation button the Member is redirected to Index 00400-29A1, FIG. #60 that displays the Members choice within the Bid Control screen as item 60A. This concludes the discussion of Index 00400-2A1, item 9E and begins the discussion of item 9F upon the Members' selection of the typical item 9C “Enter Information” button which redirects the Member to Index 00400-30A.

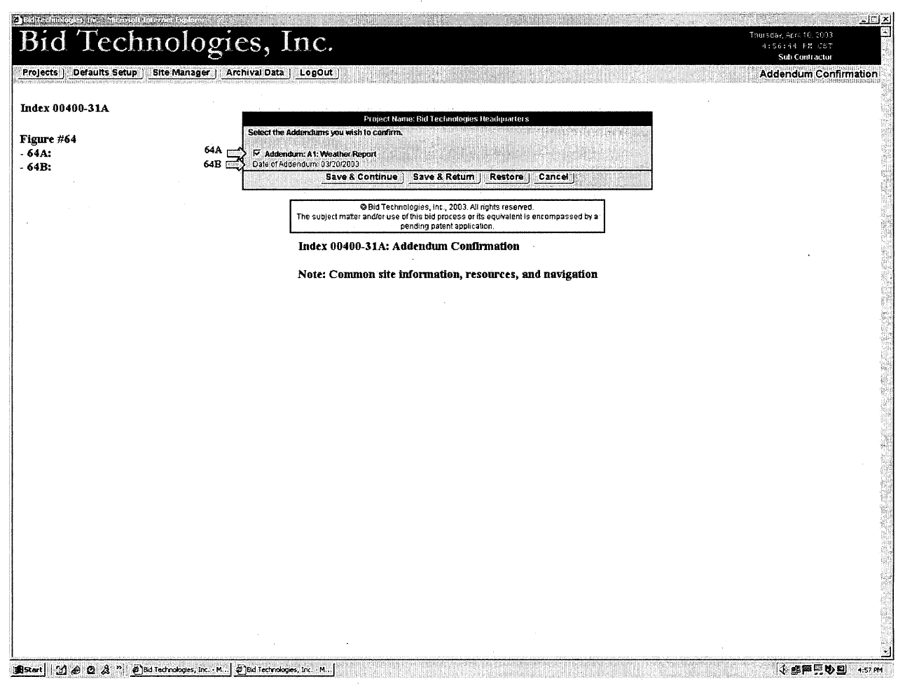

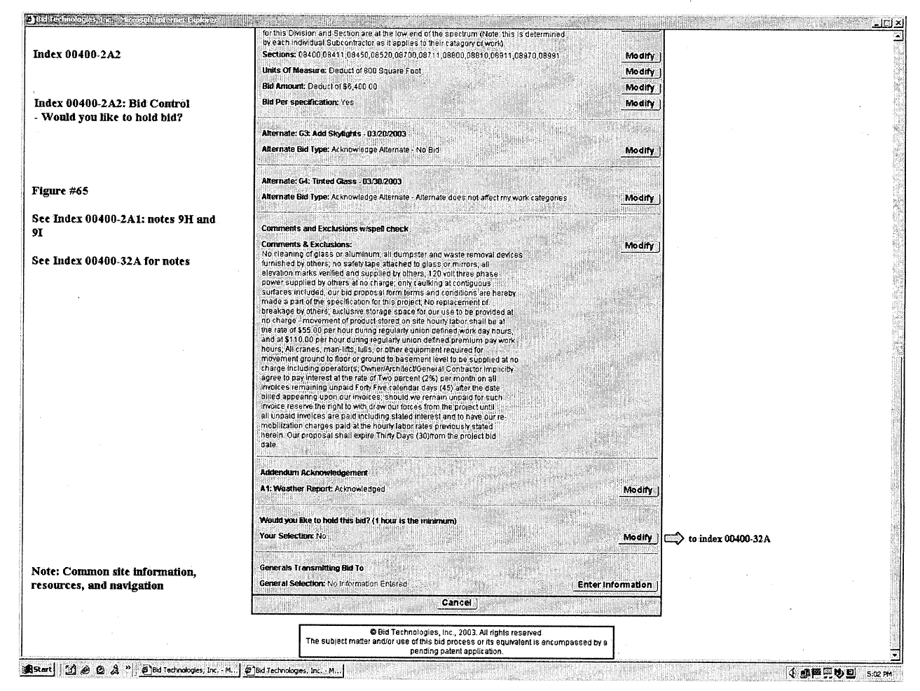

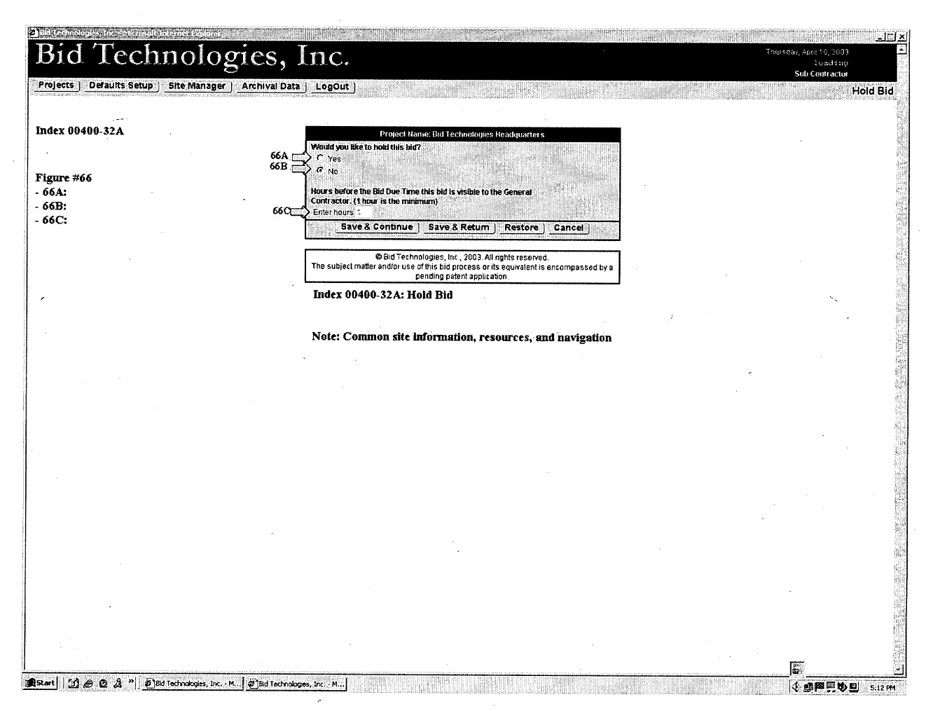

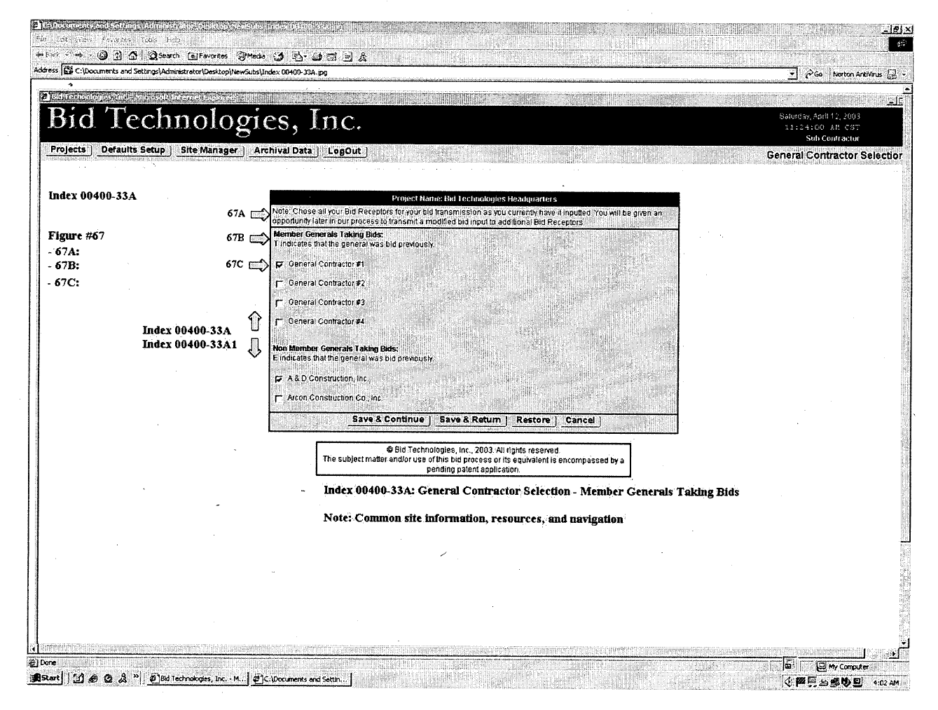

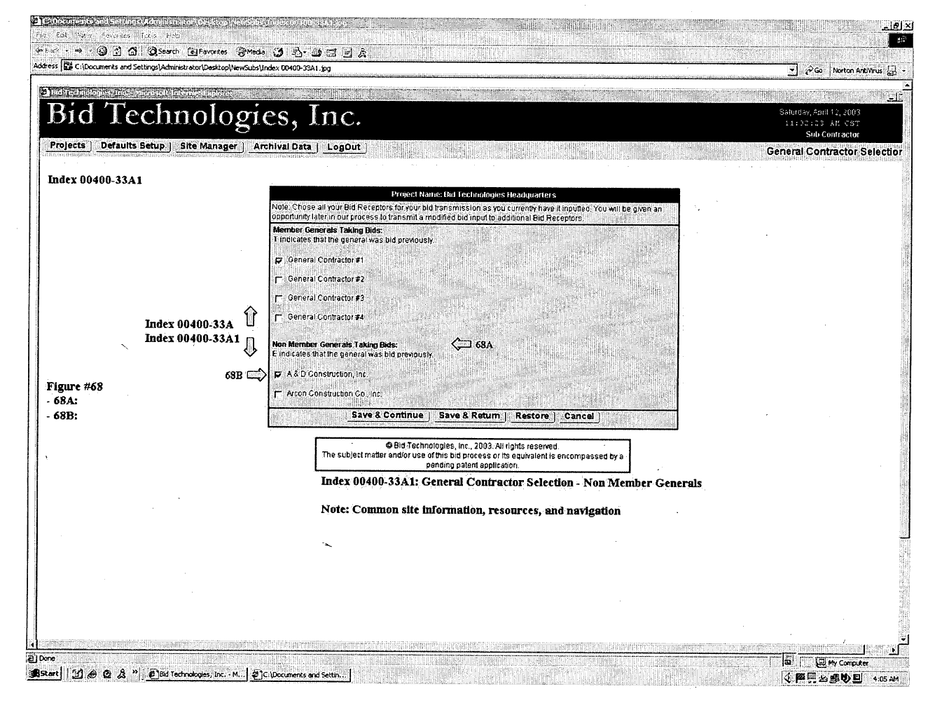

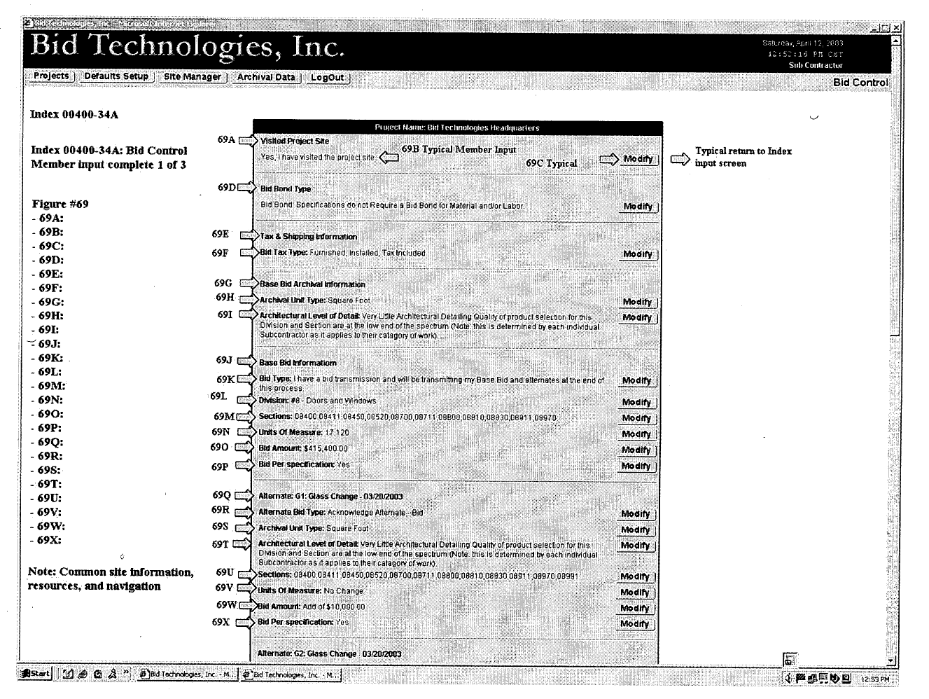

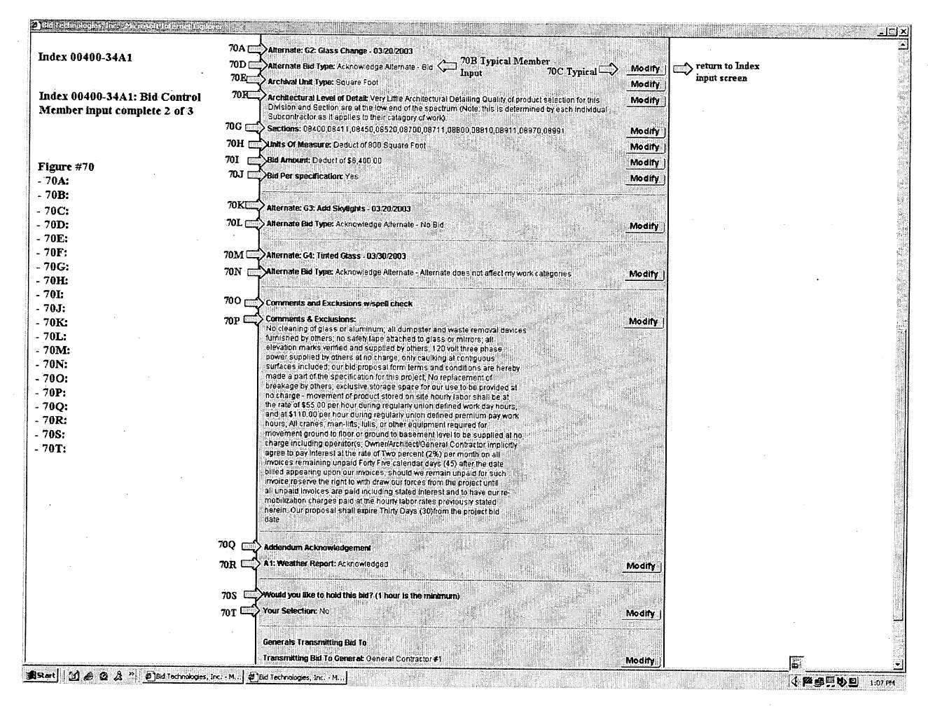

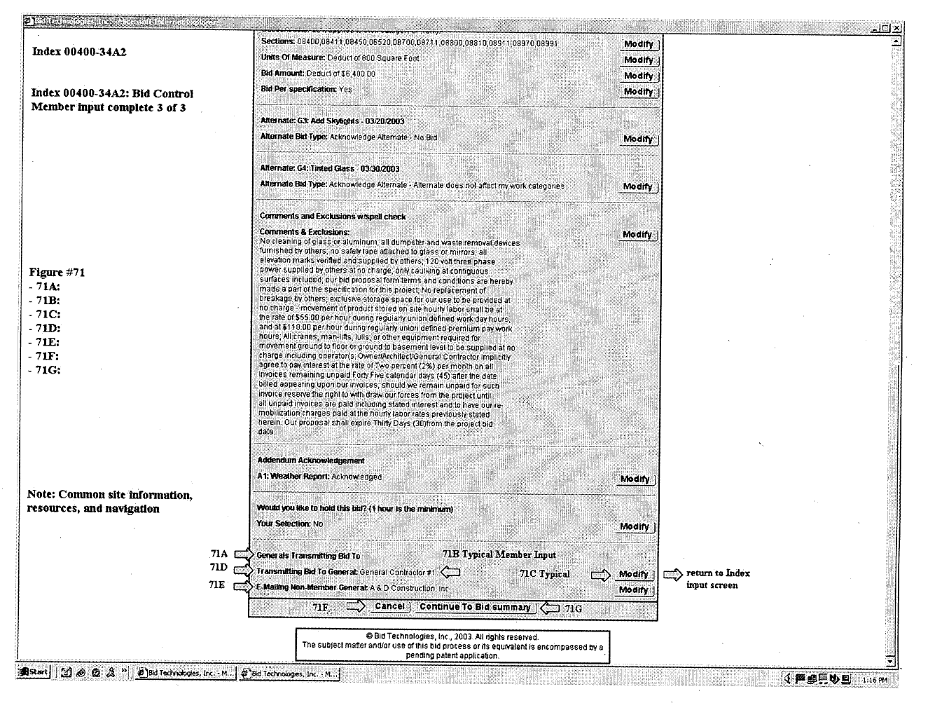

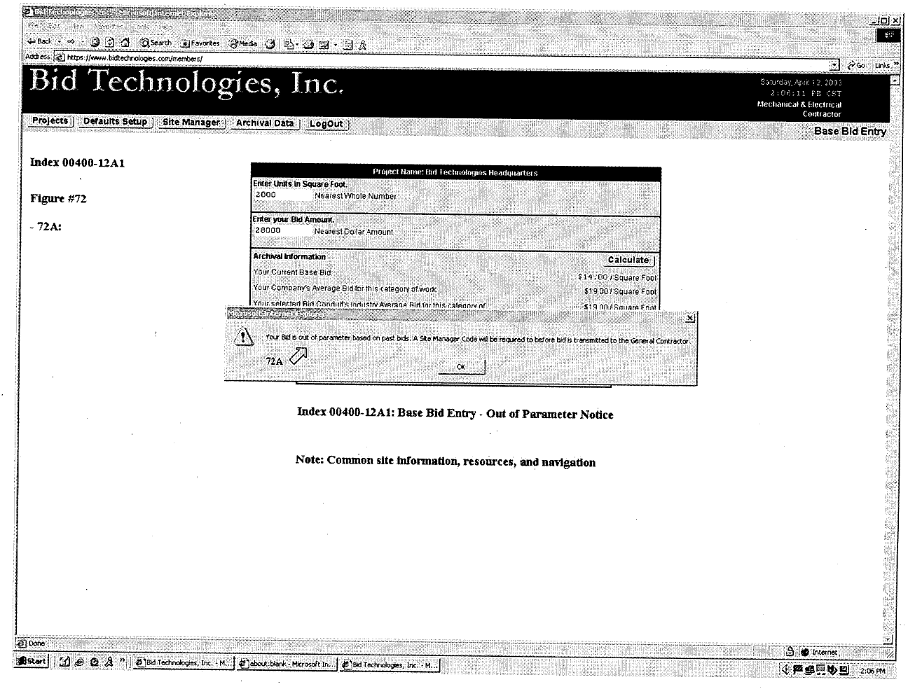

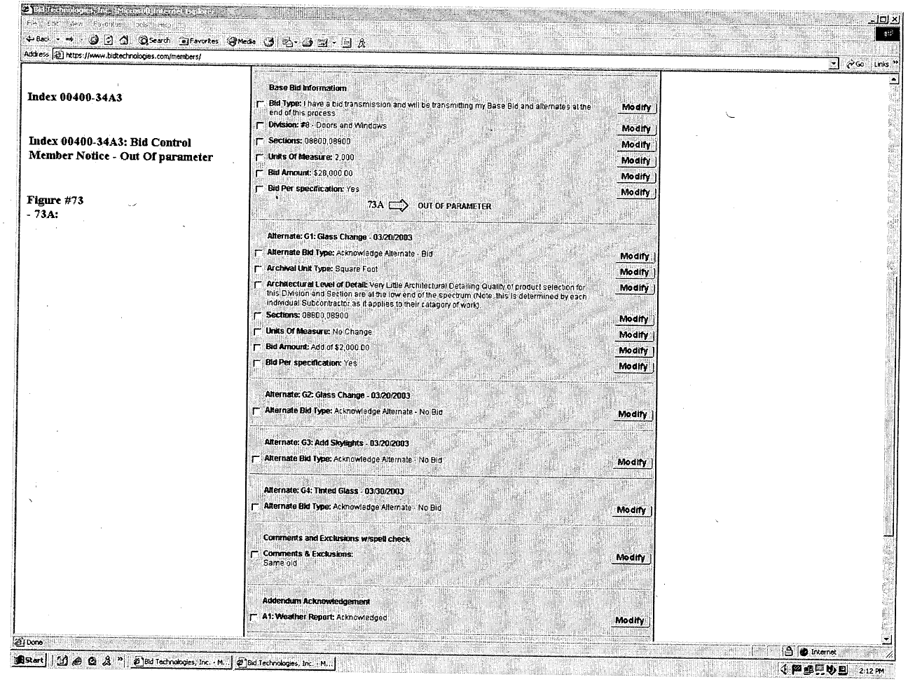

Index 00400-30A, FIG. #61, begins our discussion of Index 00400-2A1, FIG. #9, item 9F, which is the “Comments and Exclusions” screen item for this specific project that presents rather a “catch all” for terms, condition, clarifications, or any other parameter the Member considers important enough to input for display and transmission to their chosen Bid Receptors for this specific project. The indicated index displays item 61A that shows a large “memo” style text entry box. It is a memo style data receptor in that it provides the Members with the capability of entering an unlimited maximum of text characters to indicate, display, and transmit any and all items the Members consider significant enough to inform their chosen Bid Receptors about the specific details through their entry herein. The following is just one example amongst a multitude of items the Members may consider for inclusion: No cleaning of glass or aluminum; all dumpsters and waste removal devices furnished by others; no safety tape or markers attached to glass, mirrors, or aluminum frames; all elevations marks verified and supplied by others at no charge; 120 volt three phase electrical power on each floor furnished and supplied by others at no charge; only caulking at contiguous surfaces included; our bid proposal from terms and conditions are hereby made a part and incorporated into the specifications for this project; No replacement of breakage by others, Act of God, or Acts of Nature; the costs for all replacement glass and glazing, regardless of the nature of the breakage, to be added to our contract by bulletin and reimbursed at the invoice amounts to be provide for same. Labor rates for installations outside the scope of our contract shall be at the following rates: $55.00 per hour per man during normal work hours as defined by our union contract, $110.00 per hour per man after normal work hours as defined by our union contract; All cranes, lifts, man-lifts, and/or other equipment required to move our products on to the site and in to the project are to be furnished at no charge during normal work hours with operators included. Owner-Architect-Bid Receptor implicitly agree to pay interest of all unpaid invoices at the rate of two percent (2%) per month on all balance remaining unpaid 45 calendar days after the date upon our invoice. In the event invoices remain unpaid after 45 calendars day, we retain the sole right to remove our forces from the project site and to be compensated for all de-mobilization and re-mobilization costs. Our proposal shall be firm for 30 calendar days from the date hereon. Another example available to the Members might be the following: In the event the Members had an electronic/digital copy of their professionally prepared Proposal they might complete a digital copy and thereafter copy and paste this digital form into the “Comments and Exclusions” text input area. There is no system limitation on the type or information the Members may input or transmit within this Index. Another aspect of this Index results from the Members' selection of item 61B “Save and Spell Check” button. Upon their selection the Member is redirected to Index 00400-30A1, FIG. #62. Within this index the Members text input is reviewed by an open source spell checking application. Item 62A “Spell Checker: English (United States) Not in Dictionary:” displays the Members' inputted word that it has not found within its dictionary library. Item 62B “Replace with:” provides a text entry box which allows the Members to provide the correct word spelling or another word entirely in the event the spell checking application is unsuccessful or not able to provide the correct spelling. Item 62C “Suggestions” provides additional words in a drop down menu the Spell Checker application has found in it's library that the Member may chose to replace the incorrectly spelled work displayed in item 62A. Item 62D “Ignore” permits the Member to override the spell checking application and utilize the word in “Comments and Exclusions” as the Member spelled the word. Item 62E “Add” permits the Member to add the word to the spell checker application's dictionary library. Item 62F “Change” selects the word the Member chose in item 62C and inserts it in lieu of the “word” found in item 62A. The spell checker “runs” through the Member input in the Comments and Exclusion text entry box and displays all words that it cannot match within it's dictionary library. It does not identify grammar errors made by the Member. The spell checker is a mandatory “run” application, by this we mean the Member may utilize the “Restore” and “Cancel” button on Index 00400-30A, but in order to complete the system process the Members' input must be spell checked. Upon the Members completion of the spell check application's items 62D, 62E, and 62F they are redirected to Index 00400-30A2, FIG. 63

Index 00400-30A2, FIG. #63 confirms to Members the success of the previous spell check operation as indicated by item 63A. The Members must select a common navigation button to move forward within the process. Per our previous discussion, we have assumed the “Save and Return” button has been utilized, and with its selection we have concluded Index 00400-30A, and been redirected to the “Bid Control” screen Index 00400-2A1. Upon the Members' selection of the typical “Enter Information button for item 9G, Addendum Acknowledgement, the Members are redirected to Index 00400-31A.

Index 00400-2A1, FIG. #64 provides the Members a method to input confirmation regarding Addendum or Addendums. Addendums are instruction give to bidders prior to the specified bid date and time for a given project. These instructions are in reality changes to the project the Owner desires to make to the project, and are to be included within the Members' “Bid Amounts” for the specific projects Base Bid and/or any Alternates. By checking item 64A Members acknowledge they have review the Addendums for all changes the Addendum might make to the “Plan and Specs” for their work categories and they have included any price modifications created there from within their “Bid Amounts”. Item 64B displays the record date of the Addendum to the Members. Upon completing their check box selections, the Members select a common navigation button. Per our previous discussion, we have assumed the “Save and Return” button has been utilized, and with its selection we have concluded Index 00400-31A, and been redirected to the “Bid Control” screen Index 00400-2A1. Upon the Members' selection of the “Modify” button for item 9H, “Would you like to hold this bid? (1 hour is the minimum)”, the Members are redirected to Index 00400-32A.

Index 00400-32A, FIG. #66 provides to Members a method to hold their bid for a specific time period prior to the specific project's specifications due time. In order to use this parameter, the Members must first chose the item 66A “Yes” radio button for the query “Would you like to hold this bid?” The default choice is “No”, item 66B, although the default can be set to Yes. The Members, upon choosing item 66A, are then able to enter numeric number greater than 1 within the item 66C text entry box. The Members' numeric entry answers the query “Hours before the Bid Due Time this bid is visible to the General Contractor. (1 hour is the minimum)” the system poses. Upon completing either of their selection choices, the Members select a common navigation button. Per our previous discussion, we have assumed the “Save and Return” button has been utilized and with its selection we have concluded Index 00400-32A, and been redirected to the “Bid Control” screen Index 00400-2A1 where the Members' choice is displayed as item 9I. Upon the Members' selection of the typical “Enter Information button for item 9J, “Generals Transmitting Bid to”, the Members are redirected to Index 00400-33A.

Index 00400-33A, FIG. #67 in combination with Index 00400-33A1, FIG. #68 provide the Members a method to select the Bid Receptors to whom they want to transmit this specific bid transmission for this specific project. The Members choose additional Bid Receptors through Index 00400-36A discussed later herein (and/or the “Modify” button upon the Members return to the “Bid Control” screen) to transmit a different specific bid transmission for this specific project. Within this index, Members chose Bid Receptors, who are Members of the system, by checking the check box item 67C to the left of their displayed Names to indicate to the system the member Bid Receptors they are transmitting bids to. The Architect for the specific project inputs the displayed member name choices for “Architect Projects”. The member General Contractor for the specific project is displayed for “General Contractor Projects.” Item 67A provides instruction for the Members concerning their Bid Receptor choices. Item 67B, also, provides instruction for Members concerning their Bid Receptor choices in the event they chose to bid additional Bid Receptors as discussed late in Index 00400-36A, or utilize the “Modify” button on the “Bid Control” screen. Index 00400-33A1, FIG. #68 provides the Members the same choices as Index 00400-33A for “Architect Projects” for Non-Member Bid Receptors through item 68B. Item 68A identifies the Non-Member category. This category is not available within the “General Contractor Projects”, as these projects are inputted by the specific Member General Contractor for which there are no other Bid Receptors due to the nature of the origination of the project input into our system process. Upon completing their selection choices, the Members select a common navigation button. Per our previous discussion, we have assumed the “Save and Return” button has been utilized, and with its selection we have concluded Index 00400-33A and Index 00400-33A1, and been redirected to the “Bid Control” screen Index 00400-2A1.

At this time only item 9K remains un-discussed within Index 00400-2A1. Item 9K is a common navigation button. Upon Member selection this button deletes all data for the current specific project the Member has inputted data, and redirects them to the “Projects” screen to again choose a specific project to enter bid data for. This item allows the Members to totally cancel their previous input, For example, in the event they have chosen the wrong project for the bid data they have prepared to send for another project.

At this time the Member has completed the data necessary to transmit their bid to their chosen Bid Receptors. All items for Index 00400-2A, items 8A-8H and Index 00400-2A1, items 9A-9J display “Modify” buttons rather than “Enter Information” buttons, and another navigation button item 71G titled “Continue to Bid Summary” is displayed for Member selection at the bottom of the “Bid Control” screen. This status is displayed by Indexes 00400-34A, 34A1, and 34A2. These three indexes in combination are necessary to show the entire “Bid Control” screen Members' choices, as displayed within the system's single scrollable “Bid Control” screen. In general when a Member selects a “Modify” button on the system's “Bid Control” screen such as Index 00400-34A2, noted as typical item 71C, they are redirected to the input index for the item displayed to the left of the “Modify” button they have chosen to select. For item 71A, 71B, 71D, and 71E see Indexes 00400-33A and 33A1. Item 71F the common site navigation “Cancel” button has been previously discussed.

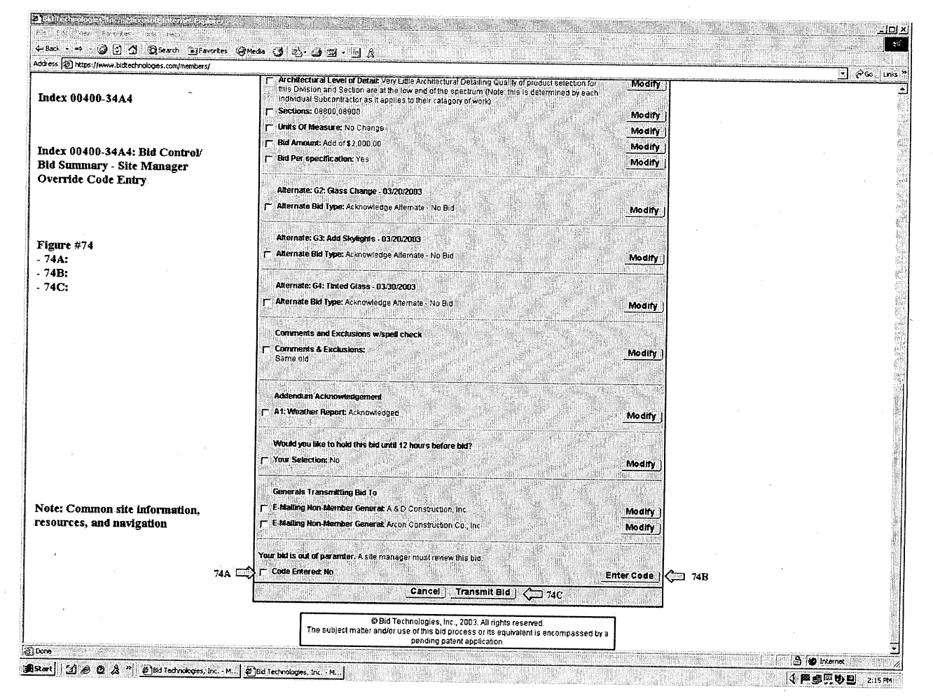

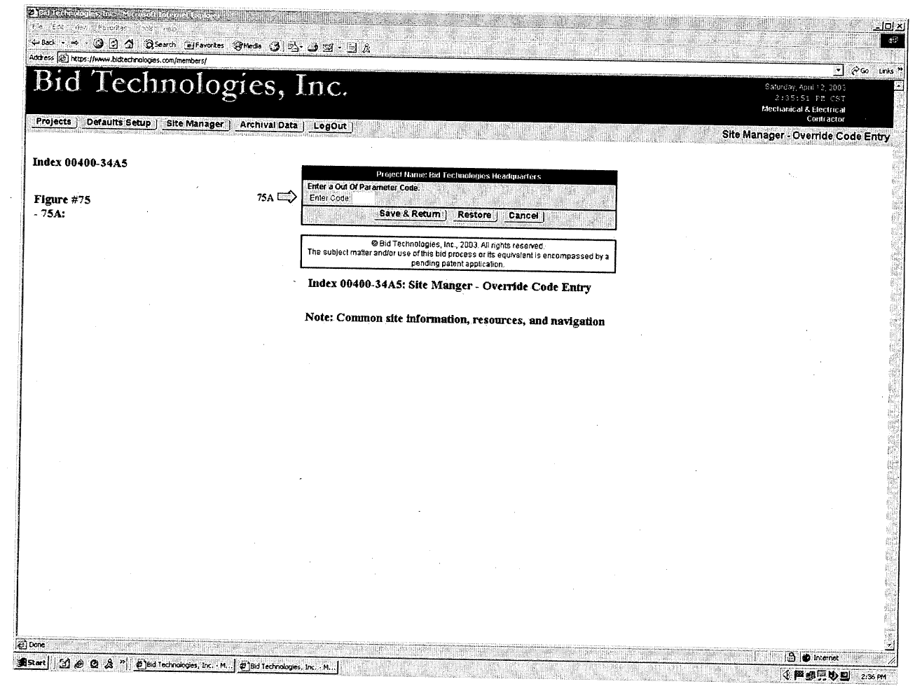

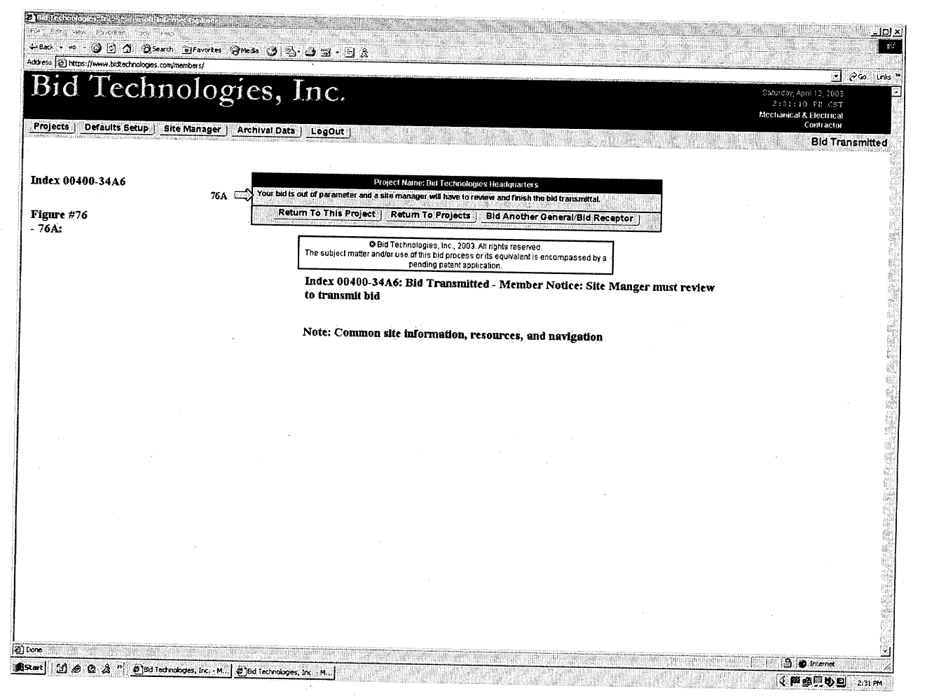

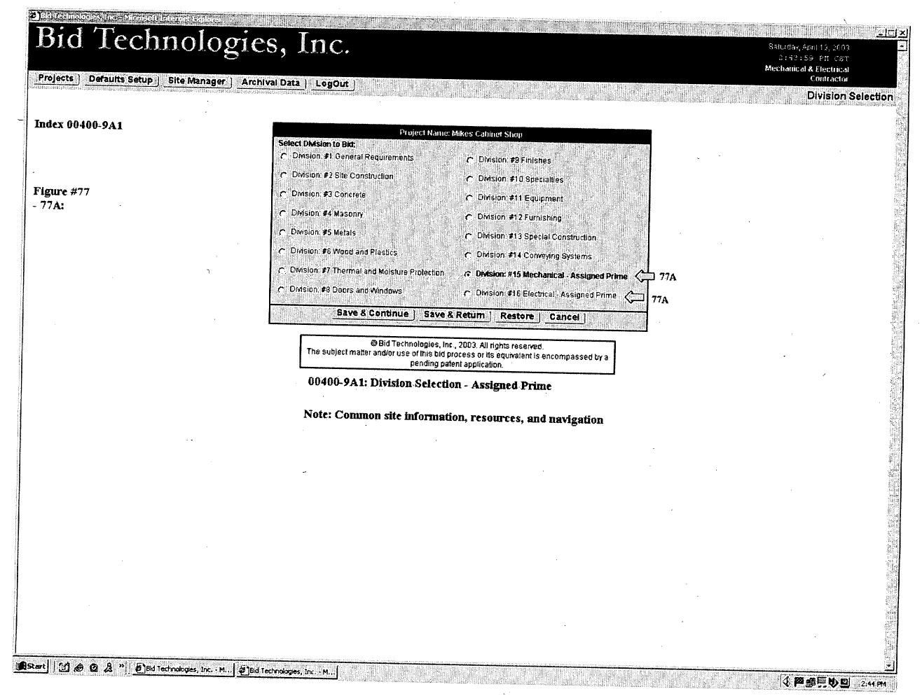

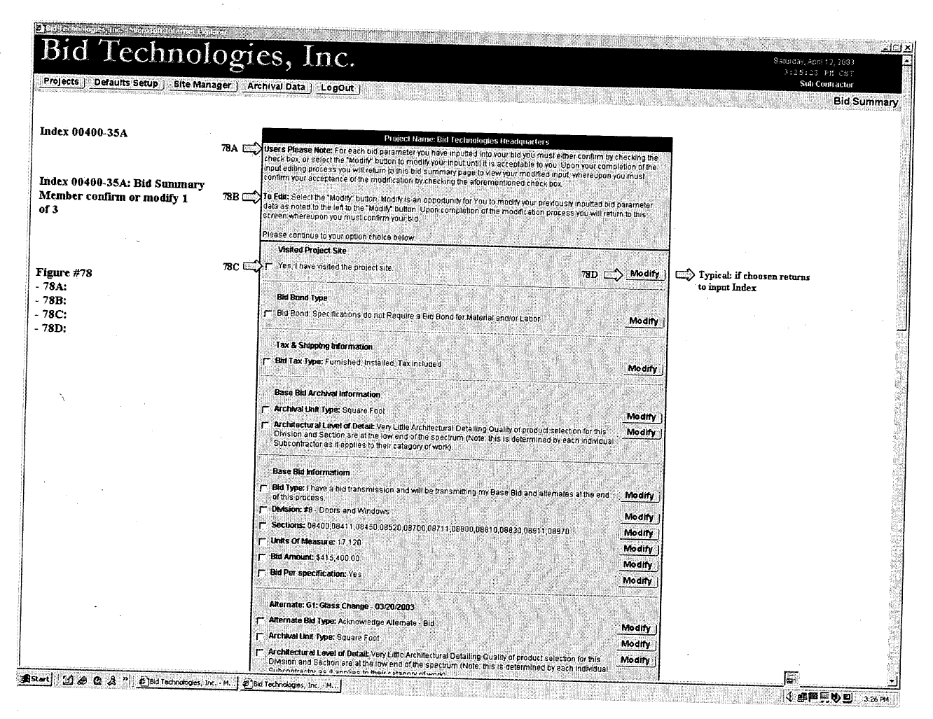

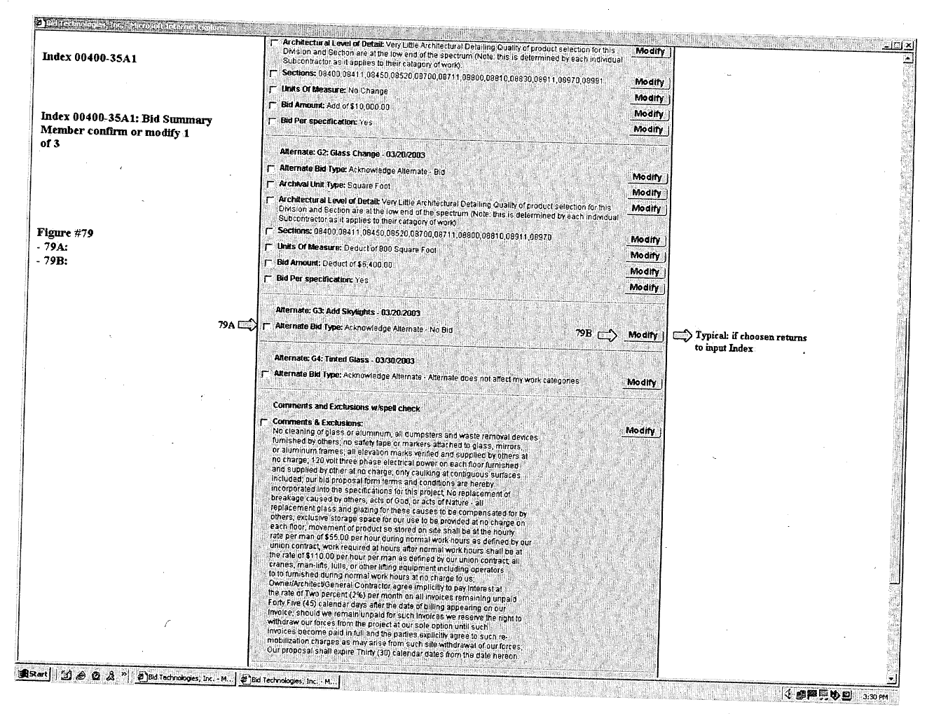

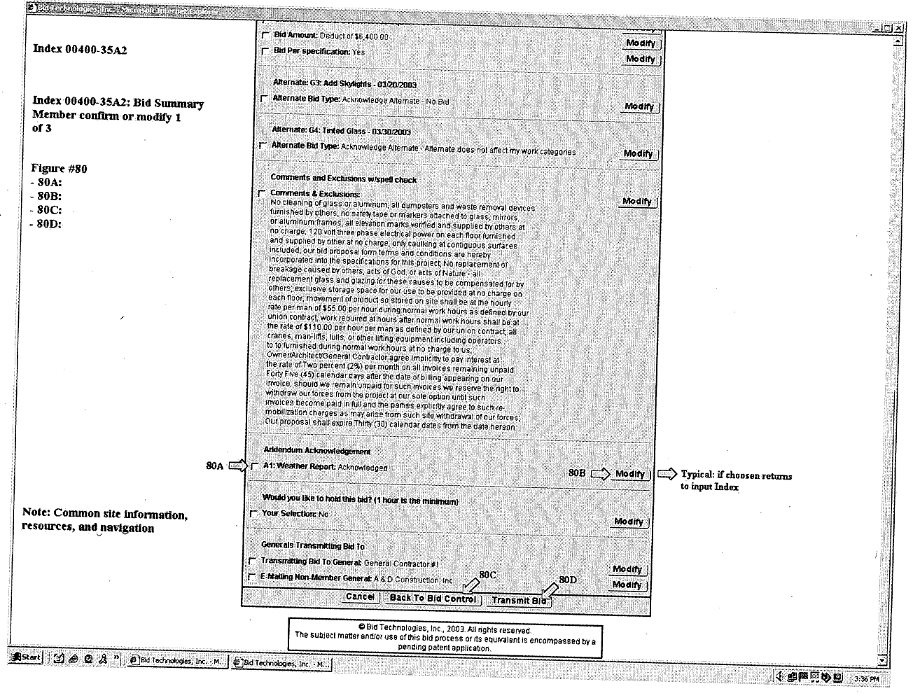

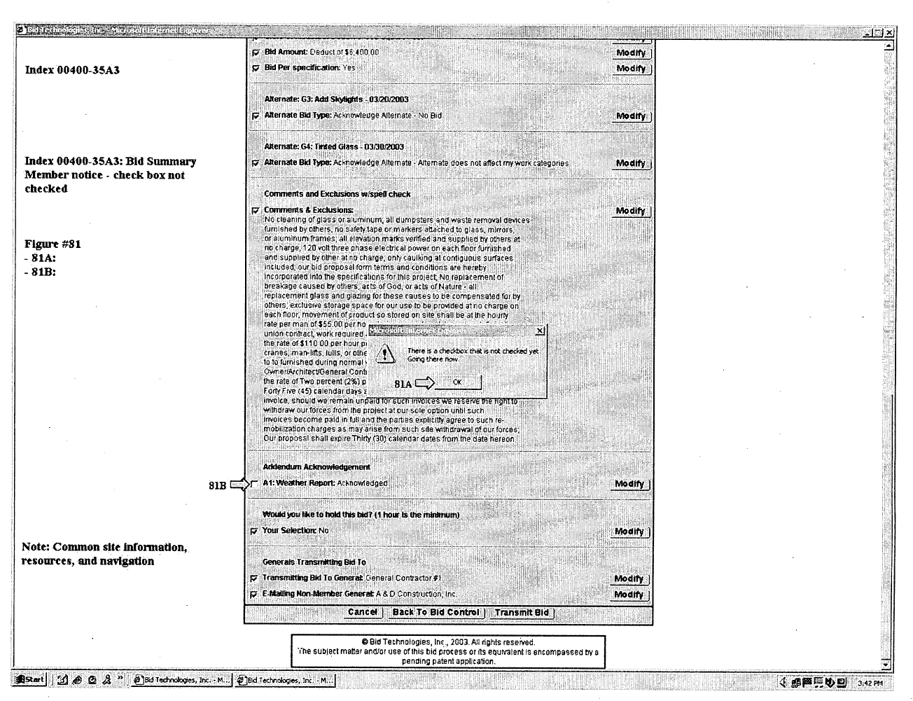

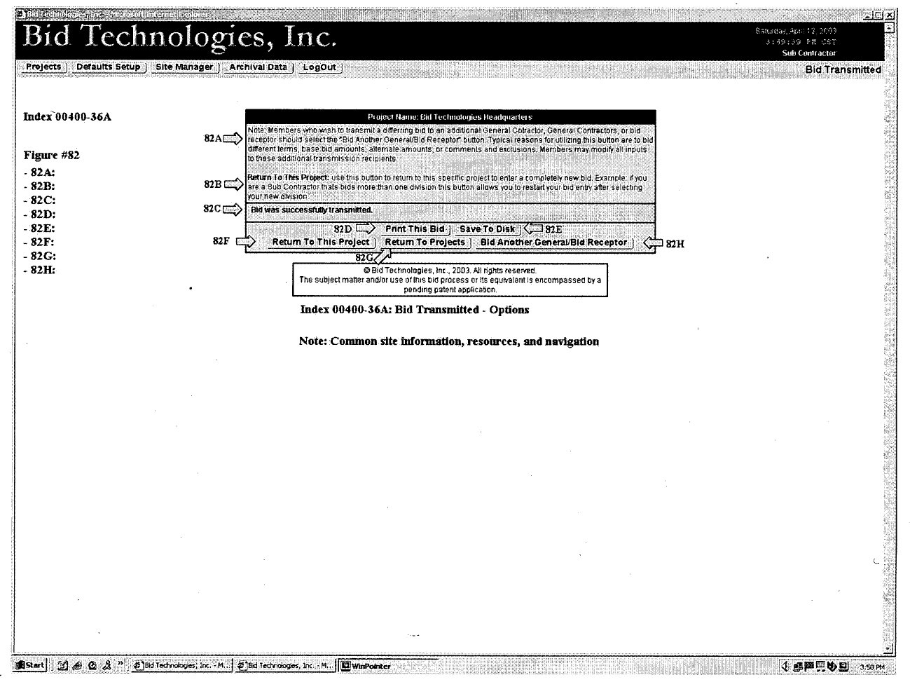

Before continuing with the “Continue to Bid Summary” button we shall discuss as noted here Index 00400-34A3, FIG. 73, which displays the system's item 73A “OUT OF PARAMETER” alert to the current Member. This alert also precipitates the “Your bid is out of parameter. A site manager must review this bid” text and item 74A check box for “Code entered: No” for Index 00400-34A, FIG. #74, which displays immediately after the “Bid Control” screen's “Generals Transmitting Bid To” section. This alert display occurs because the Members “Bid Amount” input exceeds the percentage allowable through either the current transmitters percentage inputted, or as is more likely the case the percentage the Site Manager has inputted. These percentages are discussed in Indexes 00500-1A1 “Default Setup (current Transmitter) and 00600-1A3 “Site Manager—Out of Parameter Alert” (Site Manager) which will be discussed later herein. The quotient is computed comparing the Member's current “Archival Average” value (Unit of Measure, Unit of Measure range (if chosen), and the Architectural Level of Detail of the current project for the specific category of work as chosen by the Originator of the project and displayed within the Project screen's “Project Name & Category of Work”) to the Member's “Bid Amount” value. The percentage is inputted and calculated for same percentage above and below the archival average of the Member. This alert does not necessarily mean the bid parameter is in error, as the specific project's plans, specifications, or job conditions cannot be considered in the valuation. But, given the Member's previous bid Member's “Bid Amount” average values for these categories of work, they give the Members a strong reason for checking the bid parameters again before transmitting the bid. The Members' current transmitter may continue and complete their data input, but unless the Site Manager's Override code is entered for “OUT OF PARAMETER” bids they will not be able to transmit their bid until the appropriate override code is entered as noted previously (to be detailed within Indexes 00500-1A1 and 00600-1A3). All notes as detailed herein for Index 00400-34A3 are germane for Index 00400-34A4 as they relate specifically to the alert and override code entry. Index 00400-34A5, FIG. #75 provides the Members an opportunity to input the override code noted as item 75A required to transmit a completed bid entry for bid transmission as required on either the “Bid Control” or “Bid Summary” screen. This item is reached by redirection by the Members' selection of the “Enter Code” button noted as item 74B on Index 00400-34A4 “Bid Summary” screen with the Bid Control screen having a similar input button. Index 00400-34A6, FIG. #76, item 76A is displayed in the event the Member or Site Manager has not inputted the appropriate override code, and the Member has chosen to select the item 74C “Transmit” button on Index 00400-34A4. Thereafter see Index 00400-1A4, item 21C which has been previously discussed or Index 00600-AA5, item 95B which will be discuss later herein. The “OUT OF PARAMETER” notice may be a response to a bid or bid component being outside of parameters pre-established by the Bid Receptor (e.g., length of time of work, number of symbols in a password, materials, labor costs, material costs, etc.) or may be in response to the bid or bid component being outside of a standard deviation range for all other bids. The component may be identified for review without explanation so that a bidder (Member) will not be able to use bid submissions to, in effect, query the bid process to determine approximations of other bids. A statement that a bid component should be considered because of of an anomalous or unusual value would suffice.

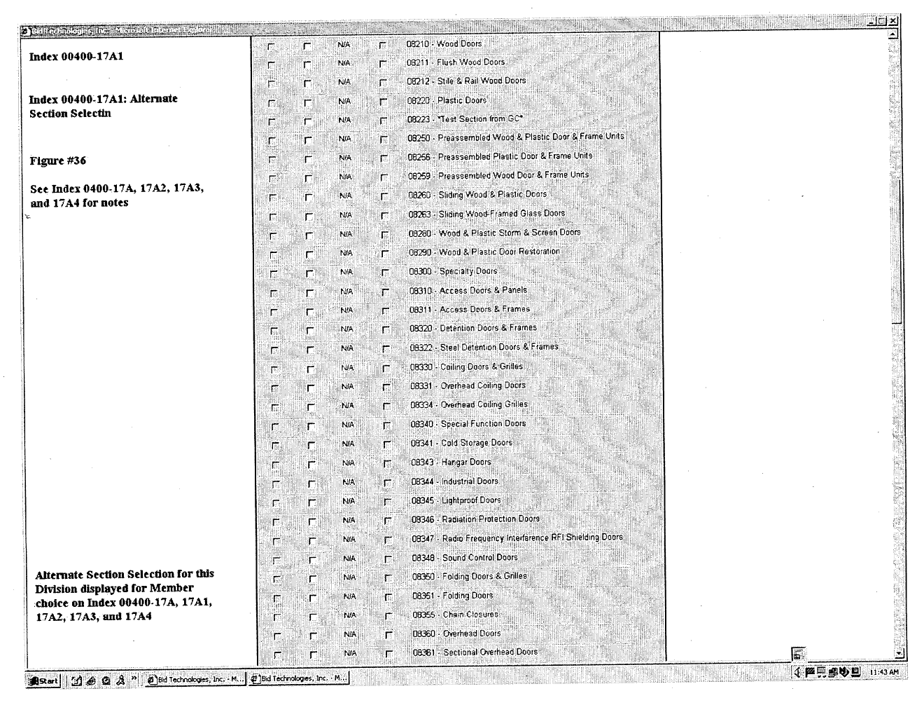

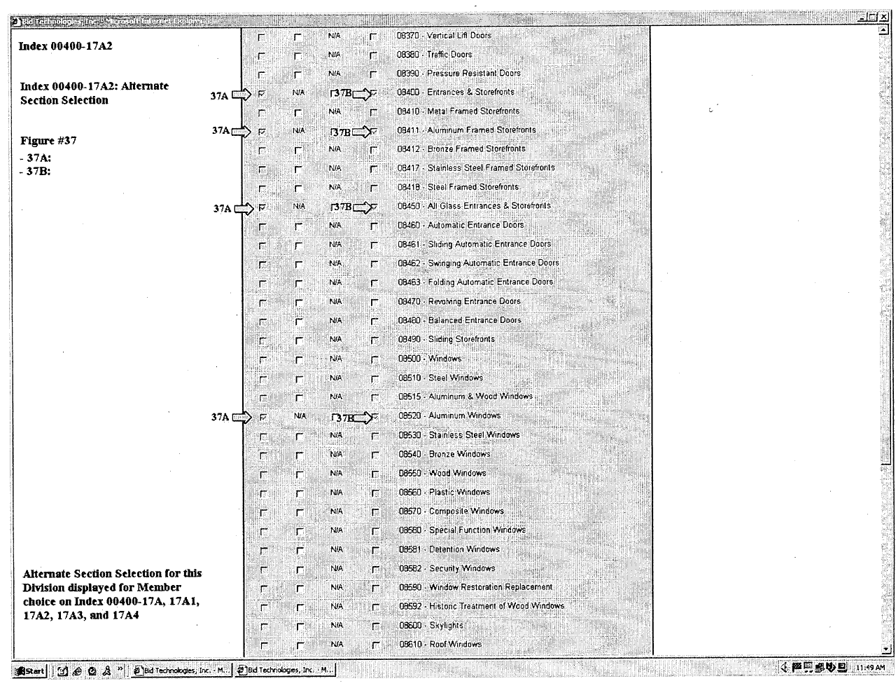

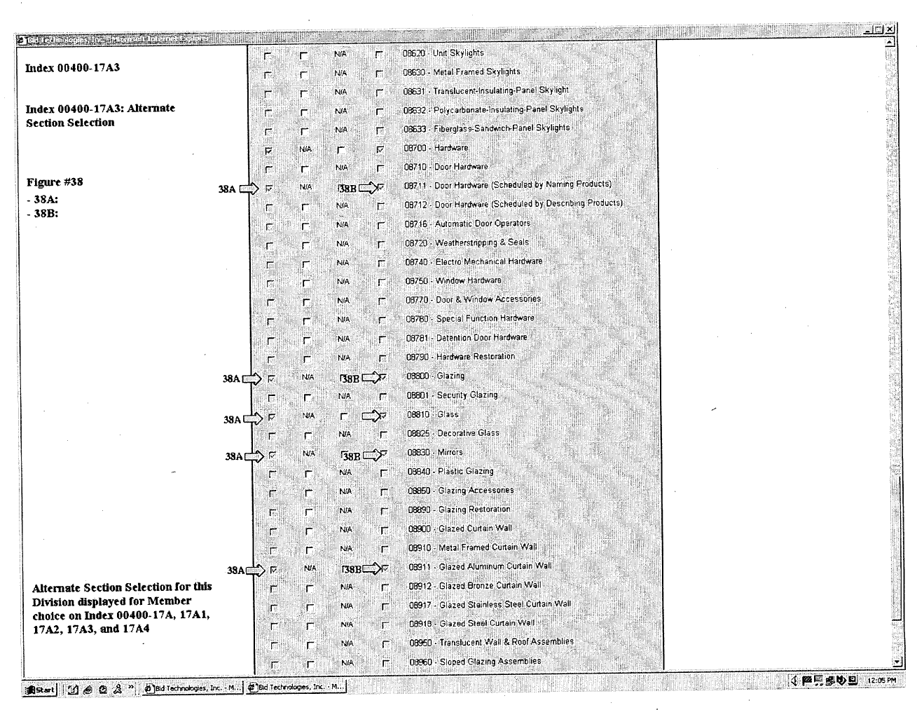

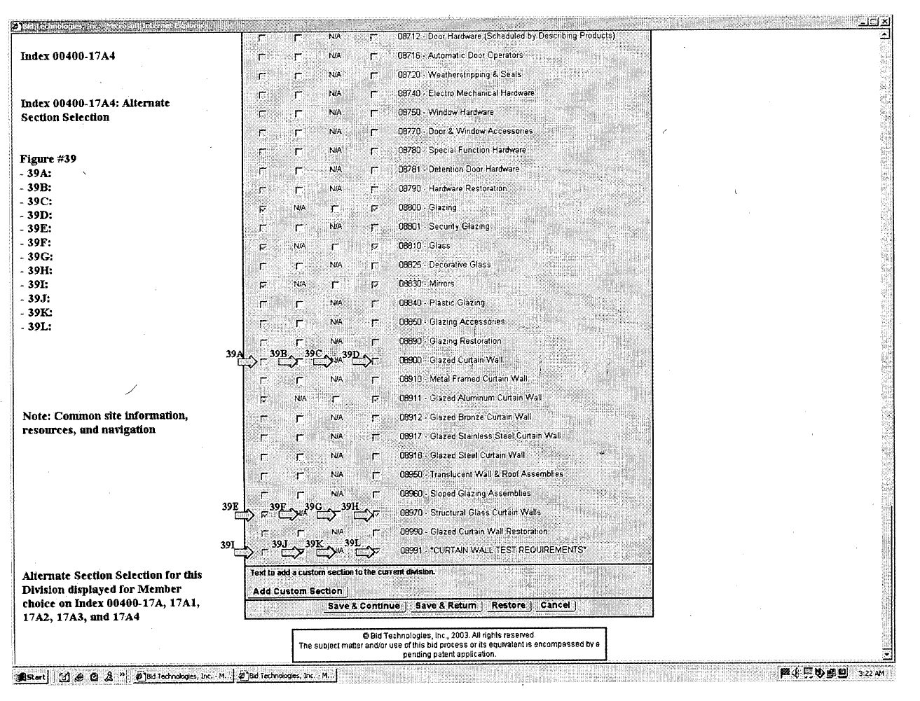

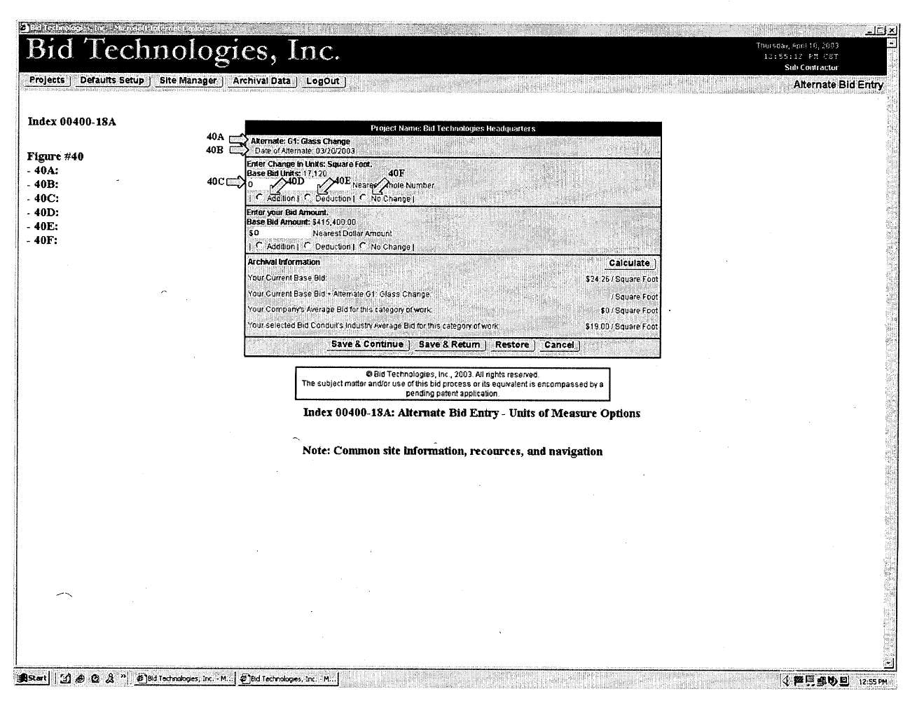

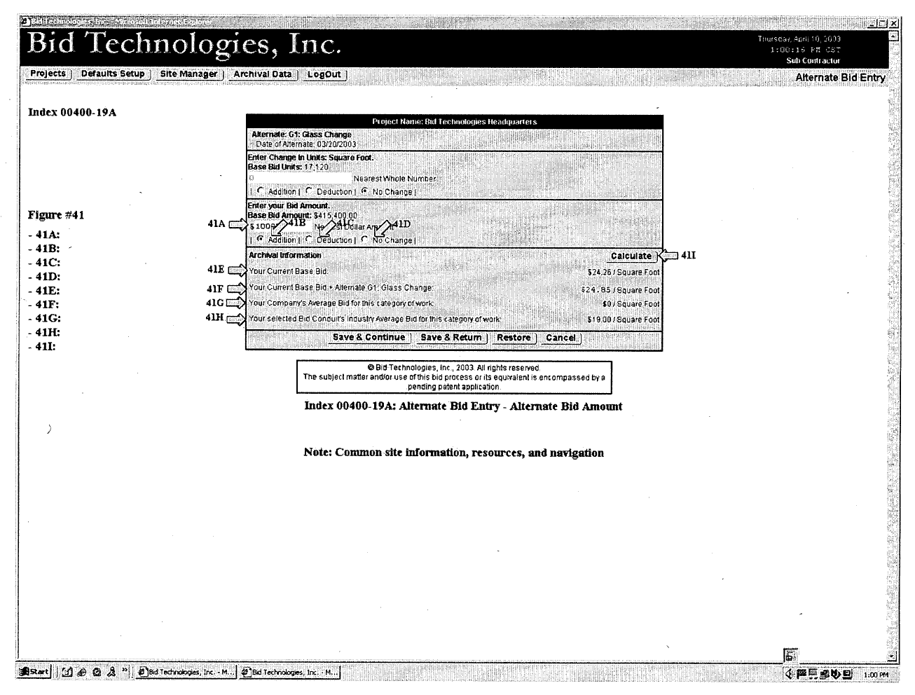

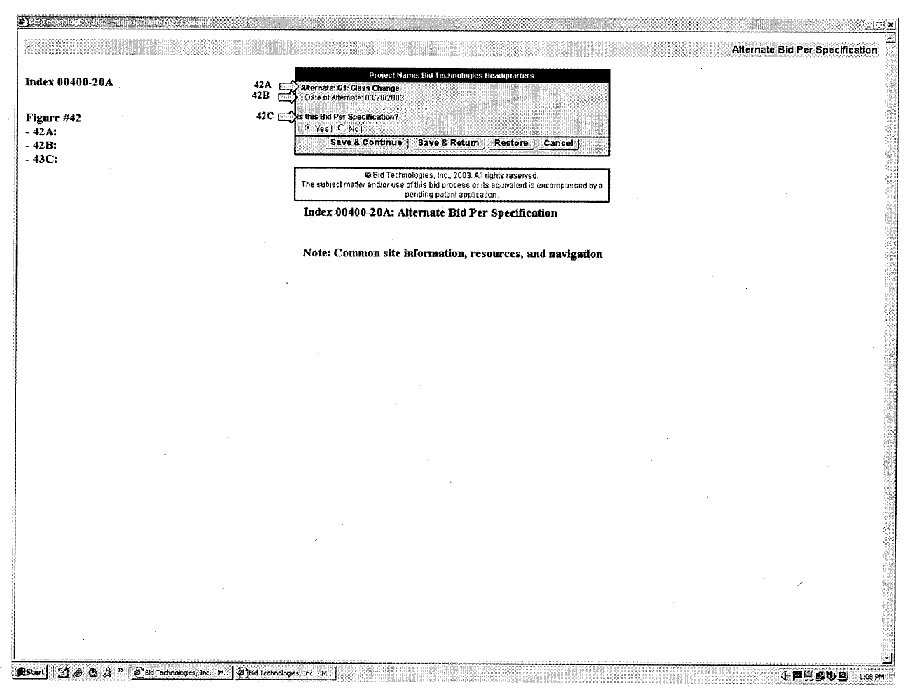

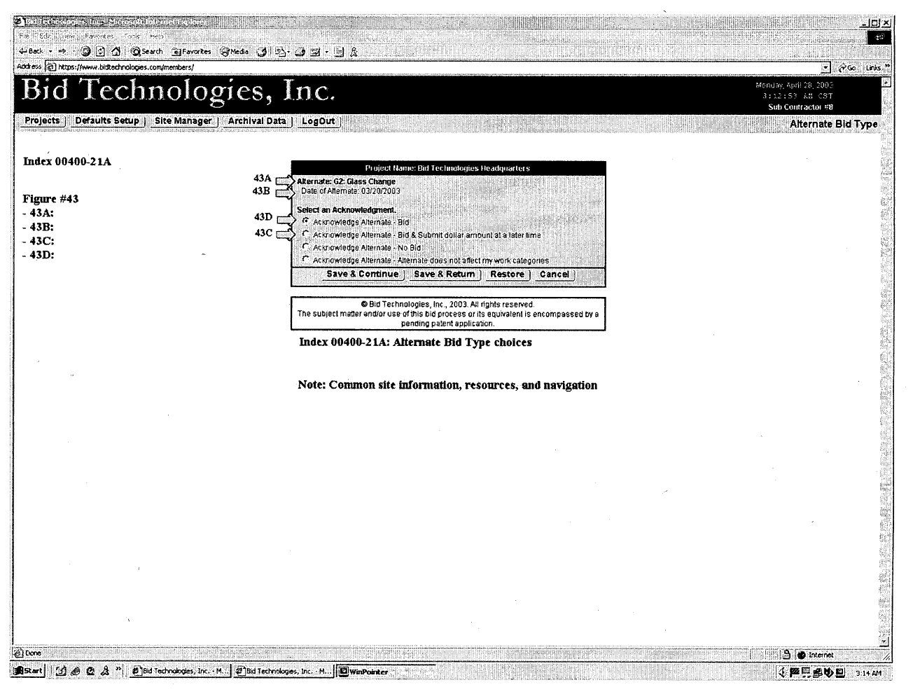

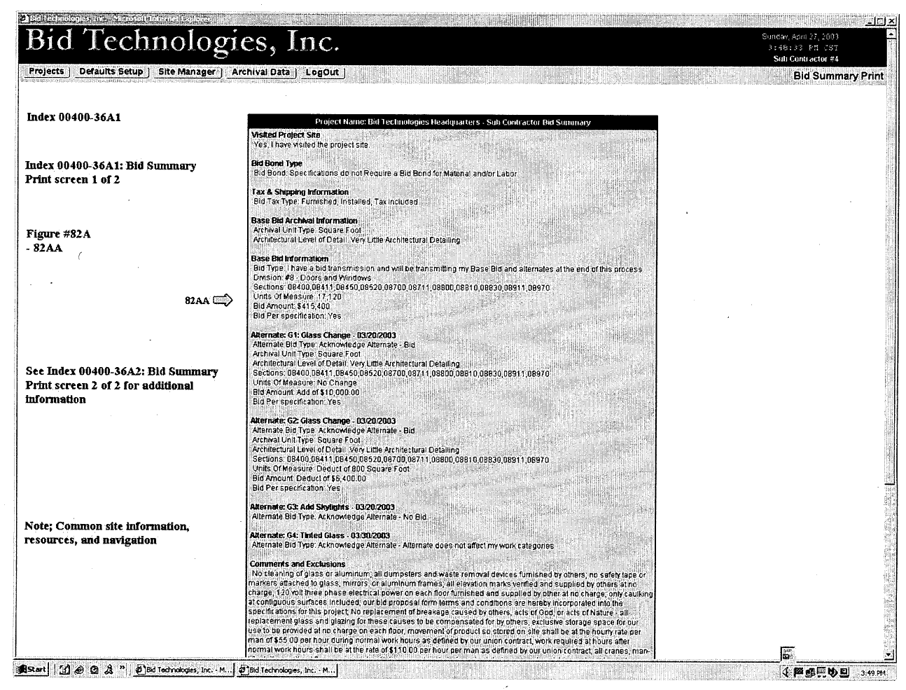

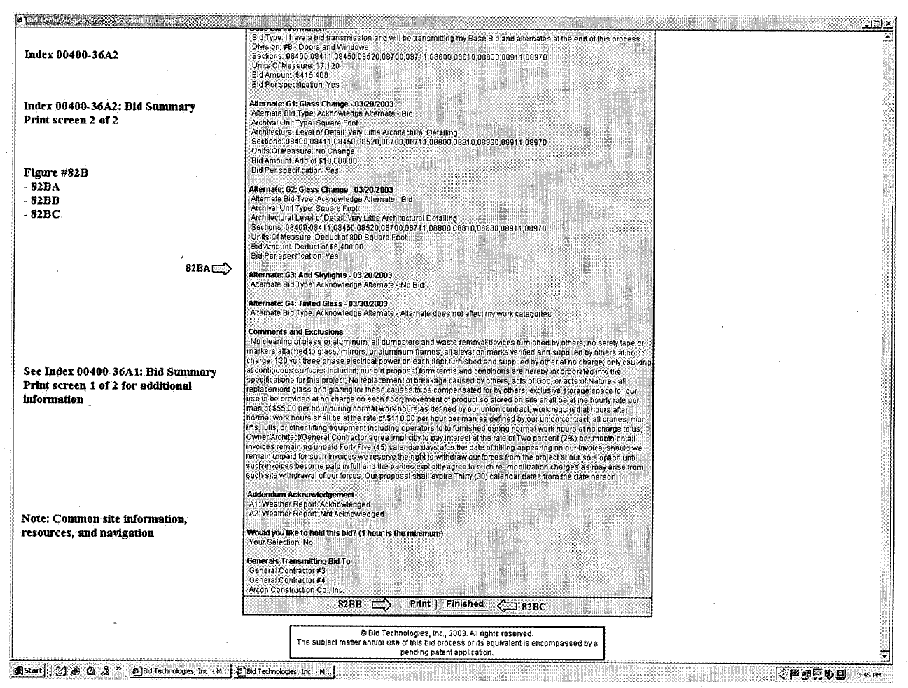

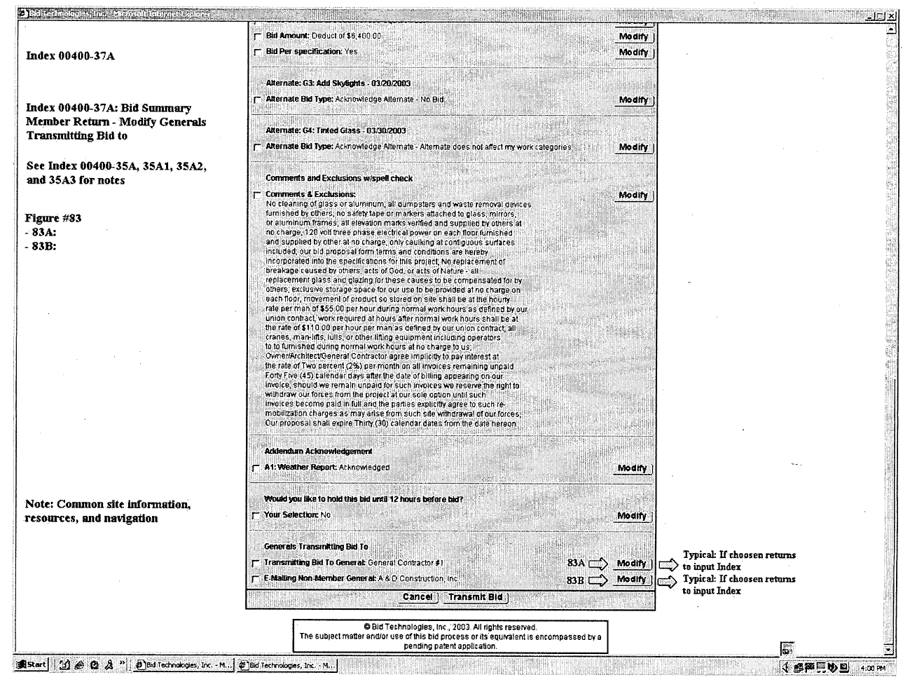

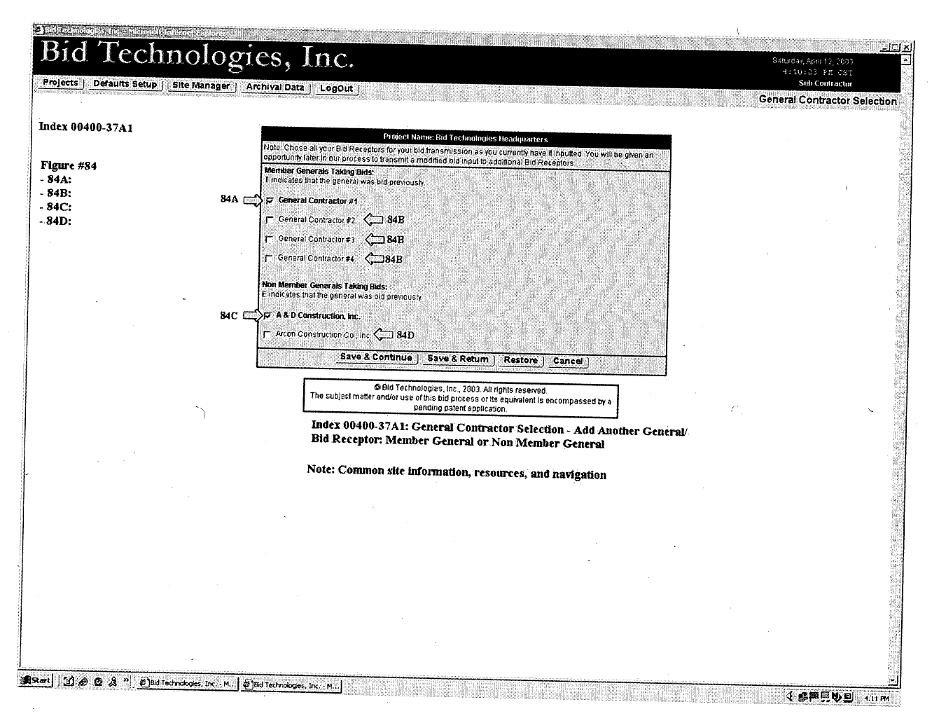

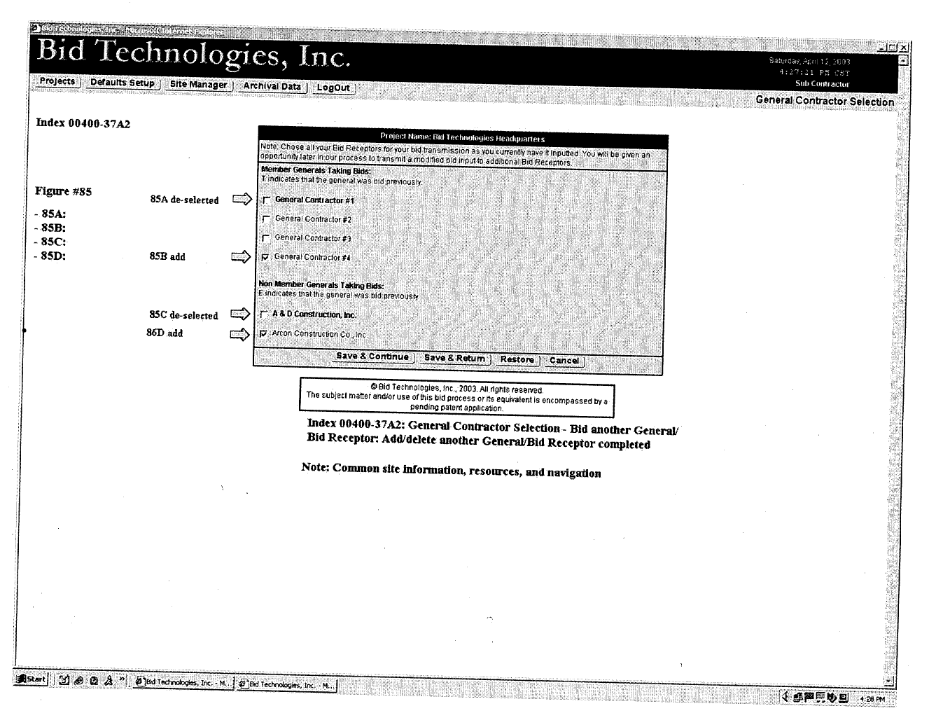

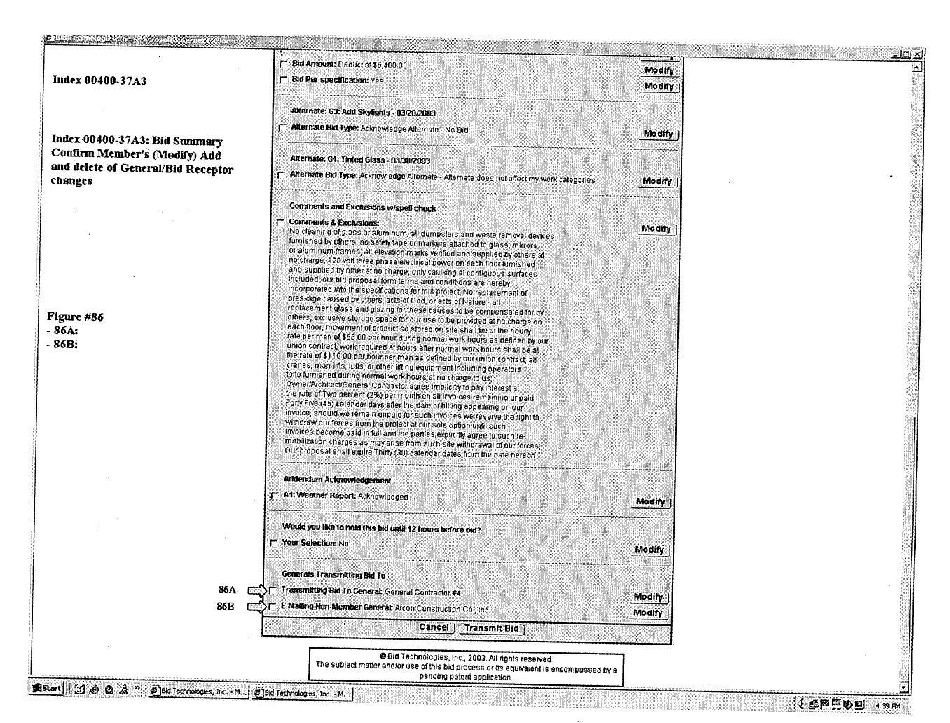

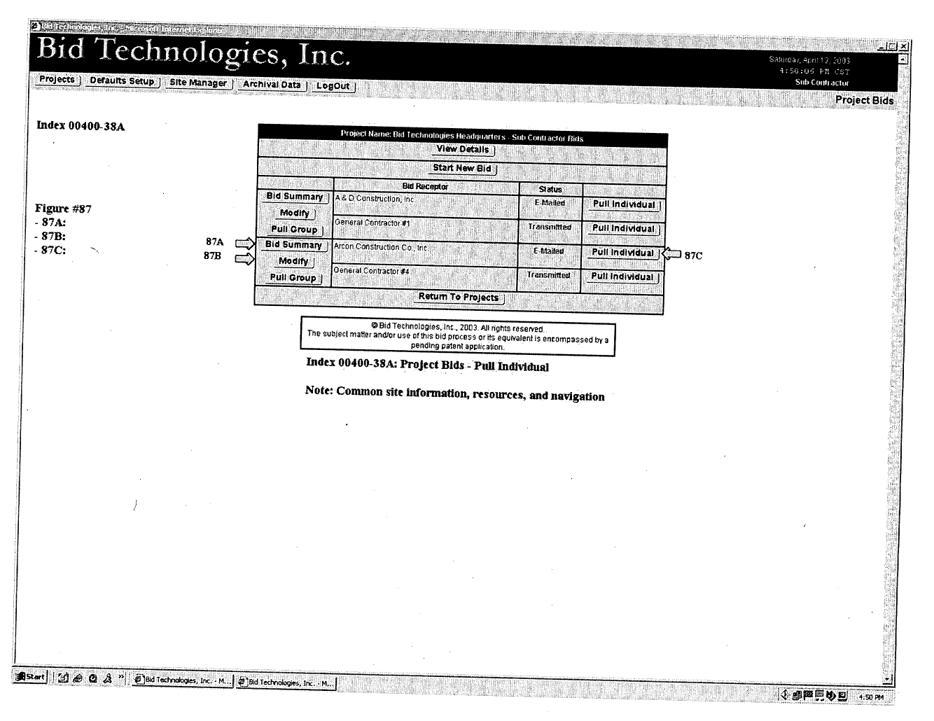

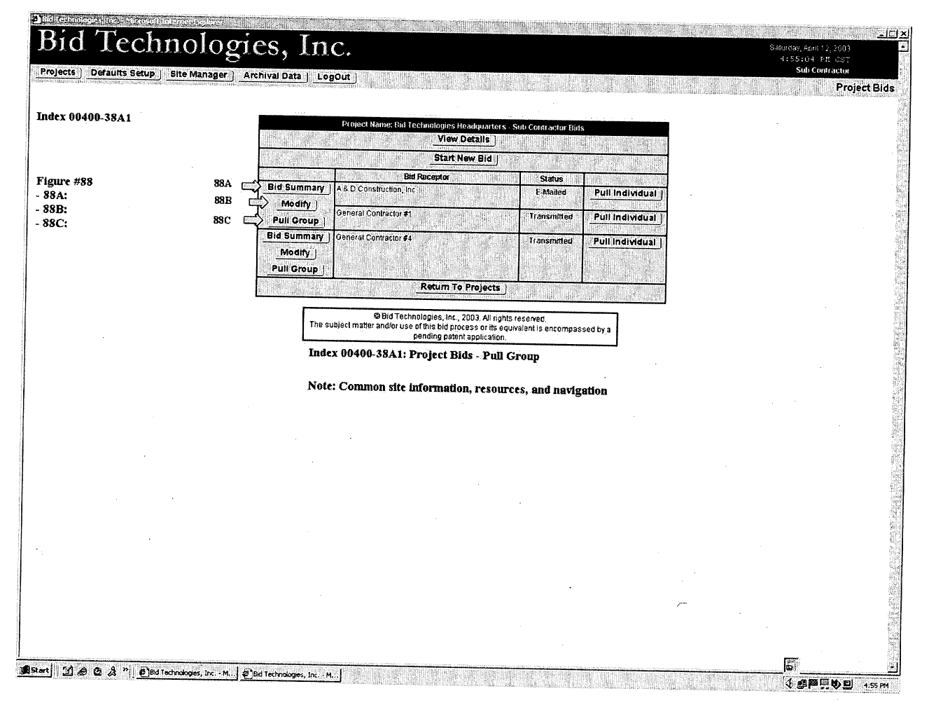

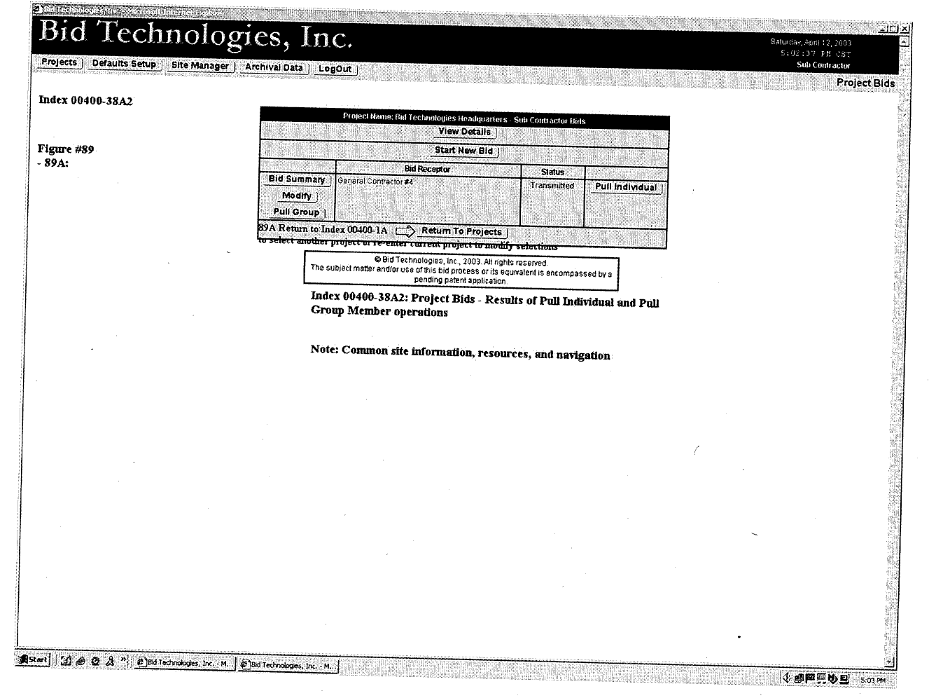

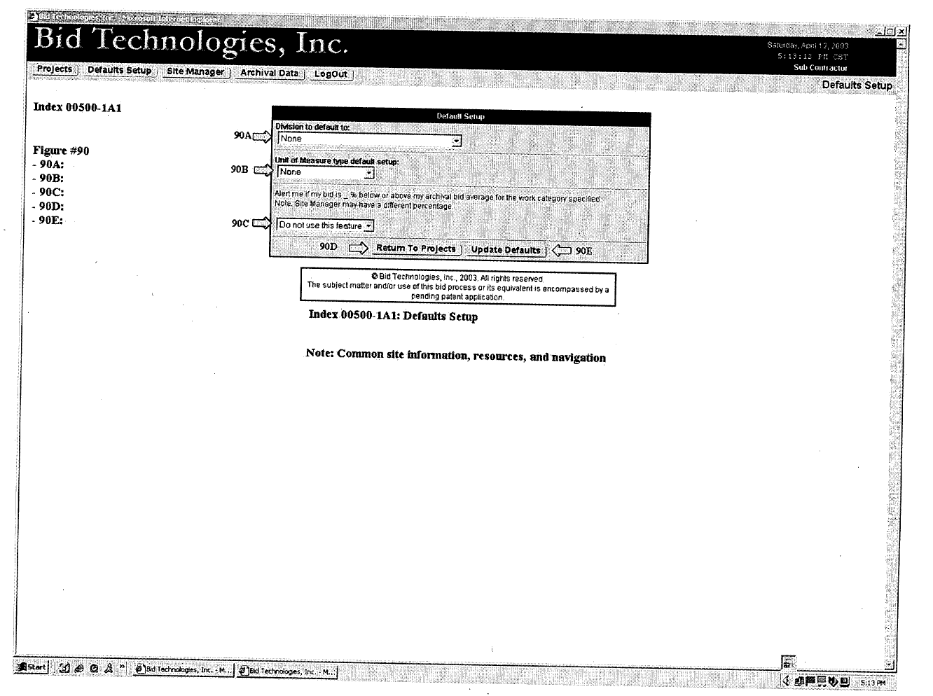

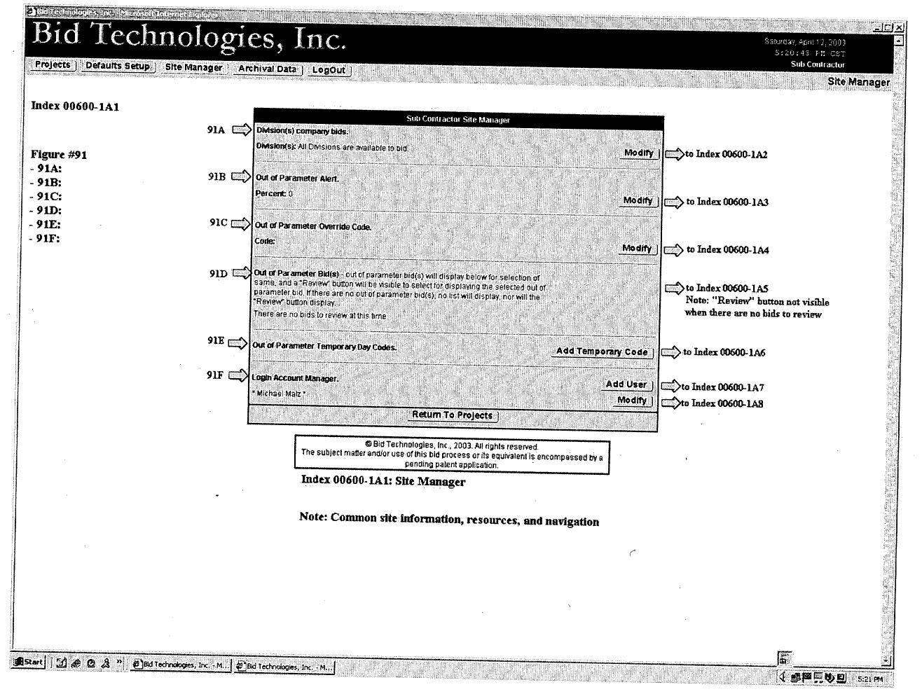

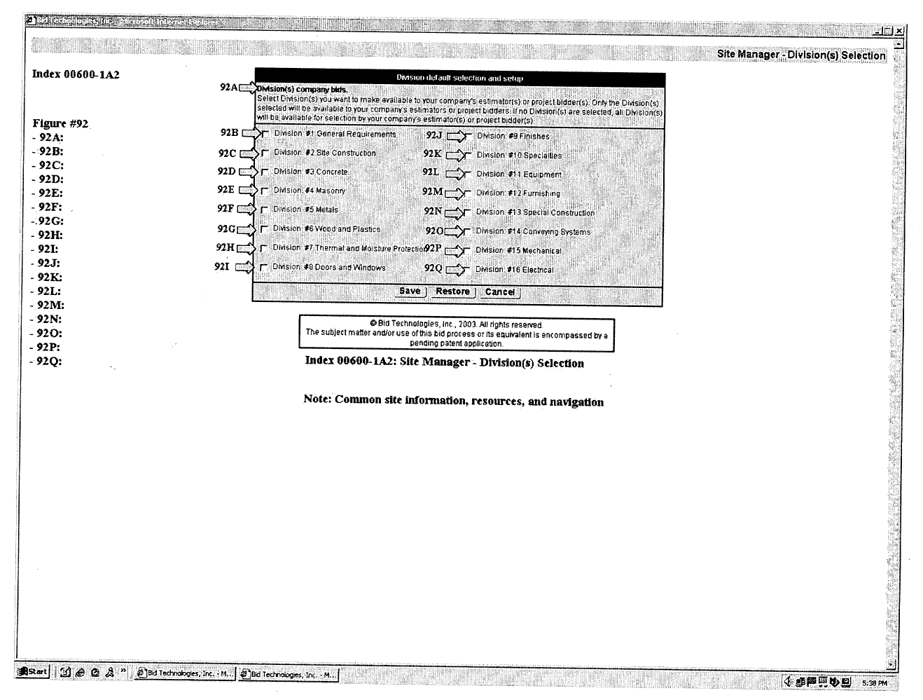

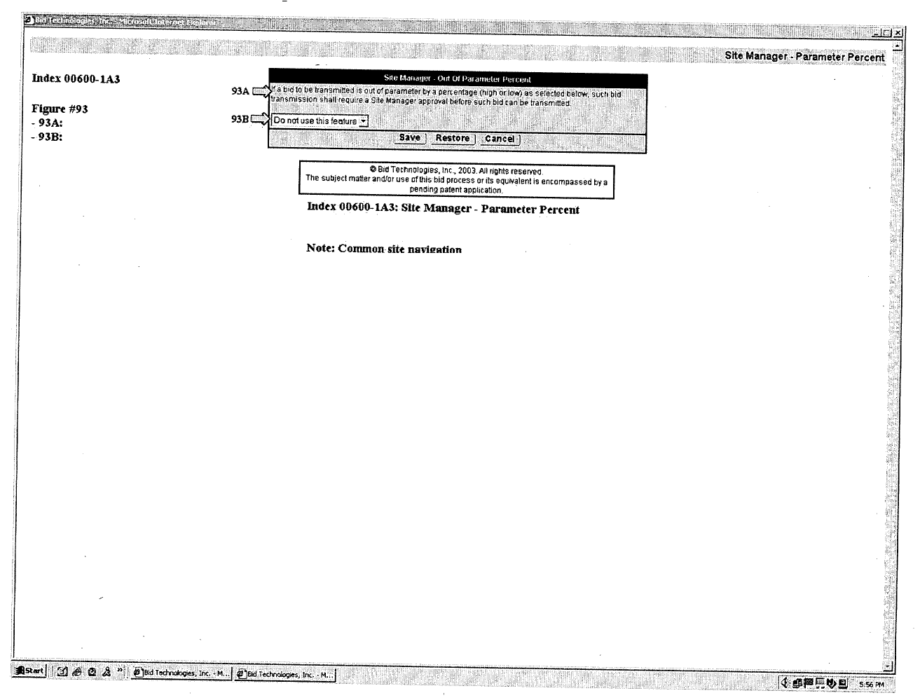

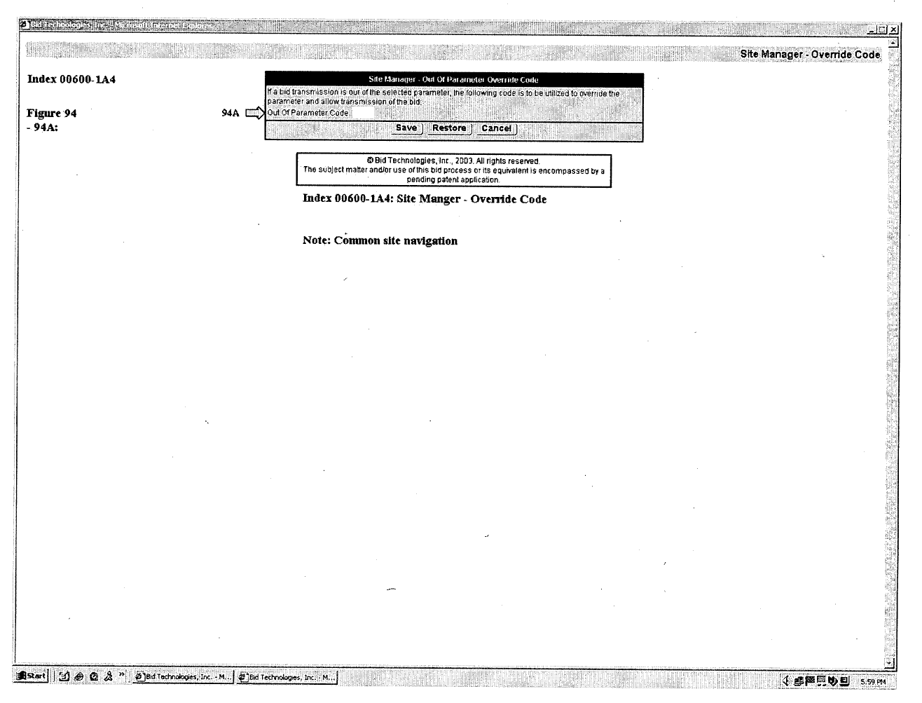

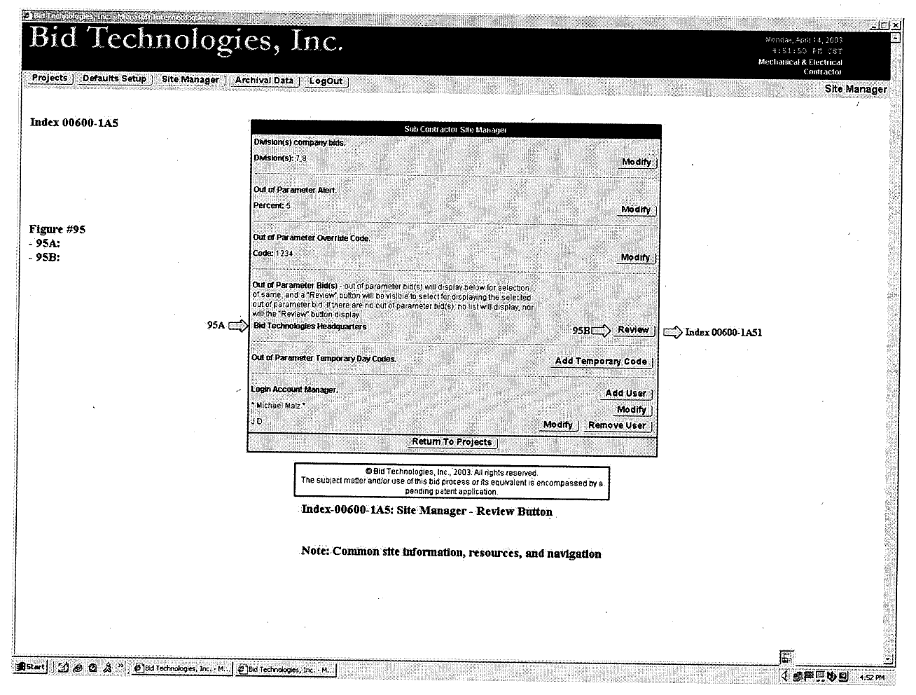

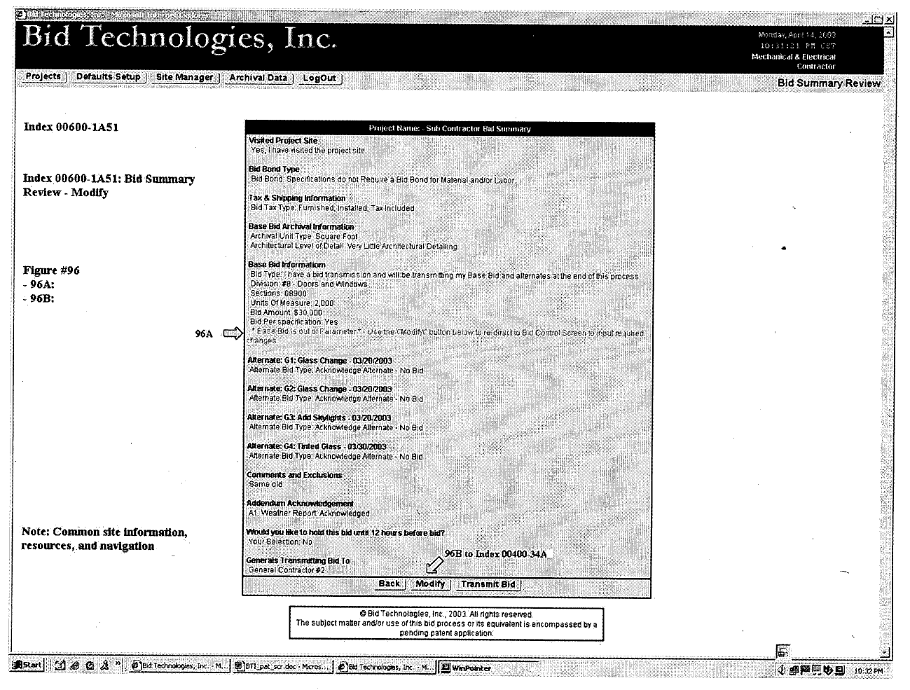

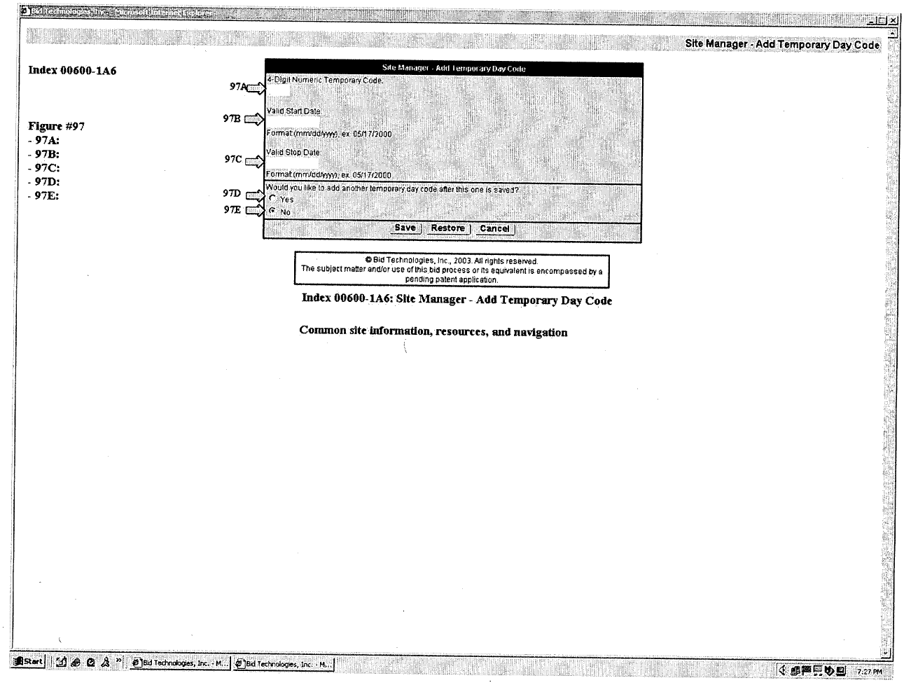

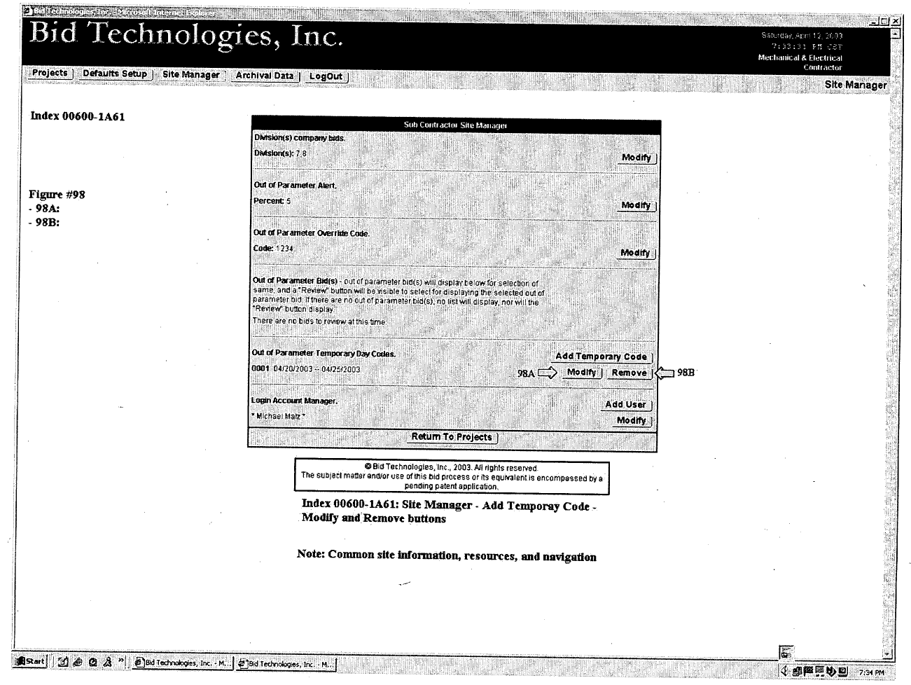

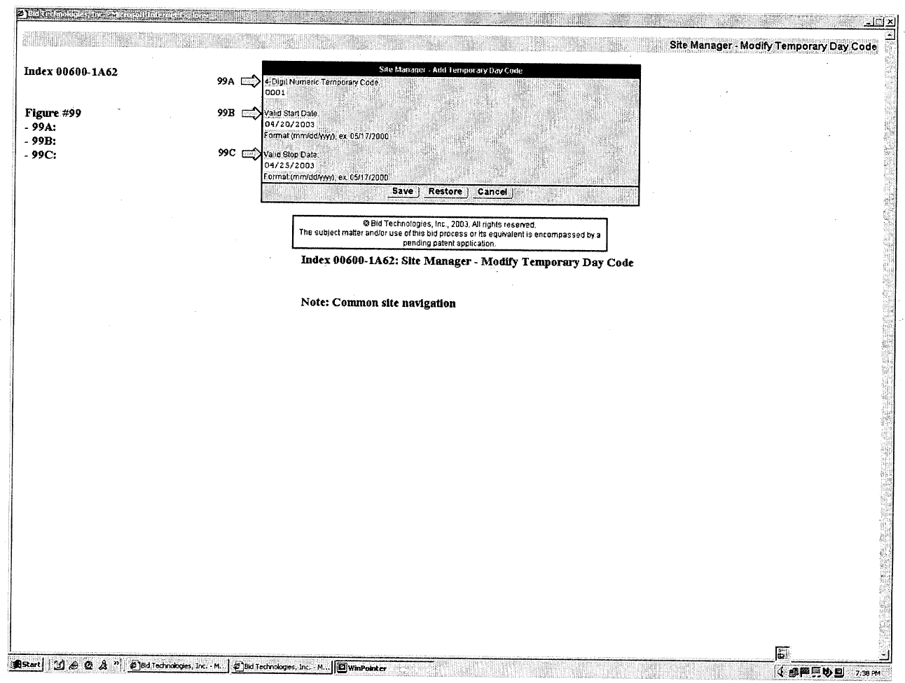

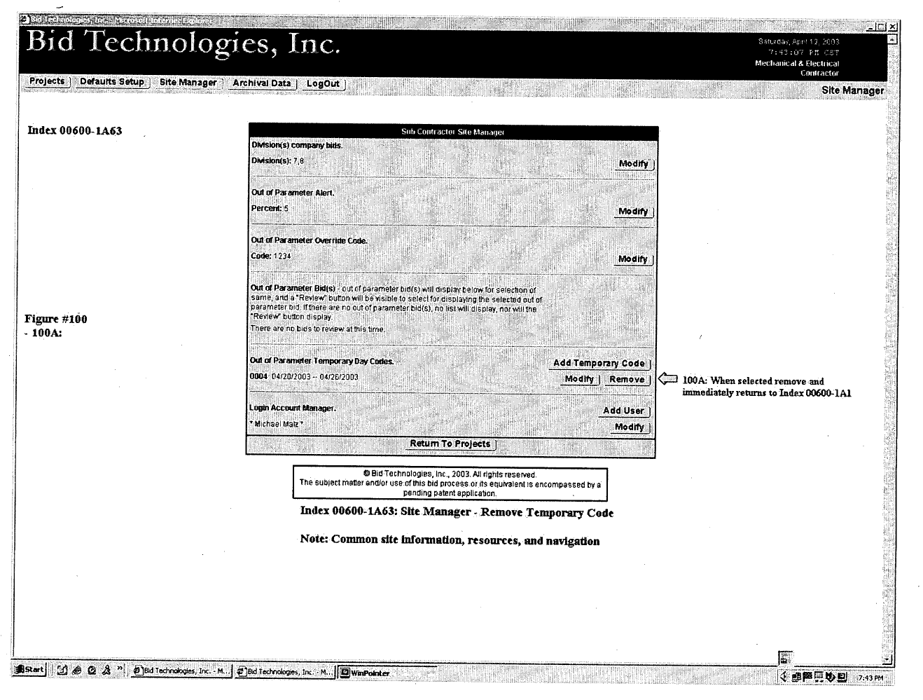

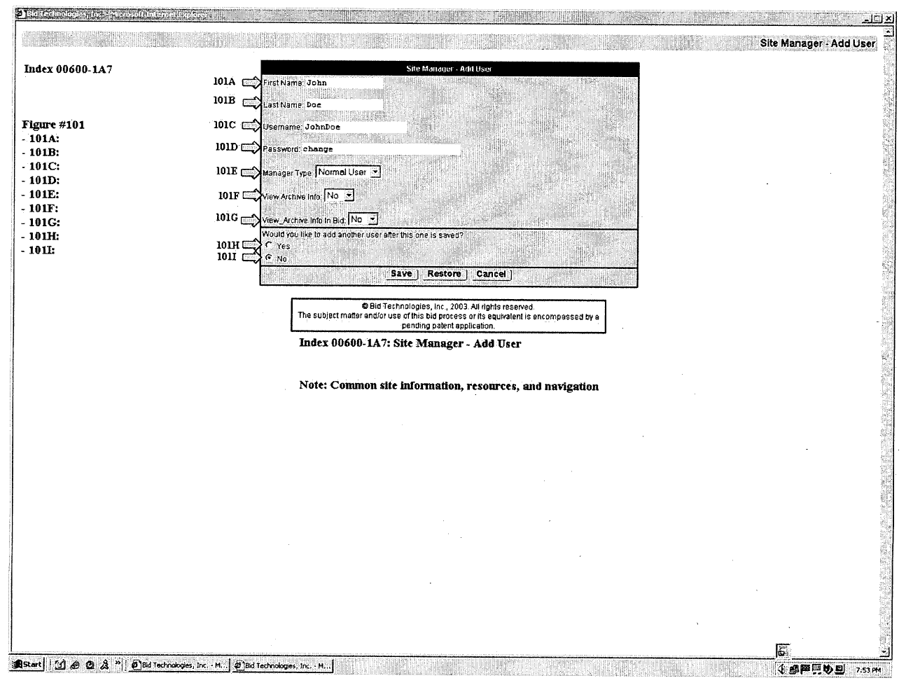

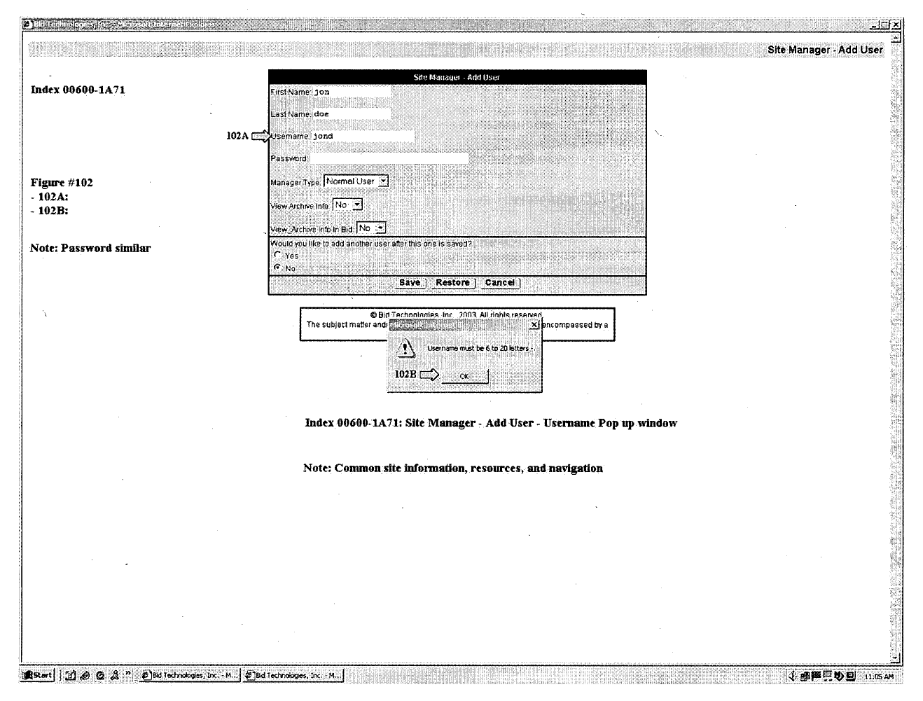

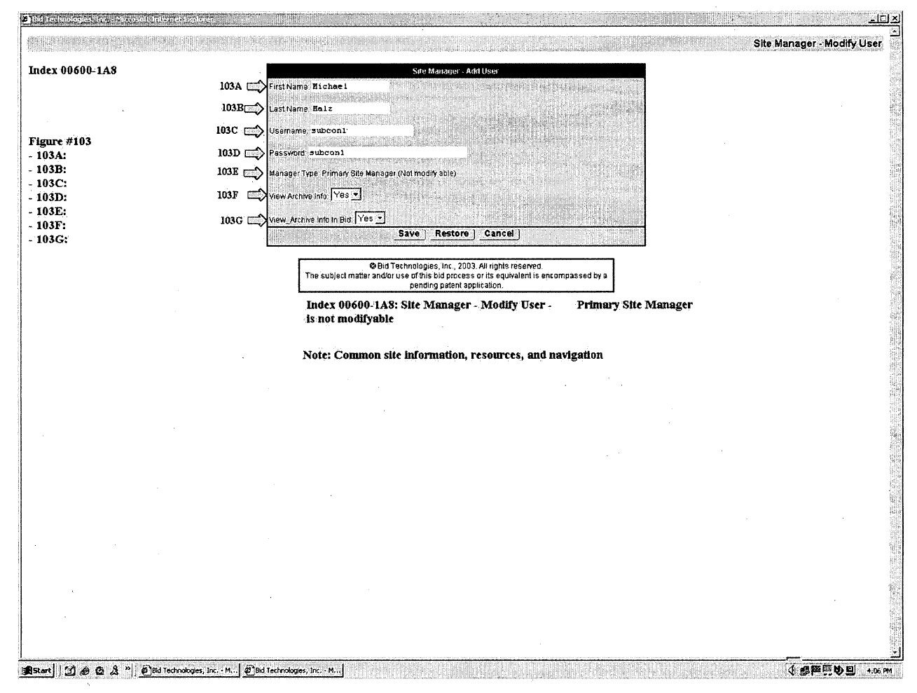

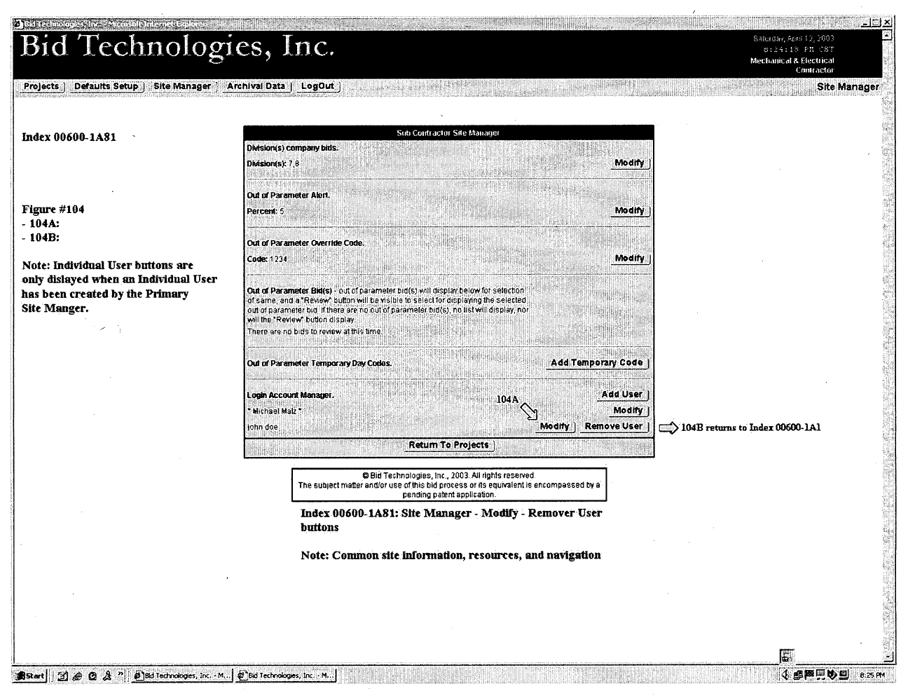

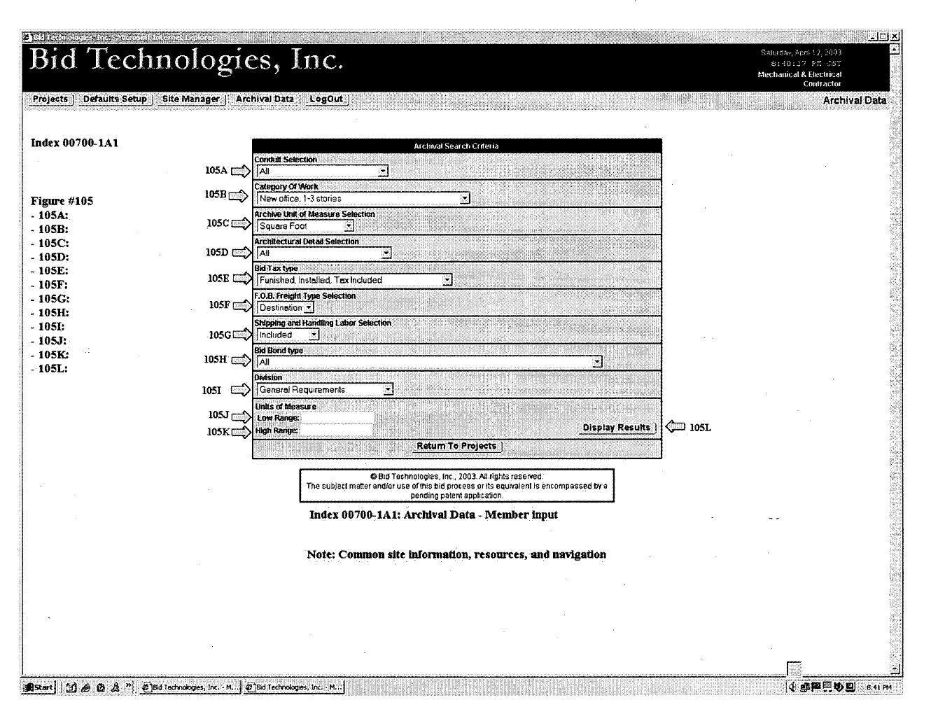

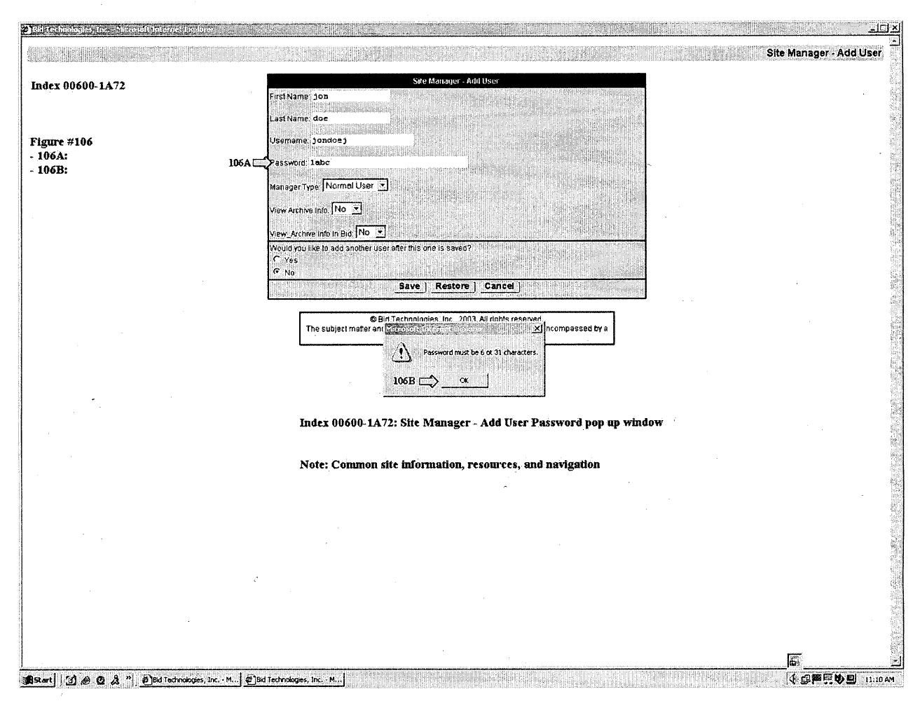

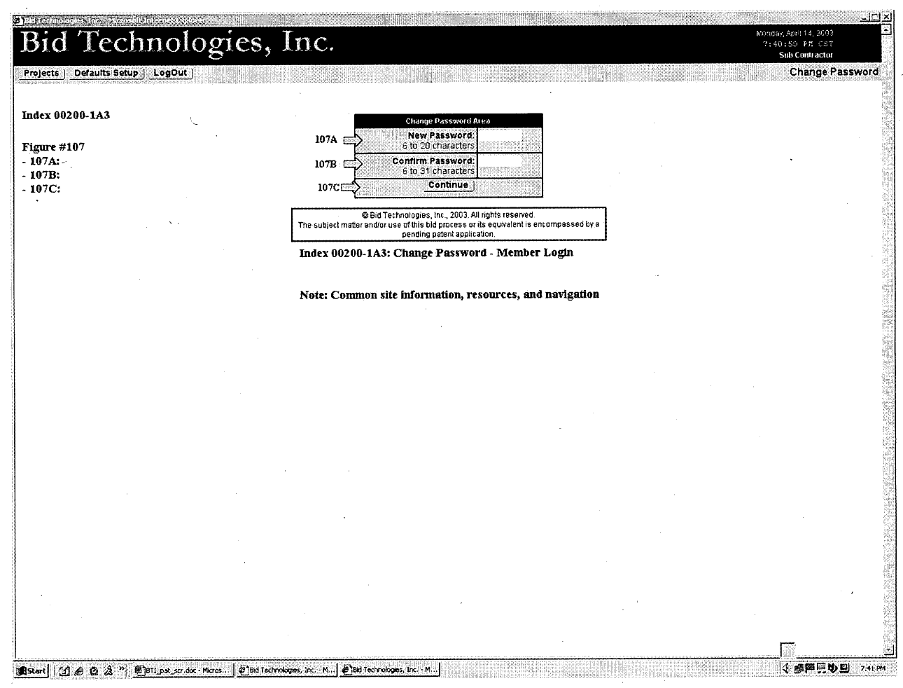

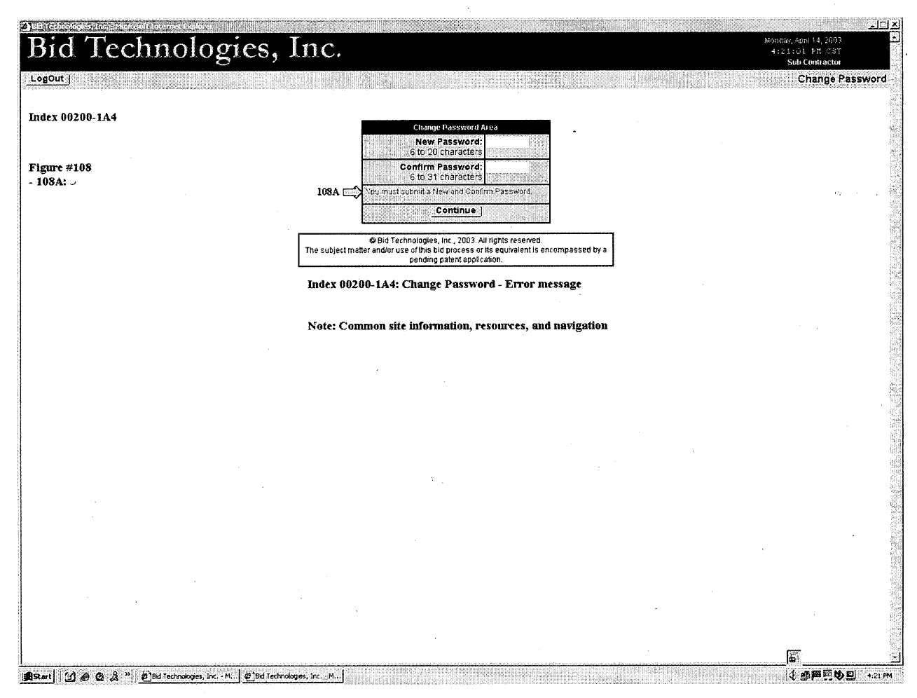

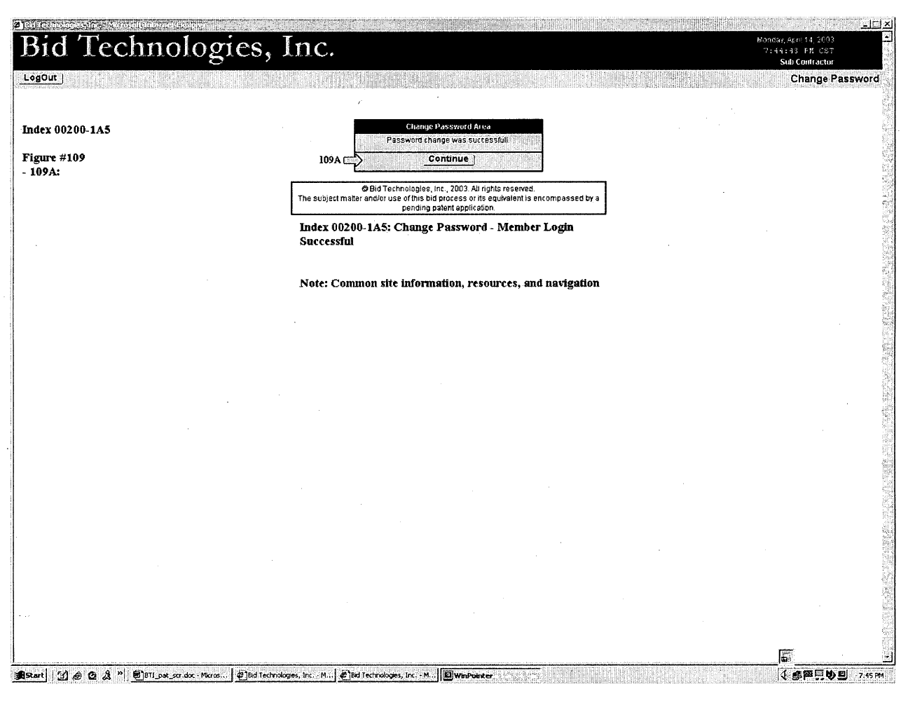

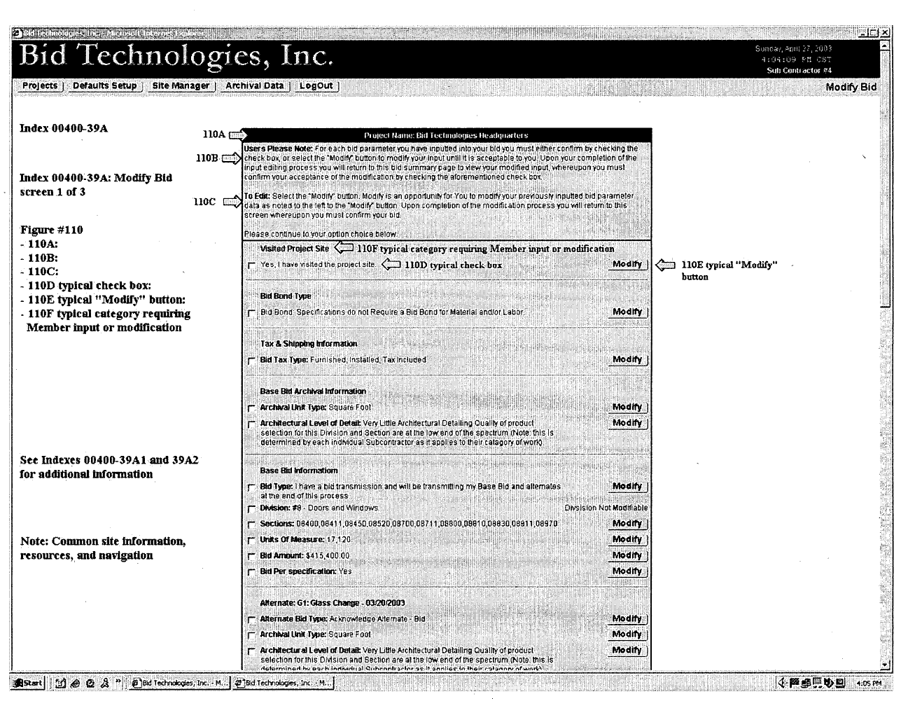

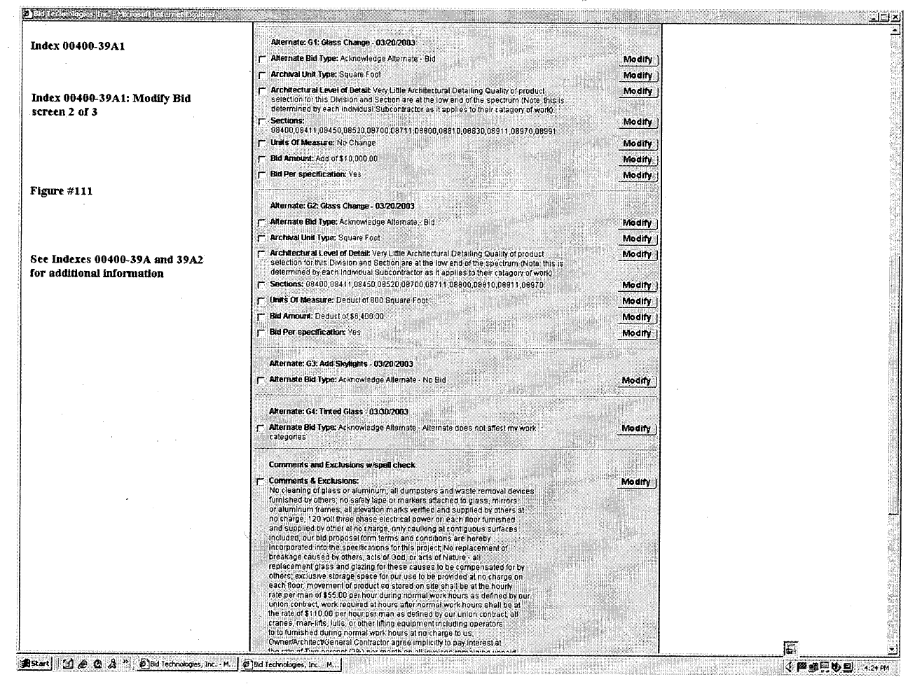

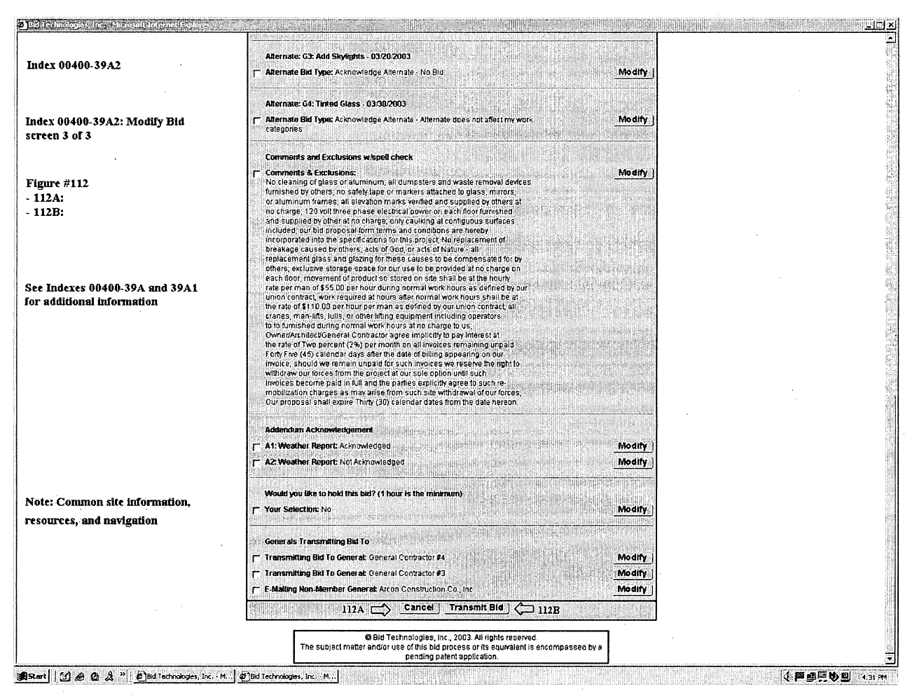

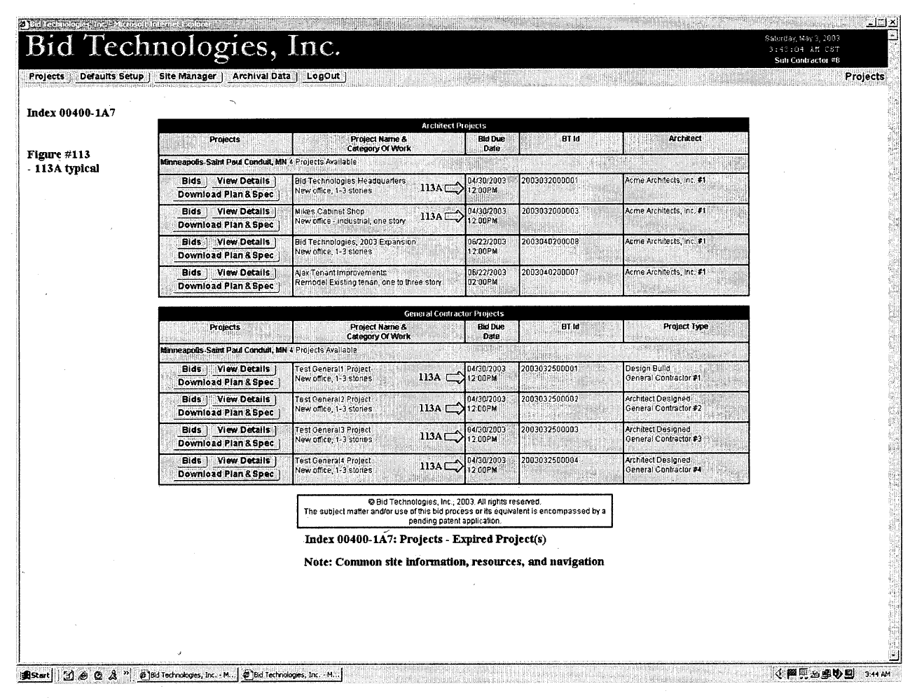

Continuing now with the “Continue to Bid Summary” button located at the bottom of Index 00400-34A2, FIG. #71, item 71G. Upon the Members selection of the “Continue to Bid Summary” button they are redirected to Index 00400-35A, which along with Indexes 35A1, 35A2, and 35A3 are the composite indexes displaying the single scrollable system “Bid Summary” screen. Index 00400-35A, FIG. #78 begins the progression. Item 78A provides the Members information relative to “check boxes” and the “Modify” button. If the Member chooses not to check the check box this must utilize the item 78D to Modify there previous input and then confirm their data input by checking the check box for the parameter. Item 78B give the Members explicit instructions for utilizing the “Modify” button. Item 78C provides a “check box” which is utilized to confirm the Members' previous input. Item 78D provides the typical “Modify” button, which has been previously detailed for the Bid Control Screen and now for the Bid Summary screen, redirects the Member to the input index for the particular bid input parameter. Index 00400-35A1, FIG. #79 continues the “Bid Summary” screen progression. Item 79A again indicates the check box for the Members' confirmation of previously inputted data, and item 79B is again the typical “Modify” button for changing their previous data input. Index 00400-35A2, FIG. #80 concludes the “Bid Summary” screen progression. Item 80A is again the Members' check box confirmation. Item 80B is again the Members' “Modify” button option. Item 80C provides the Member an option to redirect to the “Bid Control” screen should they need to do so. Item 80D is a new navigation button for the Members. It is the “Transmit” button. This button is what the Members have entered and/or modified their data input for. This button transmits the Members' bid to the chosen Bid Receptors. This is accomplished by placing the Members bid transmission into the various Bid Receptor Members' folder on the web server, or by sending the Non-Members selected an email version of the “Bid Summary” screen (note: neither of these methods transmits/displays the Members' “Archival Unit type”, “Architectural Level of Detail”, or “Unit of Measure” inputs). When the Members' bid transmission have been placed into the Bid Receptor Members' folder on the system's web server, the Member Bid Receptors are the only entities that can view the transmitted bids within their specific folders. Index 00400-35A3, FIG. #81 is an indicator to the Members that they have not checked for confirmation one or more of the required check boxes. Upon the selection of item 81A “OK” button the Member is redirected to the first unchecked check box within Index 00400-35A, 35A1, and 35A2 and provides for the Members to confirm they have selected all of the required check boxes therein. This display will continue until the Member has check all displayed and required check boxes indicating their confirmation of the data inputted for the bid parameter. Upon successful completion of the check box task, the Member and selection of the “Transmit” button the Members are redirected to Index 00400-36A, FIG. #82, the “Bids Transmitted” screen. Hereon Members are given additional instructions in item 82A regarding how to bid additional Bid Receptors for this specific project with perhaps a different “Bid Amount” parameter, although any of the bid parameters may be different. Item 82 provide Members additional instructions regarding how they may return to the “Projects” screen to select and enter a completely new bid. An example of this is for a Member who bids Divisions 15 and 16. Each of these Divisions requires a separate bid within our system, and this option allows for the Members to accomplish this within our system. Item 82C indicates to the Members their bid transmission has been successful. Item 82D “Print This Bid” button provides the Members an opportunity to print a paper copy of their “Bid Summary” screen (see Indexes 00400-36A1, FIG. 82A and 36A2, FIG. 82B for a display of the printable copy). Item 82E “Save to Disk” button provides the Members an opportunity to save a copy of their “Bid Summary” screen to another storage device such as a floppy disk, removable disk, or their own hard drive. Item 82F “Return to This Project” button allows the Member to redirect to this specific project and enter a new bid for this specific project through modification of the previously entered bid parameters and then selecting the “Transmit” button again. Item 82G “Return to Projects” button allows the Members to redirect to the “Projects” screen to select either this project or another project to input bid data into. Item 82H “Bid Another General/Bid Receptor” button redirect the Member to the “Modify Bid” screen whereupon the Member may modify the individual parameters of this bid to meet their requirements to bid another Bid Receptor or Bid Receptors for this specific project (see Indexes 00400-39A, 39A1, and 39A2 for the “Modify Bid” screen). Although the “Bid Another General/Bid Receptor” button provides a simplified method to bid additional Bid Receptors, Members may choose the 82F “Return to This Project” button and utilize the “Modify” button to change their bid parameters as noted and accomplish the same objective as utilizing the “Bid Another General/Bid Receptor” button (see Indexes 00400-37A. 37A1, 37A2, and 37A3 which detail this alternative hereafter).

Index 00400-37A; FIG. #83 redirection results from the Members previous selection of Index 00400-36A, item 82F. This redirection returns the Members to the “Bid Summary” screen whereupon the may chose item 83A “Modify” button for redirection to adjust their input of Member General Contractor/Bid Receptors, or item 83B for redirection to adjust their input of Non-Member General Contractor/Bid Receptors to transmit their bid parameters too (as displayed for Members choice in Index 00400-37A1, FIG. #84, items 84A, 84B, 84C, and 84D and Index 00400-37A2, FIG. #85, item 85A, 85B, 85C, and 85D). Thereafter, upon the Members choice of a common navigation button (as we have previously noted—“Save and Return”) the Members are redirected to Index 00400-37A3, FIG. #86 which displays the previous modifications as items as items 86A and/or 86B. Hereagain, the Members are presented with common navigation “Cancel” and “Transmit Bid” buttons which effects upon choice have been previously discussed. This concludes the alternative method to bid additional General Contractors/Bid Receptors.

Index 00400-38A, FIG. #87 is a “Project Bids” screen. Item 87C, “Pull Individual” button was briefly discussed previously within Index 00400-1A3. The purpose of this button is to allow Members to withdraw a specific project bid that has been transmitted to a specific individual Member or Non-Member Bid Receptor. This choice may result from the Members determination that an error exist within their previously transmitted bid to the specific individual Bid Receptor, or it may result from any other reason the Members determine is sufficient to cause them to withdraw their bid from this specific Member Bid Receptor or Non-Member Bid Receptor. Item 87A “Bid Summary” button selections redirects the Members to the “Bid Summary” screen, whereupon the Members can execute the options provide thereon which have been previously discussed within Indexes 00400-35A, 35A1, and 35A2. Item 87B “Modify” button selection which redirects the Members to the “Modify Bid” screen option to be discussed within Indexes 00400-39A, 39A1, and 39A2 herein. Index 00400-38A1, FIG. #88 is a “Projects Bids” screen. Item 88C, “Pull Group” button was briefly discussed previously within Index 00400-1A3. The purpose of this button is to allow Members to withdraw a specific project bid that has been transmitted to a specific group of Member and/or Non-Member Bid Receptors. This choice may result from the Members determination that error exist within their previously transmitted bid to the group of Bid Receptors, or it may result from any other reason the Members determine is sufficient to cause them to withdraw their bid from this specific group of Bid Receptors. Item 88A, “Bid Summary” button redirects the Members to the “Bid Summary” screen, whereupon the Members can execute the options provided thereon which have been previously discussed within Indexes 00400-35A, 35A1, and 35A2. Item 88B “Modify” button selection which redirects the Members to the “Modify Bid” screen option to be discussed within Indexes 00400-39A, 39A1, and 39A2 herein. Index 00400-38A2, FIG. #89 displays the revisions made previously within Indexes 00400-38A and 00400-38A1. Item 89 is the “Return to Projects” button common navigation button that redirects the Members to Index 00400-1A “Projects” screen upon Members selection thereof whereupon the Members may exercise the options available to them thereon.

Index 00400-39A, FIG. #110 is the first of three indexes that together comprise the single scrollable system “Modify Bid” screen. The indexes are 00400-39A, 39A1, and 39A2. Members are redirected to the “Modify Bid” screen from the “Modify” button within Indexes 00400-1A3, 1A5, 1A6; Index 00400-36A, item 82H; and Index 00400-38A, 38A1, 38A2. Upon Member redirection to the “Modify Bid” screen Index 00400-39A, Members are presented with a screen that looks and feels similar to the “Bid Summary” screen. Item 110A, displays the specific project name. Item 110B and 110C provide Member instructions relating to the parameters (see item 110F), check boxes (see item 110D), and “Modify” button. (see item 110E). Item 110F indicates the parameter for both the check box and “Modify” button within the parameter's cell. Item 110D indicates the typical “check box” for Member confirmation after the Member has inputted their Modification within the redirected Index for the typical “Modify” button indicated by item 110E. Index 00400-39A1, FIG. #111 continues the “Modify Bid” screen display with the different input parameters and typical “check box” and “Modify’ buttons. Index 00400-39A2, FIG. #112 completes the “Modify Bid” screen trilogy of Indexes. After the Members have completed the modifications they inputted through the “Modify” buttons, which includes their revised choice of Bid Receptors they must check all check boxes to confirm their choices, whereupon they may select the “Transmit Bid” button at the bottom of the “Modify Bid” screen to transmit their parameters choices to the Bid Receptors they have selected as a part of their modifications. Simply put the “Modify Bid” screen allows the Members to revise their previous input for the specific project through the utilization of the “Modify” buttons for each bid parameter. Thereafter, the Members complete the revised transmission through their choice of the “Transmit Bid” button as they have previously done within the “Bid Summary” screen. This concludes the direct discussion of Member input indexes; it leaves the Default Setup, Site Manager, and Archival Data buttons that begin displaying within the “Projects” screen, and we take our discussion to these item now.

Members can initiate certain default action through two methods. Both methods are available to Members from within the “Projects” screen. Both methods can be initiated prior to selecting the “Bids” thereon to begin data entry into a specific project. Index 00500-1A, “Default Setup” button, indicates the first of these methods, and can be instituted by Members who are not a Site Manager. Upon Member selection they are redirected to Index 00500-1A1, FIG. #90 or the “Default Setup” screen. Within this index Members may select the Division, Unit of Measure type, and Alert percentage for “Out of Parameter” notices. Item 90A provides Members a drop down menu to select their Division from. It contains Divisions #1 thru #16 for Members' selection. Item 90B provides Members a drop down menu of the default Unit of Measure types. It does not allow for custom Unit of Measure selection, which must be done either in Index 00400-6A or 00400-15A. Item 90C provides the Members a drop down menu of percentages that begin at 5% and increases in increments of 5. The selection of this percentages determines when the “Out of Parameter” and “Your bid is out of parameter. A site manager must review this bid” notices appear within the “Bid Summary” screen, as well as the “Code Entered: No” check box and “Enter Code” button. This concludes the “Default Setup” button options. Index 00600-1A, “Site Manager” button, indicates the second of these methods, and can only be accessed by a Member who is a Site Manager, as determined during the Member Login process. If a Site Manager, the Member may select and access the “Site Manager” button. Upon selection the Member (Site Manager) is redirected to Index 00600-1A1, FIG. #91 or the “Site Manager” screen. Within this index the Site Manager can input certain default values or create user logins for use by their fellow Members within the same organization. Item 91A “Division(s) company bids” can be modified from the default value “All Divisions are available to bid” displayed after “Division(s):” by selection of the “Modify” button within the cell. Upon the Site Manager's selection they are redirected to Index 00600-1A2. Index 00600-1A2, FIG. #92, or the Site Manager—Division(s) Selection screen provides the Site Manager check box items 92B-92Q to select for Divisions #1 thru #16. Item 92A provides the Site Manager instructions in the matter of Division selection. These instructions are “Select Division(s) you want to make available to your company's estimator(s) or project bidder(s). Only the Division(s) selected will be available to your company's estimators or project bidders. If no Division(s) are selected, all Division(s) will be available for selection by your company's estimator(s) or project bidder(s).” In most instances a Site Manager would check only one division, but there are exceptions. For example, Mechanical and Electrical divisions often have Members who bid both divisions and consequently would display both divisions. It should be noted these cases require the Member to bid both divisions as separate bid transmissions, although they could indicate their association and other terms for their use within the “Comments and Exclusions” of both bids. Upon the Site Manager's selection completion they select from common navigation buttons previously discussed, and upon selection are redirected to Index 00600-1A1.

The next item for discussion within Index 00600-1A1 is item 91B “Out of Parameter Alert”. Through selection of the “Modify” button within the cell the Site Manager can modify the default value of “0” Percent. Upon selection of the “Modify” button, redirection to Index 00600-1A3 occurs. Index 00600-1A3, FIG. #93, or the “Site Manager—Parameter Percent” screen provide a drop down menu item 93B for the Site Manager to select a percentage for this parameter. This parameter when exceeded above or below displays the “OUT OF PARAMETER”, “Code Entered: No” check box, and “Enter Code” button on both the “Bid Control” and “Bid Summary” screens which require a code entry input from the Site Manager which has been inputted for use within Index 00600-1A4 to be discussed later herein. Item 93A provides the Site Manager instructions regarding their choice for item 93B as follows: “If a bid to be transmitted is our of parameter by a percentage (high or low) as selected below, such bid transmission shall require a Site Manager approval before such bid can be transmitted. The approval is the Site Manager's code entry. Upon the Site Manager's selection completion they select from common navigation buttons previously discussed, and upon selection are redirected to Index 00600-1A1.

The next item for discussion within Index 00600-1A1 is item 91C ”Out of Parameter Override Code”. Through selection of the “Modify” button within the cell the Site Manager can enter the override code. Upon selection of the “Modify” button, redirection to Index 00600-1A4 occurs. Index 00600-1A4, FIG. #94, or the “Site Manager—Override Code” screen provides the Site Manager a text box for entry of their “Out of Parameter Code:”. This code is a four digit numeric code and is noted as item 94A. Additional text instructions provide are provided as follows: “If a bid transmission is out of the selected parameter, the following code is to be utilized to override the parameter and allow transmission of the bid.” Upon the Site Manager's input completion they select from common navigation buttons previously discussed, and upon selection are redirected to Index 00600-1A1.

The next item for discussion within Index 00600-1A1 is item 91D “Out of Parameter Bid(s). Index 00600-1A5, FIG. #95 is the Site Manager screen when an “Out of Parameter Bid” exists within the system process. Through selection of the “Review” button within the cell the Site Manager can review out of parameter bids. The “Review” button is displayed only when a bid that is out of parameter has been entered and listed as indicated by item 95A. In this case the Site Manager selects the item 95B “Review” button and is redirected to Index 00600-1A51. Index 00600-1A51, FIG. #96 displays a summary of the inputted bid parameters for the “Out of Parameter Bid”. Item 96A instructs the Site Manager as follows: “*Base Bid is out of Parameter*—Use the \“Modify”\ button below to re-direct to Bid Control screen to input required changes.” Note this display is located below the Bid Type. This notice would display below an alternate in the event the “Alternate Bid Type” exceeded the “Out of Parameter” percentage. Upon the Site Manager's selection of the “Modify” button they would be redirected to Index 00400-34A to either modify the parameter creating the “Out of Parameter” notice and/or enter the override code. This Index's processes have been discussed previously and in conjunction with the Site Manager's modifications and/or Site Manager's code entry would permit the bid either with the modifications made or the code entered to be transmitted successfully. Note the Site Manager could approve the bid upon their review and by selection of the “Transmit Bid” button at the bottom of Index 00600-1A51 send the bid to the chosen Bid Receptor with out utilization of the “Modify” button located adjacent thereto.

The next item for discussion within Index 00600-1A1 is item 91E “Out of Parameter Temporary Day Codes.” Site Managers for each Member could utilize this code to provide for those situations when they might be unavailable due to vacations, attendance at seminars, or other events, situations, and occasion for which they were predisposed to provide an alternate entry code for an authorized subordinate to enter the temporary code and allow “Out of Parameter Bid” to be transmitted successfully. Through selection of the “Add Temporary Code” button within the cell redirection to Index 00600-1A6 occurs. Index 00600-1A6, FIG. #97 provide a number of text entry boxes for the Site Manager to provide input. Item 97A provides a text entry box for the temporary code to entered. Item 97B provides a text entry box for a valid start date to establish the beginning date the code will be valid. Item 97C provides a text entry box for a valid end date to establish the ending date the code will be valid. Item 97D provides a radio button “Yes” response to the query “Would you like to add another temporary code after this one is saved?” Item 97E provides a radio button “No” response and is the default response to the query “Would you like to add another temporary code after this one is saved?” Upon the Site Manager's selection of a common navigation button, the date inputted is saved, cleared for new input, or cancelled without being saved. Index 00600-1A61, FIG. #98 displays the Site Manager's saved input of a temporary code. It also displays item 98A that provides the Site Manager an opportunity to modify their previous input through selection of the “Modify” button. Item 98B, also displayed, provides the Site Manager an opportunity to remove the temporary code inputted through selection of the “Remove” button.

The next item for discussion within Index 00600-1A1 is item 91F “Login Account Manager.” Site Managers upon their selection of the “Add User” button within this cell are redirected to Index 00600-1A7. Index 00600-1A7, FIG. #101, or “Site Manager—Add User” screen provides the Site Manager a method to add additional user(s). Item 101A provide a text box for entry of the user's first name. Item 101B provides a text box for entry of the user's last name. Item 101C provides a text box for entry of a username. Item 101D provides a text box for entry of a password. Item 101E provides a text box for entry of Manager Type from a drop down menu selection. Item 101F provides the Site Manager's a drop down menu choice of “No” or “Yes” to view Archive data. Item 101G provides the Site Manager's a drop down menu choice of “No” or “Yes” to view Archive info in Bid. Item 101H provides a radio button “Yes” choice to the query “Would you like to add another user after this one is saved?” Item 101I provides a radio button default “No” choice to the query “Would you like to add another user after this one is saved?” Index 00600-1A71, FIG. #102 provides the Site Manager a “pop up” error message item 102B concerning the text box input for a username item 102A, and a similar “pop up” error message item 106B concerning the text box input for a password as noted in Index 00600-1A72, FIG. #106, item 106A. Upon the Site Manager's selection of a common navigation button, the date inputted is saved, cleared for new input, or cancelled without being saved. Within item Index 00600-1A1, item 91F a “Modify” button is displayed for the Site Manager's account and it displays when additional members have been added. Upon selection of the individual users “Modify” button the Site Manager is redirected to Index 00600-1A8. Index 00600-1A8, FIG. #103 is Index 00600-1A7 with the exception of the radio button choices thereon and the notes thereon are sufficient hereon as well. Index 00600-1A81, FIG. #104 displays an additional user, but it also displays item 104B the “Remove User” button that does not display for the Site Manager user. This button upon selection removes a user from the system and returns the Site Manager to Index 00600-1A1. Item 104A redirects to Index 00600-1A81 which has been previously discussed. This completes the Site Manager button discussion.

Members can initiate their Archival query choices through Index 00700-1A “Archival Data” button found on the “Projects” screen. Upon the Members selection redirection to Index 00700-1A1 occurs. Index 00700-1A1, FIG. #105, provides the Members a number of drop down menus and text boxes for their choices regarding their archival data input. Item 105A provides a drop down menu to select the “Conduit” or “Conduits” the Member has authorization to utilize for the archival engine to utilize for its activities. Item 105B provides the Members a drop down menu choice of the “Category or Work” areas to select. Item 105C provides the Members a drop down menu choice of the “Archival Unit of Measure Selection”. Item 105D provides the Members a drop down menu choice of the “Architectural Detail Selection”. Item 105E provides the Members a drop down menu choice of the “Bid Tax Type”. Item 105F provides the Members a drop down menu choice of the “F.O.B. Freight Type Selection”. Item 105G provides the Members a drop down menu choice of the “Shipping and Handling Labor Selection”. 105H provides the Members a drop down menu choice of the “Bid Bond Type”. Item 105I provides the Members a drop down menu choice a “Division”. Item 105J provides the Members a text box entry to input the low range for their Units of Measure parameter. Item 105K provides the Members a text box entry to input the high range for their “Units of Measure” parameter. Item 105L provides the Members a “Display Results” button to view the archival display of their inputted or chosen query values. Upon selection of the common navigation button “Return to Projects” the Members are returned to the “Projects” screen.

What is claimed:

1. A construction project online bidding system, the bidding system comprising a) technical infrastructure for sending, receiving, storing, and exchanging information; and b) software enabling editable manipulations of the methodology, system processes, and system threads of the bidding system, the software being coupled to the technical infrastructure for managing at least one project process function that allows a user to identify a specific main project on which to bid, and after the user identifies a main project, the user then being able to identify major categories within the main project for submitting a bid, and the user then, under each major category identified for bid, being able to identify specific sub-project categories for bid, and after the user enters user data specific to at least one sub-project category as part of the user's bid, the system storing the user's bid made on the at least one sub-project bid on criteria other than the total cost of the bid.

2. The system of claim 1 wherein a software/hardware function program is present so that upon a user attempting to submit a bid, the software/hardware program may analyze the bid to a) determine if predefined types of errors appear in the bid or b) evaluate the bid in comparison with other bids submitted on either the main project of the major category.

3. The system of claim 2 wherein upon determination that a predefined type of error appears in the bid, the program notifies at least one of the system and the user that an error may exist.

4. The system of claim 3 wherein software/hardware has the capacity to notify the user of the error determined by the function program.

5. The system of claim 1 wherein screens are provided to the user during the entry of data in the submission of a bid by the user, with the user entering data into specific areas of the screen.

6. The system of claim 5 wherein at least one screen allows the user to identify alterations to be made in the main project or a sub-project category being bid upon and to identify variations in value or terms based on those alterations.

7. The system of claim 5 wherein at least one screen allows the user to identify itself as a specific user known to the system through a username and password for the specific authentication of the user known to the system and the system logs each occurrence of login.

8. The system of claim 5 wherein at least one screen allows the user to accept or reject a published and displayed known system disclaimer agreement and the system logs each occurrence of acceptance.

9. The system of claim 5 wherein at least one screen allows the user to chose specific processes available to user within the system with at least two processes selected from the group consisting of new bids, modify existing bids, set user defined defaults, idle resets and logout, and the system logs each occurrence of choice definition.

10. The system of claim 5 wherein at least one screen allows the user to predefine a specific major work category for the at least one specific project upon which the user chooses to bid.

11. The system of claim 5 wherein at least one screen allows the user to predefine the user's chosen work category's specific unit of measurement for at least one specific project the user chooses to bid.

12. The system of claim 5 wherein at least one screen allows the user to predefine specific bid parameter user notification rule(s) for at least one specific sub-project category work area.

13. The system of claim 5 wherein at least one screen allows the user to modify predefined user system choices and updates the user's known system profile.

14. The system of claim 5 wherein at least one screen allows the user to view specific project bidding information selected from the group consisting of the project's architect, the project's bid date, the project's bid due time, the project's alternates, the project's addendums, and the project's bid receiver(s).

15. The system of claim 5 wherein at least one screen requires the user to provide mandatory notification to the bid receiver(s) of either the user's actual viewing and inspection of the specific project site, or the user's choice to not view and inspect the specific project construction site.

16. The system of claim 15 wherein the screen requires the user to exercises a choice before continuation within the process is allowed and logs each occurrence of user choice.

17. The system of claim 5 wherein at least one screen requires the user to choose its sub-project work category specific unit of measure in the event the user has not or does not desire to predefine this data within the process.

18. The system of claim 5 wherein at least one screen requires the user to choose at least one major project category of work definition.

19. The system of claim 5 wherein at least one screen requires the user to choose at least one sub-project work category of work definition.

20. The system of claim 5 wherein at least one screen allows the user to enter bid value data for the specific project's specific major project work categories and sub-project work categories specific to the user's choices within those category(s) before continuation within the process is allowed and the system logs each user's inputted data values upon each occurrence.

21. The system of claim 5 wherein at least one screen allows the user to input specific project specific unit of measure value data as either predefined or manually selected by the user.

21. The system of claim 5 wherein at least one screen allows the user to choose specific notification to the bid receiver(s) of the user's bid adherence to the specific project's plan and specification, or the user's choice not to adhere the user's bid to the specific project's plan and specifications.

22. The system of claim 5 wherein at least one screen allows the user to acknowledge each owner requested modification(s) to the sum total of the plans and specifications for the specific project.

23. The system of claim 22 wherein owner requested modification(s) may be made by the owner through at least one representative and may require modification(s) within the specific sub-project category being bid upon by the user; and if affected or not affected by such modification(s) the system process requires notification of each modification(s) affect to the bid receptor(s).

24. The system of claim 22 wherein at least one screen allows the user to identify each owner requested modification(s) to the sum total of the plans and specifications for the specific project and to provide specific bid values for each requested modification(s) noted as requiring a bid modification through acknowledgement to the bid receiver(s) for the specific project's major work categories and sub-project work category(s) upon the user's determination that such modification(s) do indeed affect the value of it's specific major work category and sub-project work category(s) original bid value(s).

25. The system of claim 24 wherein a process supported by the system requires the user to input a modification bid value which will produce a addition, deduction, or no change to the user's original bid value(s) in the event a user has chosen a system defined acknowledgement which requires additional bid input value(s) as determined by the user's examination of the modification's specifications and plans, before continuation within the process is allowed and logs each user's specific modification(s) bid values.

26. The system of claim 25 wherein bid values provide values for each modification required in the form of additions, deductions, or no change bid value(s) to the user's original bid; and includes additional information or deletes user identified sub-project work categories as required by such modification requests.

27. The system of claim 5 wherein at least one screen allows the user to identify each owner requested modifications to the sum total of the plans and specifications for the specific project and to provide notification to the bid receiver(s) of the change(s) or non-change in the specific sub-project work category(s) that may be added, deleted, or have no change with the modification's price as submitted by user.

28. The system of claim 27 wherein a process supported by the system allows the user to choose for each owner modifications determined by the bidder to require bid modification as determined by user, or to add or delete a system defined sub-project work category(s) as determined by user examination of each modification's specifications and plans before continuation within the process is allowed.

29. The system of claim 5 wherein at least one screen allows the user to identify each owner requested modifications to the sum total of the plans and specifications for the specific project and to input additions, deletions, or no change to the specific project's specific sub-project work category(s) specific units for measurement value either inputted by predefinition or manually chosen by the user.

30. The system of claim 29 that requires the user to enter data for the modification which the user has determined requires a bid, before continuation within the process is allowed and logs each user input value(s).

31. The system of claim 5 wherein at least one screen allows the user to select the specific bid receiver(s) from a list to whom the user will be submitting the user's currently defined bid data parameters within the system.

32. The system of claim 31 wherein the system supports a process that requires the user to exercise at least one choice from the list, before continuation within the process is allowed and logs each occurrence of the user's choice(s).

33. The system of claim 5 wherein at least one screen allows the user to select specific acknowledgement of addenda or addendum for a specific project.

34. The system of claim 5 wherein at least one screen allows the user to select specific predefined choices which provide bid tax values to the specific bid receiver(s) regarding the user's bid tax data, the system process requiring the user to exercise a choice from the list, before continuation within the process is allowed and logs the user's choice.

35. The system of claim 5 wherein at least one screen allows the user to input data specific to the specific project, the user's major project work categories, or the user's sub-project work category(s), which defines, clarifies, enumerates, excludes, modifies or takes exception, inputs terms and conditions, and/or instructs the bid receiver(s) concerning the specific terms or parameters of the user's specific project bid within the major project or sub-project work category(s) chosen by the user.

36. The system of claim 35 wherein at least one screen allows notifies the user of spelling error within data input and presents the user with a choice to either correct or not correct the system defined errors.

37. The system of claim 5 wherein at least one screen allows the user to chose spelling modifications, enter the system defined spelling error as proprietary and correct spelling entry within the system's custom dictionary module, or ignore the specific error and continue to the next error entry, if any.

38. The system of claim 5 wherein at least one screen allows the user to display all previously inputted bid parameters for the user's visual inspection, review, and suitability for the specific project, or provide for the modification of user determined error(s) prior to submittal of the terms and parameters, the system process requiring the user to designate by a mark in an appropriate box the validity of each parameter previously entered before continuation in the system process is allowed.

39. The system of claim 38 wherein at least one screen allows the user to submit to the user selected bid receiver(s) the reviewed and user designated correct bid parameters for at least one of the specific project's items selected from the group consisting of major project work category(s), sub-project work category(s), and specific bid parameters, terms, and conditions input by the user.

40. The system of claim 39 wherein at least one screen confirms to the user the successful transmission of the user's bid to selected bid receiver(s.

41. The system of claim 39 wherein at least one screen allows the user the choice to print a hardcopy of the successfully transmitted bid as transmitted.

42. The system of claim 5 wherein at least one screen allows the user the choice to re-enter the system, re-input bid parameters through which entry allows the user to select additional different bid receiver(s) to be transmitted different bid parameters, terms, and conditions for the specific project's major project work categories and user's sub-project work category(s) as designated by the user based upon parameters known to the user.

43. The system of claim 1 wherein at least one of the criteria is selected from the group consisting of variance to current bid history, multiple sub-project work categories, cumulative bid totals compared to another user's cumulative bid totals, and owner defined alternates.

44. A process for a contractor entering a bid for a construction project comprising:
the contractor connecting to a central bidding website,
logging into the website as a specific contracting entity,
consenting to a standard of general bidding obligations on projects,
identifying at least one specific project on which bid(s) are to be entered,
entering information on a bid to be submitted on the specific project on which bid(s) are to be entered, the information including at least:
a) generic nature of the work to be performed;
b) identification of work units defining a value bases for estimating bid to be submitted;
c) entering or passing over data on exceptions to specifications for the project on bid, and
d) entering cost estimate on bid;
submitting bid to the website to have the bid evaluated and correlated according to parameters at the website for evaluating and correlating the bid.
